(19) United States
(12) Patent Application Publication
(10) Pub. No.: US 2009/0324016 A1
(43) Pub. Date: Dec. 31, 2009

(54) MOVING TARGET DETECTING APPARATUS, MOVING TARGET DETECTING METHOD, AND COMPUTER READABLE STORAGE MEDIUM HAVING STORED THEREIN A PROGRAM CAUSING A COMPUTER TO FUNCTION AS THE MOVING TARGET DETECTING APPARATUS

(75) Inventors: Mitsuhisa Ikeda, Tokyo (JP); Hiroshi Kameda, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI ELECTRIC CORPORATION, Chiyoda-ku (JP)

(21) Appl. No.: 12/490,973

(22) Filed: Jun. 24, 2009

(30) Foreign Application Priority Data
Jun. 26, 2008 (JP) 2008-167013

(51) Int. Cl. G06K 9/00

(52) U.S. Cl. 382/103

(57) ABSTRACT

To extract a target pixel that shows a moving target in an image containing a complicated background. An image storing section 112 stores first image data indicating a first image and second image data indicating a second image. A destination candidate extracting section 152 extracts a pixel from a plurality of pixels included in the two images, as a destination candidate pixel, when the luminance value of the pixel is increased. A source candidate extracting section 151 extracts a pixel from the plurality of pixels included in the two images, as a source candidate pixel, when the luminance value of the pixel is decreased. A target extracting section 153 extracts the destination candidate pixel as a target pixel, when the destination candidate pixel is paired with the source candidate pixel.

### BACKGROUND OF THE INVENTION

1. Field of the Invention

The present invention relates to a moving target detecting apparatus for detecting a moving target based on a plurality of images consecutive in time-series.

2. Description of the Related Art

There have been target detecting devices for detecting a target based on images captured by a sensor or the like. Some examples of target detecting devices are disclosed in JP 05-266191 A, JP 07-334673 A, JP 2006-319602 A, and JP 2003-298949 A.

Existing target detecting devices are generally designed to detect a target when the background area has a certain uniformity, the luminance level of a target is sufficiently greater than that of the background, or a pixel showing a target is at the peak compared to pixels in the neighborhood of the pixel showing the target.

Therefore, it is difficult for those existing target detecting devices to detect a target if a complicated pattern, such as clouds, is contained in the background, or the luminance level of a target does not show a significant difference compared to that of the background.

### SUMMARY OF THE INVENTION

The present invention is directed to solving problems such as that described above, for example. It is an object to detect a target even in a situation where a complicated pattern, such as clouds, is contained in the background, or the luminance level of a target is not significantly different compared to that of the background.

These and other objects of the embodiments of the present invention are accomplished by the present invention as hereinafter described in further detail.

According to one aspect of the present invention, a moving target detecting apparatus may include a memory for storing data; a processor for processing the data; an image storing section that stores first image data indicating a first image and second image data indicating a second image, by using the memory; a destination candidate extracting section that may extract a pixel increasing in a luminance value as a destination candidate pixel, from a plurality of pixels included in the first image and the second image, based on the first image and the second image indicated by the first image data and the second image data stored by the image storing section, by using the processor; a source candidate extracting section that may extract a pixel decreasing in a luminance value as a source candidate pixel, from the plurality of pixels included in the first image and the second image, based on the first image and the second image indicated by the first image data and the second image data stored by the image storing section, by using the processor; and a target extracting section that may extract the destination candidate pixel as a target pixel when the destination candidate pixel is paired with the source candidate pixel, based on the destination candidate pixel extracted by the destination candidate extracting section and the source candidate pixel extracted by the source candidate extracting section, by using the processor.

According to another aspect of the present invention, a computer readable storage medium having stored therein a computer program for causing a computer to function as the moving target detecting apparatus.

According to another aspect of the present invention, a method of detecting a moving target by a moving target detecting apparatus including a memory for storing data and a processor for processing the data based on first image data indicating a first image and second image data indicating a second image, which are stored on the memory. The moving target detecting method may include:

extracting a pixel increasing in a luminance value as a destination candidate pixel, by the processor, from a plurality of pixels included in the first image and the second image, based on the first image and the second image indicated by the first image data and the second image data stored on the memory;

extracting a pixel decreasing in a luminance value as a source candidate pixel, by the processor, from the plurality of pixels included in the first image and the second image, based on the first image and the second image indicated by the first image data and the second image data stored on the memory; and

extracting the destination candidate pixel as a target pixel, by the processor, when the destination candidate pixel is paired with the source candidate pixel, based on the destination candidate pixel extracted and the source candidate pixel extracted.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows an example of the overall system configuration of a moving target detecting system 800 according to a first embodiment;

FIG. 2 shows an example of the external view of the moving target detecting apparatus 100 according to the first embodiment;

FIG. 3 shows examples of hardware resources of the moving target detecting apparatus 100 according to the first embodiment;

FIG. 4 shows a functional block diagram illustrating an example configuration of the moving target detecting apparatus 100 according to the first embodiment;

FIG. 5 shows a flow chart illustrating an example flow of a moving target detecting process for detecting a moving target by the moving target detecting apparatus 100 according to the first embodiment;

FIG. 6 shows a flow chart illustrating an example flow of an initializing process S510 for initializing the moving target detecting process by the moving target detecting apparatus 100 according to the first embodiment;

FIG. 7 shows a flow chart illustrating an example flow of the first half of a vote percentage calculating process S520 for calculating the vote percentage for each pixel by the moving target detecting apparatus 100 according to the first embodiment;

FIG. 8 shows a flow chart illustrating an example flow of the last half of the vote percentage calculating process S520 for calculating the vote percentage of each pixel by the moving target detecting apparatus 100 according to the first embodiment;

FIG. 9 shows a flow chart illustrating an example flow of a target extracting process S560 for extracting a target pixel by the moving target detecting apparatus 100 according to the first embodiment;

FIG. 10 shows a flow chart illustrating an example flow of an adjacency target extracting process S570 for extracting a target pixel adjacent to another target pixel by the moving target detecting apparatus 100 according to the first embodiment;

FIG. 11 shows an example of the center pixel selected by a center selecting section 131 and the maximum vote number obtained by a maximum vote number calculating section 141 according to the first embodiment;

FIG. 12 shows examples of image data 411 and image data 412 which are inputted by an image inputting section 111 and a luminance increase value 420 which is obtained by an increase calculating section 132, according to the first embodiment;

FIG. 13 shows examples of increase vote numbers 431, decrease vote numbers 432, aggregation vote numbers 433, and vote percentages 434 obtained respectively by an increase vote calculating section 134, a decrease vote calculating section 136, a vote number aggregating section 137, and a vote percentage calculating section 143, according to the first embodiment;

FIG. 14 shows examples of target pixels extracted by a target extracting section 153 and an adjacency target extracting section 163, according to the first embodiment;

FIG. 15 shows a flow chart illustrating an example flow of a target outputting process S580 for outputting a detected target pixel by the moving target detecting apparatus 100 according to a second embodiment;

FIG. 16 shows examples of target pixels to be extracted by the moving target detecting apparatus 100 according to the second embodiment;

FIG. 17 shows a functional block diagram illustrating an example configuration of the moving target detecting apparatus 100 according to a third embodiment;

FIG. 18 shows a flow chart illustrating an example flow of the first half of the vote percentage calculating process S520 for calculating the vote percentage of each pixel by the moving pixels detecting apparatus 100 according to the third embodiment;

FIG. 19 shows a flow chart illustrating an example flow of the last half of the vote percentage calculating process S520 for calculating the vote percentage of each pixel by the moving target detecting apparatus 100 according to the third embodiment;

FIG. 20 shows examples of luminance evaluation values 425 obtained by an evaluation value calculating section 144 according to the third embodiment;

FIG. 21 shows an example of an evaluation value difference 427 obtained by an evaluation value difference calculating section 146 according to the third embodiment; and

FIG. 22 shows a functional block diagram illustrating an example configuration of the moving target detecting apparatus 100 according to a fourth embodiment.

### DETAILED DESCRIPTION OF THE PREFERRED EMBODIMENTS

Reference will now be made in detail to the present preferred embodiments of the invention, examples of which are illustrated in the accompanying drawings, wherein like reference numerals indicate like devices through out the several views.

### Embodiment 1

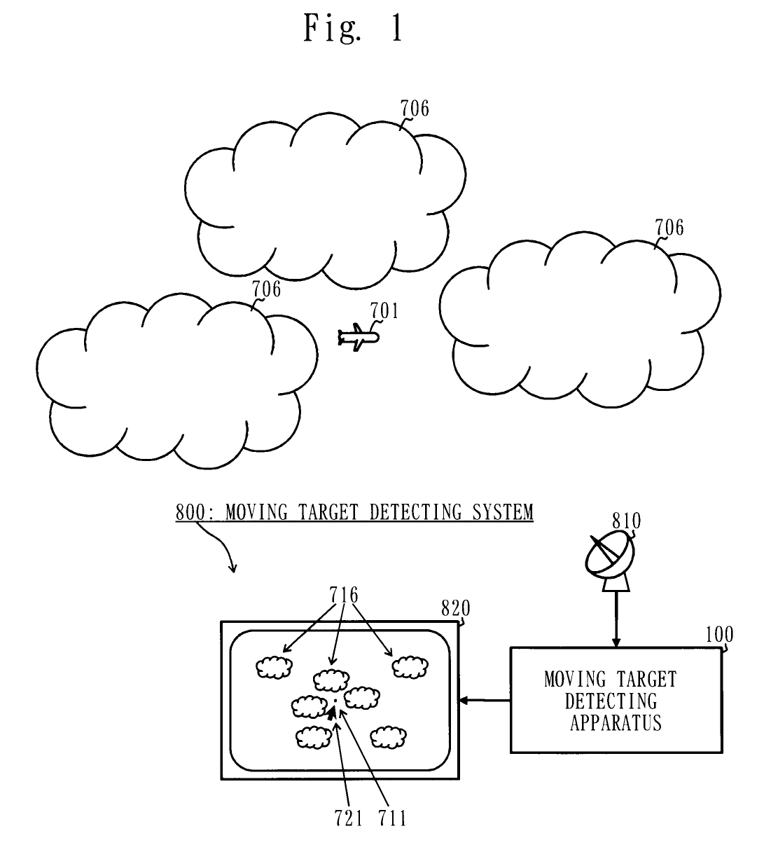

A first embodiment is described with reference to FIG. 1 to FIG. 14.

FIG. 1 shows an example of the overall system configuration of a moving target detecting system 800 according to this embodiment.

The moving target detecting system 800 may observe a moving object 701 such as an airplane and detect the position of an observed target.

The moving target detecting system 800 may include a sensor 801, a moving target detecting apparatus 100, and a detection result displaying apparatus 820.

The sensor 810 may be radar or a camera, for example. The sensor 810 may regularly observe a predetermined range, and produce a two-dimensional image as a result of observation. The two-dimensional image showing the result of observation made by the sensor 810 may consist of N by M pixels, for example. Each pixel shows the intensity of observation (hereinafter, referred to as a “luminance value”) in a predetermined tiny area within the predetermined range detected by the sensor 810. The sensor 810 may output data (hereinafter, referred to as “image data”) indicating the two-dimensional image showing the observation result. The image data may contain data (hereinafter, referred to as “luminance value data”) indicating the luminance value of each pixel.

The moving target detecting apparatus 100 may detect the moving object 701 based on a plurality of two-dimensional images in time-series observed by the sensor 810. The moving object 701 may be shown as a tiny object as a single pixel, for example, on the two-dimensional image showing the result of observation made by the sensor 810. The two-dimensional image showing the result of observation made by the sensor 810 may contain a complicated pattern such as clouds 706 in the background, in addition to the moving object 701 in some cases. The moving target detecting apparatus 100 may discriminate the moving object 701 against others by separating a pixel showing the moving object 701 from the background containing such as the clouds 706 on the two-dimensional image.

The detection result displaying apparatus 820 may display the result of detection made by the moving target detecting apparatus 100. More specifically, the detection result displaying apparatus 820 displays a two-dimensional image containing a background 716 based on the image data outputted by the sensor 810, and then puts a highlight 721, such as an arrow to highlight a target pixel 711, over the two-dimensional image based on the result of detection made by the moving target detecting apparatus 100, for example.

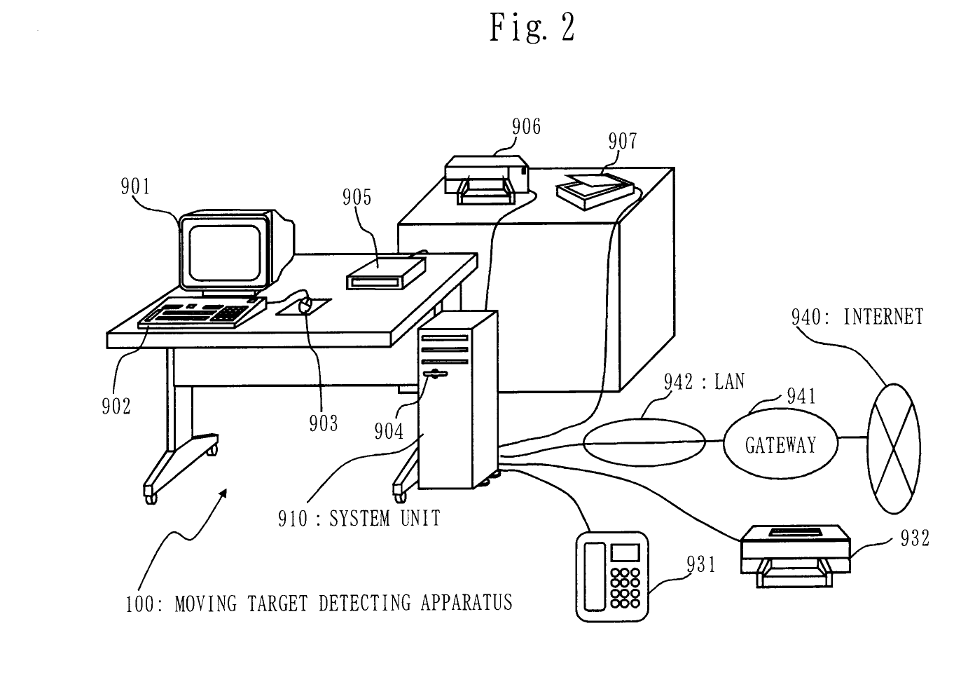

FIG. 2 shows an example of the external view of the moving target detecting apparatus 100 according to this embodiment.

The moving target detecting apparatus 100 may be configured to include hardware resources, such as a system unit 910, a display 901 having a CRT (Cathode Ray Tube) display screen or an LCD (Liquid Crystal Display) display screen, a keyboard (K/B) 902, a mouse 903, a Flexible Disk Drive (FDD) 904, a compact disk drive (CDD) 905, a printer 906, and a scanner 907, which are connected to one another via cables or signal lines.

The system unit 910 is a computer, which is connected to a facsimile machine 932 and a telephone unit 931 via cables, and also connected to the Internet 940 via a local area network (LAN) 942 and a gateway 941.

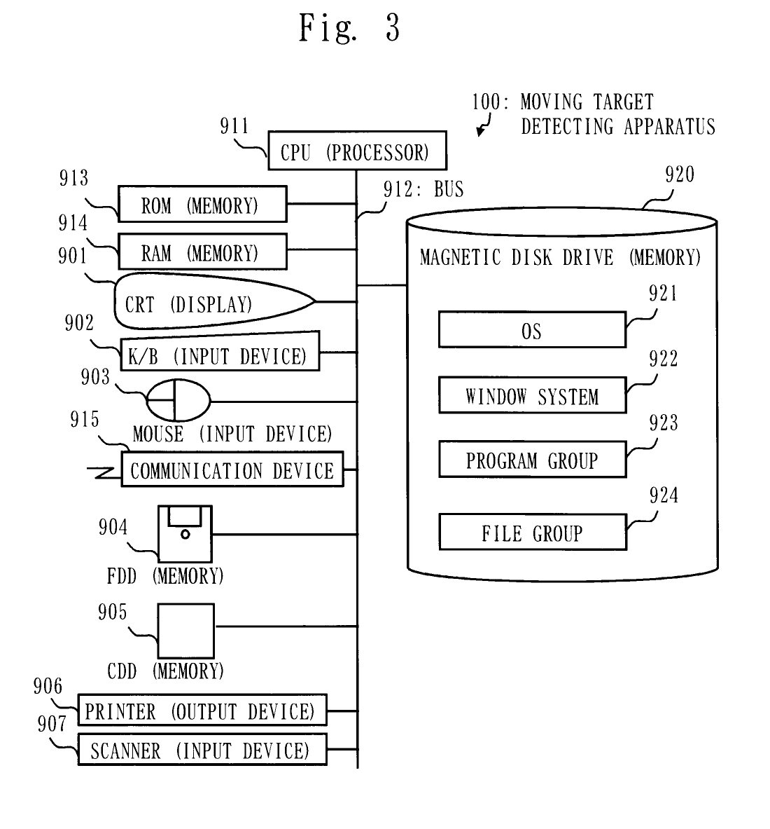

FIG. 3 shows examples of hardware resources of the moving target detecting apparatus 100 according to this embodiment.

The moving target detecting apparatus 100 may be configured to include a Central Processing Unit (CPU) 911, which may also be referred to as a processor, a computer, a microprocessor, or a microcomputer, for executing programs. The CPU 911 may be connected, via a bus 912, to a ROM 913, a RAM 914, a communication device 915, the display 901, the keyboard 902, the mouse 903, the FDD 904, the CDD 905, the printer 906, the scanner 907, and a magnetic disk drive 920, and control those hardware devices. It should be noted that the magnetic disk drive 920 may be replaced by a storage device such as an optical disk drive or a memory card read/write device.

The RAM 914 is an example of a volatile memory. The ROM 913, and the storage media such as the FDD 904, the CDD 905, and the magnetic disk drive 920 are examples of nonvolatile memories. These are examples of storage units or storing sections.

The communication device 915, the keyboard 902, the scanner 907 and the FDD 904 are examples of input sections or input devices.

The communication device 915, the display 901, the printer 906 are examples of output sections or output devices.

The communication device 915 may be connected to the facsimile machine 932, the telephone unit 931, the LAN 942, etc. The communication device 915 may not necessarily be connected to the LAN 942, but may alternatively be connected to the Internet 940, a Wide Area Network (WAN) such as IDSN, or the like. If the communication device 915 is connected to the Internet 940 or the WAN such as ISDN, then the gateway 941 is made redundant.

The magnetic disk drive 920 may store an operating system (OS) 921, a window system 922, a program group 923, and a file group 924. Programs in the program group 923 may be executed by using the CPU 911, the operating system 921, and the window system 922.

The program group 923 may store programs each causing a computer to execute a function that is described as a “section” in the following descriptions of this and other embodiments. The programs may be read and executed by the CPU 911.

The file group 924 may store information, data, a signal value, a variable value, and a parameter, each of which is referred to as a “determination result”, a “calculation result”, or a “process result” in the following descriptions of this and other embodiments, as a “file” item or a “database” item. A “file” and a “database” may be stored in a storage medium such as a disk or a memory. Information, data, signal values, variable values, and parameters stored in the storage medium, such as a disk or a memory, may be read by the CPU 911, via a read/write circuit, to be buffered in a main memory or a cache memory for a CPU operation for extraction, retrieval, reference, comparison, arithmetic operation, calculating processing, outputting, displaying, or the like. The information, data, signal values, variable values, parameters may be buffered temporarily in a main memory, a cache memory, or a buffer memory during the CPU operation for extraction, retrieval, reference, comparison, arithmetic operation, calculating processing, outputting, displaying, etc.

Arrows shown in the flow charts of the accompanying drawings for describing this and other embodiments mainly indicate the inputs/outputs of data or signals. The data and signal values may be stored in the RAM 914 for a memory, the FDD 904 for a flexible disk, the CDD 905 for a compact disk, the magnetic disk drive 920 for a magnetic disk, or any other type of storage medium such as an optical disk, a minidisk, or a Digital Versatile Disk (DVD). The data and signals may be transmitted online by way of the bus 912, a signal line, a cable, or any other type of transmission medium.

It should be noted that an element described as a “section” in the following descriptions of this and other embodiments may be replace by a “circuit”, a “device”, or “equipment”, or even by a “step”, a “procedure”, or a “process”. More specifically, the element described as a “section” may be implemented by firmware stored in the ROM 913. Alternatively, the element as a “section” may be implemented exclusively by software; exclusively by hardware such as an elemental device, a device, a substrate, or wiring; by a combination of software and hardware; or by a combination of software, hardware and firmware. Firmware and software may be stored each as a program in a storage medium, such as a magnetic disk, a flexible disk, an optical disk, a compact disk, a mini disk, a DVD, or the like. The program is read and executed by the CPU 911. More specifically, the program causes a computer to function as a “section” described below, or causes a computer to execute the procedure or method performed by a “section” described below.

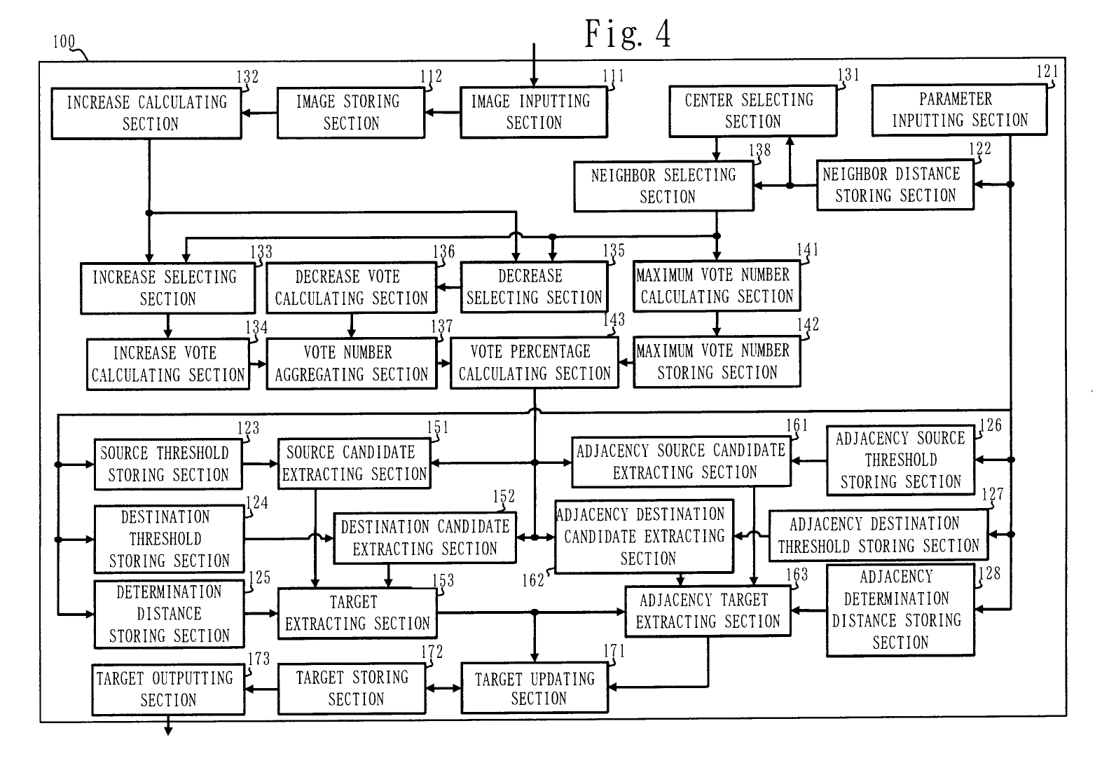

FIG. 4 shows a functional block diagram illustrating an example configuration of the moving target detecting apparatus 100 according to this embodiment.

The moving target detecting apparatus 100 may be configured to include an image inputting section 111, an image storing section 112, a parameter inputting section 121, a neighbor distance storing section 122, a source threshold storing section 123, a destination threshold storing section 124, a determination distance storing section 125, an adjacency source threshold storing section 125, an adjacency destination threshold storing section 127, an adjacency determination distance storing section 128, a center selecting section 131, a neighbor selecting section 138, an increase calculating section 132, an increase selecting section 133, an increase vote calculating section 134, a decrease selecting section 135, a decrease vote calculating section 136, a vote number aggregating section 137, a maximum vote number calculating section 141, a maximum vote number storing section 142, a vote percentage calculating section 143, a source candidate extracting section 151, a destination candidate extracting section 152, a target extracting section 153, an adjacency source candidate extracting section 161, an adjacency destination candidate extracting section 162, an adjacency target extracting section 163, a target updating section 171, a target storing section 172, and a target outputting section.

The parameter inputting section 121 may input a parameter to determine the degree of sensitivity to detect a moving target, by using the keyboard 902, or the like. Parameters inputted by the parameter inputting section 121 may include a neighbor distance, a source threshold, a destination threshold, a determination distance, an adjacency source threshold, an adjacency destination threshold, and an adjacency determination distance. The parameter inputting section 121 may output data indicating an inputted parameter, by using the CPU 911.

The neighbor distance may be defined as the number of pixels for determining a center neighbor range. The center neighbor range may be defined as a range containing a plurality of pixels in the neighborhood of a specific pixel (a center pixel) among a plurality of pixels included in a two-dimensional image generated by the sensor 810. More specifically, the center neighbor range is a rectangular area having a center pixel in the center, and the neighbor distance indicates the number of pixels on one side of the center neighbor range, for example. Alternatively, the center neighbor range is a circular area having a center pixel in the center, and the neighbor distance indicates a diameter of the center neighbor range, for example. The parameter inputting section 121 may output data (hereafter, referred to as “neighbor distance data”) indicating the inputted neighbor distance, by using the CPU 911. The neighbor distance storing section 122 may input the neighbor distance data outputted by the parameter inputting section 121, by using the CPU 911, and store the neighbor distance data, by using the magnetic disk drive 920.

The source threshold may be defined as a threshold for determining a source candidate pixel. The source candidate pixel may be defined as a pixel that is determined to be likely to show a target in the previous one of two two-dimensional images consecutive in time-series. The parameter inputting section 121 may output data (hereinafter, referred to as “source threshold data”) indicating the inputted source threshold, by using the CPU 911. The source threshold storing section 123 may input the source threshold data outputted by the parameter inputting section 121, by using the CPU 911, and store the source threshold data, by using the magnetic disk drive 920.

The destination threshold may be defined as a threshold for determining a destination candidate pixel. The destination candidate pixel may be defined as a pixel that is determined to be likely to show a target in the following one of two two-dimensional images consecutive in time-series. The parameter inputting section 121 may output data (hereinafter, referred to as “destination threshold data”) indicating the inputted destination threshold, by using the CPU 911. The destination threshold storing section 124 may input the destination threshold data outputted by the parameter inputting section 121, by using the CPU 911, and store the destination threshold data by using the magnetic disk drive 920.

The determination distance may be defined as the number of pixels for determining a pair of the source candidate pixel and the destination candidate pixel. More specifically, the source candidate pixel and the destination candidate pixel are determined as a pair, when a linear distance between them on an image measured by the number of pixels is equal to or less than the determination distance, for example. Alternatively, they are determined as a pair, when a row-wise distance and a column-wise distance between them on an image measured by the number of pixels are both equal to or less than the determination distance. The parameter inputting section 121 may output data (hereinafter, referred to as “determination distance data”) indicating the inputted determination distance, by using the CPU 911. The determination distance storing section 125 may input the determination distance data outputted by the parameter inputting section 121, by using the CPU 91, and store the determination distance data by using the magnetic disk drive 920.

The adjacency source threshold may be defined as a threshold for determining an adjacency source candidate pixel. The adjacency source candidate pixel may be defined as a pixel that is located adjacent to another target, and therefore not determined to be likely to show the specific target based on the source threshold. After a further detection, however, the adjacency source candidate pixel may be determined to be likely to show the specific target. The parameter inputting section 121 may output data (hereinafter, referred to as “adjacency source threshold data”) indicating the adjacency source threshold, by using the CPU 911. The adjacency source threshold storing section 125 may input the adjacency source threshold data outputted by the parameter inputting section 121, by using the CPU 911, and store the adjacency source threshold data by using the magnetic disk drive 920.

The adjacency destination threshold may be defined as a threshold for determining an adjacency destination candidate pixel. The adjacency destination candidate pixel may be defined as a pixel that is located adjacent to another target, and therefore not determined to be likely to show the specific target based on the destination threshold. After a further detection, however, the adjacency destination candidate pixel may be determined to be likely to show the specific target. The parameter inputting section 121 may output data (hereinafter, referred to as “adjacency destination threshold data”) indicating the adjacency destination threshold. The adjacency destination threshold storing section 127 may input the adjacency destination threshold data outputted by the parameter inputting section 121, by using the CPU 911, and store the adjacency destination threshold data by using the magnetic disk drive 920.

The adjacency determination distance may be defined as the number of pixels for determining a pair of the adjacency source candidate pixel and the adjacency destination candidate pixel. The adjacency determination distance is similar to the determination distance. The parameter inputting section 121 may output data (hereinafter, referred to as “adjacency determination distance data”) indicating the inputted adjacency determination distance, by using the CPU 911. The adjacency determination distance storing section 128 may input the adjacency determination distance data outputted by the parameter inputting section 121, by using the CPU 911, and store the inputted adjacency determination distance data, by using the magnetic disk drive 920. It should be noted that the adjacency determination distance may be the same as the determination distance, in which case, however, the determination distance storing section 125 may be used to function as the adjacency determination distance storing section 128.

The center selecting section 131 may select at least two pixels from among the plurality of pixels of the two-dimensional image generated by the sensor 810 as the center pixels, by using the CPU 911. With this embodiment, the center selecting section 131 inputs the neighbor distance data stored by the neighbor distance storing section 122, and selects as the center pixel, each pixel whose center neighbor range falls within the two-dimensional image, based on the inputted neighbor distance data, by using the CPU 911. More specifically, if the center neighbor range is a rectangular area having a center pixel in the center with a neighbor distance L₁ on a side, or a circular area with the neighbor distance L₁ in diameter, then the center selecting section 131 selects, as the center pixel, a pixel that is at least L₁/2-1 pixels away from the edge of the two-dimensional image, by using the CPU 911. The center selecting section 131 may output data (hereinafter, referred to as “center pixel data”) indicating the selected center pixels, by using the CPU 911.

It should be noted that the center selecting section 131 may select all the pixels of the two-dimensional image as the center pixels, in which case, however, the center selecting section 131 may be redundant.

For each of the plurality of the center pixels selected by the center pixel selecting section 131, the neighbor selecting section 138 may select pixels (hereinafter, referred to “center neighbor pixels”) located within the center neighbor range of the center pixel, by using the CPU 911. The neighbor selecting section 138 may input the neighbor distance data stored by the neighbor distance storing section 122 and the center pixel data outputted by the center selecting section 131, by using the CPU 911. The neighbor selecting section 138 may then select the center neighbor pixels located within the center neighbor range having the center pixel indicated by the center pixel data in the center and the neighbor distance L₁ indicated by the neighbor distance data on one side or in diameter, based on the inputted neighbor distance data and the inputted center pixel data, by using the CPU 911. The neighbor selecting section 138 may then output data (hereinafter, referred to as “neighbor pixel data”) indicating the center neighbor pixels selected for each center pixel, by using the CPU 911.

The maximum vote number calculating section 141 may input the neighbor pixel data outputted by the neighbor selecting section 138, by using the CPU 911. The maximum vote number calculating section 141 may calculate a maximum vote number for each of the pixels of the two-dimensional image, based on the inputted neighbor pixel data, by using the CPU 911. The maximum vote number may be defined as the number of center pixels each of which has the pixel of the two-dimensional image within its center neighbor range. The maximum vote number calculating section 141 may output data (hereinafter, referred to as “maximum vote number data”) indicating the maximum vote number obtained for each pixel, by using the CPU 911. The maximum vote number storing section 142 may input the maximum vote number data outputted by the maximum vote number calculating section 141, by using the CPU 911, and store the maximum vote number data by using the magnetic disk drive 920.

The image inputting section 111 may regularly input image data outputted by the sensor 810, by using the communication device 915. The image inputting section 111 may also output the inputted image data, by using the CPU 911.

The image storing section 112 may regularly input the image data outputted by the image inputting section 111, by using the CPU 911. The image storing section 112 may then accumulate and store the inputted image data, by using the magnetic disk drive 920. More specifically, the image storing section 112 may hold at least two image data items including the latest image data and the second-latest image data.

The increase calculating section 132 may input the two image data items of those stored by the image storing section 112, by using the CPU 911. The increase calculating section 132 may calculate a difference (hereinafter, referred to as a “luminance increase value”) for each of the plurality of pixels included in the two images indicated by the two image data items, based on the inputted two image data items, by using the CPU 911. Specifically, the increase calculating section 132 may obtain the luminance increase value, by subtracting the luminance value of an image (hereinafter, referred to as a “first image”) indicated by the previous image data (hereinafter, referred to as “first image data”) in time-series of the two image data items from the luminance value of an image (hereinafter, referred to as a “second image”) indicated by the following image data (hereinafter, referred to as “second image data”) of in time-series of the two image data items. The increase calculating section 132 may then output data (hereinafter, referred to as “luminance increase value data”) indicating the luminance increase value obtained for each pixel, by using the CPU 911.

The luminance value of a pixel showing a target is higher than those of other pixels. If a target is shown in the background containing a complicated pattern, however, the pixel showing the target cannot be discriminated against others based only on a predetermined threshold.

When a target moves and thereby the pixel showing the target changes, in comparison between the first and second images, the luminance value of the pixel showing the target of the first image is reduced, and the luminance value of the pixel showing the target of the second image is increased. Given this fact, the pixel showing the target may be discriminated against others based on the luminance increase value obtained by the increase calculating section 132.

The increase selecting section 133 may input the neighbor pixel data outputted by the neighbor selecting section 138 and the luminance increase value data outputted by the increase calculating section 132, by using the CPU 911. The increase selecting section 133 may obtain a pixel having the largest luminance increase value (hereinafter, referred to as an “evaluation increase pixel”) of the center neighbor pixels indicated by the neighbor pixel data, for each of the plurality of center pixels selected by the center selecting section 131, based on the inputted neighbor pixel data and the inputted luminance increase value data, by using the CPU 911. The increase selecting section 133 may output data (hereinafter, referred to as “evaluation increase pixel data”) indicating the evaluation increase pixel obtained for each center pixel, by using the CPU 911.

The increase vote calculating section 134 may input the evaluation increase pixel data outputted by the increase selecting section 133, by using the CPU 911. For each of the plurality of pixels included in the two images, the increase vote calculating section 134 may calculate the number of times (hereinafter, referred to as an “increase vote number”) the pixel is selected as the evaluation increase pixel, based on the inputted evaluation increase pixel data, by using the CPU 911. The increase vote calculating section 134 may output data (hereinafter, referred to as “increase vote number data”) indicating the increase vote number obtained for each pixel, by using the CPU 911.

The decrease selecting section 135 may input the neighbor pixel data outputted by the neighbor selecting section 138 and the luminance increase value data outputted by the increase calculating section 132, by using the CPU 911. The decrease selecting section 135 may then obtain a pixel (hereinafter, referred to as an “evaluation decrease pixel”) having the smallest luminance increase value (i.e., the largest decreased amount of the luminance value) of the center neighbor pixels indicated by the neighbor pixel data, for each of the plurality of center pixels selected by the center selecting section 131, based on the inputted neighbor pixel data and the inputted luminance increase value data, by using the CPU 911. The decrease selecting section 135 may then output data (hereinafter, referred to as “evaluation decrease pixel data”) indicating the evaluation decrease pixel obtained for each center pixel, by using the CPU 911.

The decrease vote calculating section 136 may input the evaluation decrease pixel data outputted by the decrease selecting section 135, by using the CPU 911. For each of the plurality of pixels included in the two images, the decrease vote calculating section 136 may then calculate the number of times (hereinafter, referred to as a “decrease vote number”) the pixel is selected as the evaluation decrease pixel, based on the inputted evaluation decrease pixel data, by using the CPU 911. The decrease vote calculating section 136 may then output data (hereinafter, referred to as “decrease vote number data”) indicating the decrease vote number obtained for each pixel, by using the CPU 911.

If the background of an image showing a target contains a complicated pattern, then it is likely that the luminance value of a pixel showing no object also increases or decreases. Given this fact, it may be estimated that a pixel having the largest increment/decrement of the luminance value within the neighbor range of a specific pixel is showing/has shown the target, and the other pixels only show parts of the background.

This estimation may, however, produce a different result from a different neighbor range applied. Given this fact, a plurality of center pixels may be selected to aggregate a plurality of results of the estimation from different neighbor ranges to enhance reliability in the result of the estimation.

The vote number aggregating section 137 may input the increase vote number data outputted by the increase vote calculating section 134 and the decrease vote number data outputted by the decrease vote calculating section 136, by using the CPU 911. The vote number aggregating section 137 may calculate a difference (hereinafter, referred to as an “aggregation vote number”) for each of the plurality of pixels included in the two images, based on the inputted increase vote number data and the inputted decrease vote number data. The aggregation vote number may be obtained by subtracting the decrease vote number indicated by the decrease vote number data from the increase vote number indicated by the increase vote number data. The vote number aggregating section 137 may then output data (hereinafter, referred to as “aggregation vote number data”) indicating the aggregation vote number obtained for each pixel, by using the CPU 911. The aggregation vote number has a positive value if the increase vote number is larger than the decrease vote number. If the increase vote number is smaller than the decrease vote number, then the aggregation vote number has a negative value. If the increase vote number and the decrease vote number have the same value (zero in many cases), then the aggregation vote number is zero.

The vote percentage calculating section 143 may input the maximum vote number data stored by the maximum vote number storing section 142 and the aggregation vote number data outputted by the vote number aggregating section 137, by using the CPU 911. The vote percentage calculating section 143 may then calculate a quotient (hereinafter, referred to as a “vote percentage”) for each of a plurality of pixels included in the two images, based on the inputted maximum vote number data and the inputted aggregation vote number data, by using the CPU 911. The vote percentage may be obtained by dividing the aggregation vote number indicated by the aggregation vote number data by the maximum vote number indicated by the maximum vote number data. The vote percentage calculating section 143 may then output data (hereinafter, referred to as “vote percentage data”) indicating the vote percentage obtained for each pixel, by using the CPU 911.

However, the number of times a pixel is included in the center neighbor range may differ between a pixel in the vicinity of the center of an image and a pixel in the vicinity of an edge of the image. Given this fact, when a plurality of results of the estimation applying different neighbor ranges is aggregated, vote percentages themselves rather than aggregation vote numbers may be compared. This may enhance reliability in the results of the estimation, especially for the pixels in the vicinity of the edges of an image.

It should be noted that if pixels in the vicinity of the edges of an image are not to be detected to see whether they show a target, then the aggregation vote numbers themselves may be compared. In this case, the maximum vote number calculating section 141, the maximum vote number storing section 142, and the vote percentage calculating section 143 may be redundant. Alternatively, it is also possible that the increase vote numbers or the decrease vote numbers are compared themselves rather than the aggregation vote numbers themselves are compared. In this case, the vote number aggregating section 137 may also be made redundant together with the maximum vote number calculating section 141, the maximum vote number storing section 142, and the vote percentage calculating section 143.

The source candidate extracting section 151 may input the source threshold data stored by the source threshold storing section 123 and the vote percentage data outputted by the vote percentage calculating section 143, by using the CPU 911. The source candidate extracting section 151 may compare the vote percentage indicated by the vote percentage data and the source threshold indicated by the source threshold data, for each of the plurality of pixels included in the two images, based on the inputted source threshold data and the inputted vote percentage data, by using the CPU 911. The source candidate extracting section 151 may then determine a pixel as the source candidate pixel if the vote percentage of the pixel is smaller than the source threshold. With this specific example, the source threshold is a value more than −1 and less than 0, e.g., −0.5. The source candidate extracting section 151 may then output data (hereinafter, referred to as “source candidate data”) indicating the extracted source candidate pixel, by using the CPU 911.

The destination candidate extracting section 152 may input the destination threshold data stored by the destination threshold storing section 124 and the vote percentage data outputted by the vote percentage calculating section 143, by using the CPU 911. The destination candidate extracting section 152 may compare the vote percentage indicated by the vote percentage data and the destination threshold indicated by the destination threshold data, for each of the plurality of pixels included in the two images, based on the inputted destination threshold data and the inputted vote percentage data, by using the CPU 911. The destination candidate extracting section 152 may then determine that a pixel as the destination candidate pixel if the vote percentage of the pixel is larger than the destination threshold. With this specific example, the destination threshold is more than 0 and less than 1, e.g. 0.5. The destination candidate extracting section 152 may then output data (hereinafter, referred to as “destination candidate data”) indicating the extracted destination candidate pixel, by using the CPU 911.

The target extracting section 153 may input the source candidate data outputted by the source candidate extracting section 151, the destination candidate data outputted by the destination candidate extracting section 152, and the determination distance data stored by the determination distance storing section 125, by using the CPU 911. The target extracting section 153 may extract a destination candidate pixel as the target pixel from the destination candidate pixels indicated by the destination candidate data, when the destination candidate pixel is paired with a source candidate pixel among the source candidate pixels indicated by the source candidate data, based on the inputted source candidate data, the inputted destination candidate data, and the inputted determination distance data, by using the CPU 911. The target extracting section 153 may then output data (hereinafter, referred to as “target pixel data”) indicating the extracted target pixel, by using the CPU 911.

That the destination candidate pixel is paired with the source candidate pixel means that there is a source candidate pixel within a neighbor candidate range having the destination candidate pixel in the center, among other pixels (hereinafter, referred to as “neighbor candidate pixels”). The neighbor candidate range may be defined as an area determined by a determination range L₂. The neighbor candidate range may be a rectangular area having the destination candidate pixel in the center, with the determination distance L₂ on a side, for example. Alternatively, the neighbor candidate range may be a circular area having the destination candidate pixel in the center, with the determination distance L₂ in diameter, for example.

When increase/decrease of the luminance value is used for discriminating against others a pixel showing a target/a pixel having shown a target, a defective pixel might be misjudged as a pixel showing a target/a pixel having shown a target. The defective pixel may be defined as a pixel having a luminance value that has nothing to do with whether or not the target is shown. The defective pixel may be produced as a result of failure in the sensor 810 or the like. A defective pixel with a constant luminance value, whose luminance increase value is 0, is not likely to be misjudged as the target pixel. A defective pixel with a random luminance value (e.g., a blinking defective pixel) is likely to be misjudged as the target pixel, since the luminance value varies.

When the target moves and thereby the pixel showing the target changes, a pixel whose luminance value is increased and a pixel whose luminance value is decreased are paired with each other. The blinking defective pixel, although discriminated against others as a pixel whose luminance value is increased or decreased, is however paired with no pixel. Given this fact, the target extracting section 153 may exclusively extract the destination candidate pixel having the paired source candidate pixel as the target pixel. The target extracting section 153 may therefore never extract the destination candidate pixel having no paired pixel as the target pixel.

The adjacency source candidate extracting section 161 may input the adjacency source threshold data stored by the adjacency source threshold storing section 125 and the vote percentage data outputted by the vote percentage calculating section 143, by using the CPU 911. The adjacency source candidate extracting section 161 may compare the vote percentage indicated by the vote percentage data and the adjacency source threshold indicated by the adjacency source threshold data, for each of the plurality of pixels included in the two images, based on the inputted adjacency source threshold data and the inputted vote percentage data, by using the CPU 911. The adjacency source candidate extracting section 161 may then determine a pixel as the adjacency source candidate pixel if the vote percentage of the pixel is smaller than the adjacency source threshold. With this specific example, the adjacency source threshold is more than the source threshold and less than 0, e.g., −0.2. The adjacency source candidate extracting section 161 may then output data (hereinafter, referred to as “adjacency source candidate data”) indicating the extracted adjacency source candidate pixel, by using the CPU 911.

The adjacency destination candidate extracting section 162 may input the adjacency destination threshold data stored by the adjacency destination threshold storing section 127 and the vote percentage data outputted by the vote percentage calculating section 143, by using the CPU 911. The adjacency destination candidate extracting section 162 may compare the vote percentage indicated by the vote percentage data and the adjacency destination threshold indicated by the adjacency destination threshold data, for each of the plurality of pixels included in the two images, based on the inputted adjacency destination threshold data and the inputted vote percentage data, by using the CPU 911. The adjacency destination candidate extracting section 162 may then determine that a pixel is the adjacency destination candidate pixel if the vote percentage of the pixel is larger than the adjacency destination threshold. With this specific example, the adjacency destination threshold is more than 0 and less than the destination threshold, e.g., 0.2. The adjacency destination candidate extracting section 162 may then output data (hereinafter, referred to as “adjacency destination candidate data”) indicating the extracted adjacency destination candidate pixel, by using the CPU 911.

The adjacency target extracting section 163 may input the target pixel data outputted by the target extracting section 153, the adjacency source candidate data outputted by the adjacency source candidate extracting section 161, the adjacency destination candidate data outputted by the adjacency destination candidate extracting section 162, and the adjacency determination distance data stored by the adjacency determination distance storing section 128, by using the CPU 911. The adjacency target extracting section 163 may extract an adjacency destination candidate pixel as the target pixel from the adjacency destination candidate pixels indicated by the adjacency destination candidate data, when the adjacency destination candidate pixel is paired with an adjacency source candidate pixel among the adjacency source candidate pixels indicated by the adjacency source candidate data, based on the inputted adjacency source candidate data, the inputted adjacency destination candidate data, the inputted adjacency determination distance data, and the inputted target pixel data, by using the CPU 911. The adjacency target extracting section 163 may then output the target pixel data indicating the extracted target pixel, by using the CPU 911.

The adjacency destination candidate pixel in the neighborhood of the target pixel may be defined as the adjacency destination candidate pixel within the center neighbor range when the target pixel is the center pixel. That the adjacency destination candidate pixel is paired with the adjacency source candidate pixel means that an adjacency source candidate pixel within the adjacency neighbor candidate range having the adjacency destination candidate pixel in the center, among other pixels. The adjacency neighbor candidate range may be defined as an area determined by an adjacency determination range L₃.

When a plurality of target pixels locate close to each other, a target pixel having a large luminance increase value may get a high concentration of votes while a target having a small luminance increase value may get votes below the destination threshold in some cases. This is also true with the source candidate pixels. Given this fact, the destination candidate pixel and the source candidate pixel may be extracted again with the threshold being lowered only for the pixels located in the neighborhood of the target pixel extracted by the target extracting section 153. This may allow for an effective extraction of a plurality of target pixels located close to each other.

The target updating section 171 may input the target pixel data outputted by the target extracting section 153 and the target pixel data outputted by the adjacency target extracting section 163, by using the CPU 911. The target updating section 171 may output the inputted target pixel data to the target storing section 172, by using the CPU 911. The target storing section 172 may input the target pixel data outputted by the target updating section 171, by using the CPU 911, and store the inputted target pixel data by using the magnetic disk drive 920.

The target outputting section 173 may input the target pixel data stored by the target storing section 172, by using the CPU 911. The target outputting section may output the inputted target pixel data, by using the communication device 915.

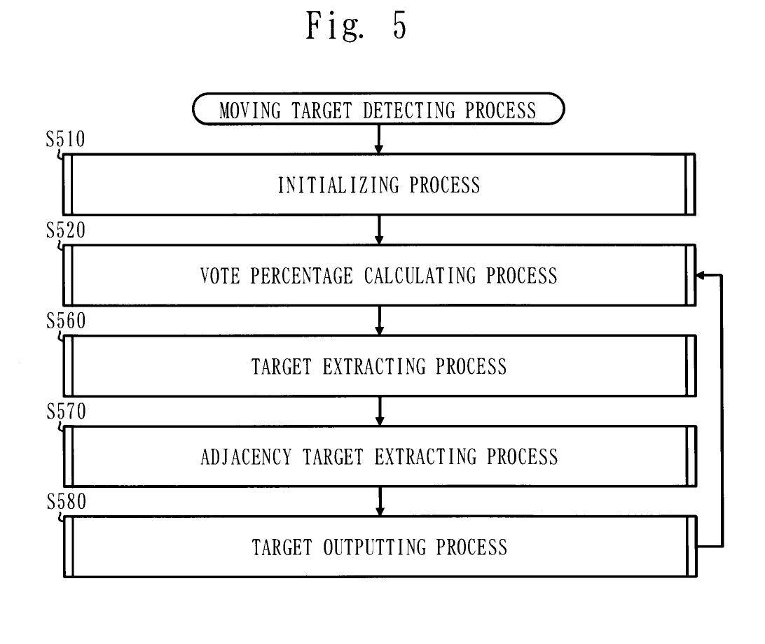

FIG. 5 shows a flow chart illustrating an example flow of a moving target detecting process for detecting a moving target by the moving target detecting apparatus 100 according to this embodiment.

In an initializing process S510, the moving target detecting apparatus 100 performs initialization such as inputting parameters.

In a vote percentage calculating process S520, the moving target detecting apparatus 100 inputs new image data and calculates the vote percentage based on the inputted image data.

In a target extracting process S560, the moving target detecting apparatus 100 extracts the target pixel based on the vote percentage obtained in the vote percentage calculating process S520.

In an adjacency target extracting process S570, the moving target detecting apparatus 100 extracts the target pixel adjacent to the target pixel extracted in the target extracting process S560.

In a target outputting process S580, the moving target detecting apparatus 100 outputs the target pixel extracted in the adjacency target extracting process S560 or the adjacency target extracting process S570.

The process then returns to the vote percentage calculating process S520 to process the next item of the image data.

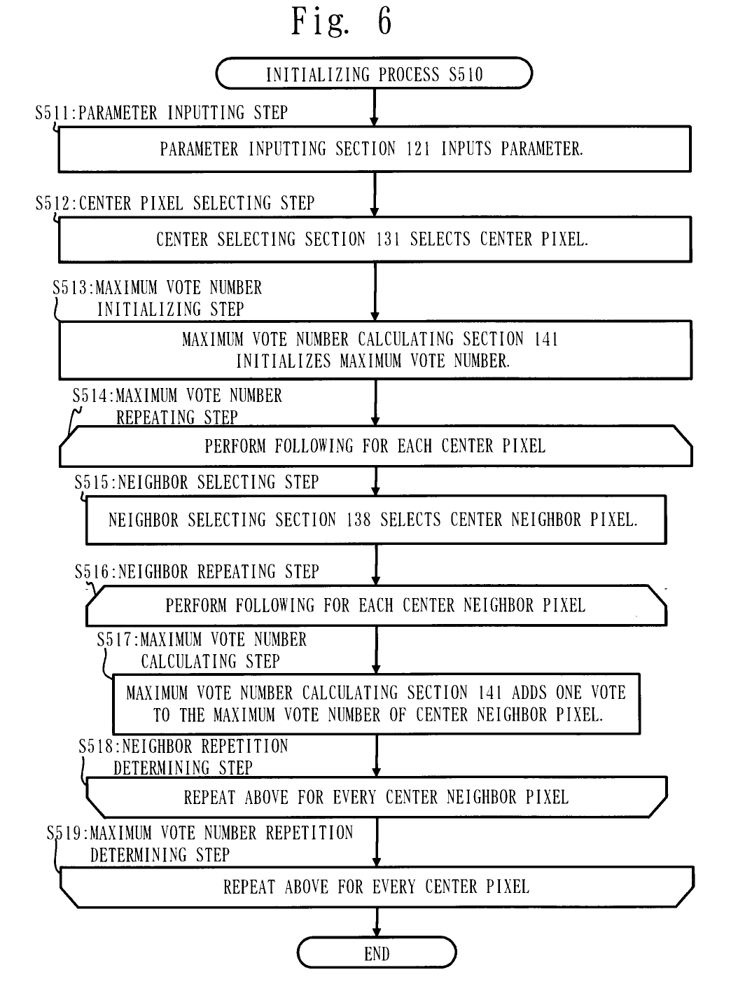

FIG. 6 shows a flow chart illustrating an example flow of the initializing process S510 for performing initialization for the moving target detecting process by the moving target detecting apparatus 100 according to this embodiment.

In a parameter inputting step S511, the parameter inputting section 121 inputs parameters such as the neighbor distance, the source threshold, the destination threshold, the determination distance, the adjacency source threshold, the adjacency destination threshold, and the adjacency determination distance, by using the keyboard 902, etc. The neighbor distance storing section 122, the source threshold storing section 123, the destination threshold storing section 124, the determination distance storing section 125, the adjacency source threshold storing section 125, the adjacency destination threshold storing section 127, and the adjacency determination distance storing section 128 store data indicating the parameters inputted by the parameter inputting section 121, by using the magnetic disk drive 920.

In a center pixel selecting step S512, the center selecting section 131 selects the plurality of center pixels, based on the neighbor distance stored by the neighbor distance storing section 122 in the parameter inputting step S511, by using the CPU 911. The center selecting section 131 stores the center pixel data indicating the selected plurality of center pixels, by using the magnetic disk drive 920.

In a maximum vote number initializing step S513, the maximum vote number calculating section 141 initializes the maximum vote number for every pixel in the two-dimensional image, by using the CPU 911. The maximum vote number storing section 142 stores the maximum vote number data indicating 0 as the maximum vote number for every pixel in the two-dimensional image.

In a maximum vote number repeating step S514, the neighbor selecting section 138 inputs the center pixel data stored by the center selecting section 131 in the center pixel selecting step S512, by using the CPU 911. The neighbor selecting section 138 selects one center pixel at a time from among all the center pixels indicated by the inputted center pixel data, by using the CPU 911. The neighbor selecting section 138 performs a neighbor selecting step S515 through a neighbor repetition determining step S518 for the selected center pixel. The neighbor selecting section 138 repeats these processes for every center pixel.

In the neighbor selecting step S515, for the center pixel selected in the maximum vote number repeating step S514, the neighbor selecting section 138 selects the plurality of center neighbor pixels in the neighborhood of the center pixel, by using the CPU 911. The neighbor selecting section 138 stores the neighbor pixel data indicating the selected plurality of center neighbor pixels, by using the magnetic disk drive 920.

In the neighbor repeating step S516, the maximum vote number calculating section 141 inputs the neighbor pixel data stored by the neighbor selecting section 138 in the neighbor selecting step S515. The maximum vote number calculating section 141 selects one pixel at a time from among all the center neighbor pixels indicated by the inputted neighbor pixel data, by using the CPU 911. The maximum vote number calculating section 141 performs the maximum vote number calculating step S517 for the selected center neighbor pixel. The maximum vote number calculating section 141 repeats this process for every center neighbor pixel.

In the maximum vote number calculating step S517, the maximum vote number calculating section 141 inputs the maximum vote number data stored by the maximum vote number storing section 142 for the selected center neighbor pixel based on the center neighbor pixel selected in the neighbor repeating step S516, by using the CPU 911. The maximum vote number calculating section 141 increases the maximum vote number indicated by the inputted maximum vote number data, by 1, by using the CPU 911. The maximum vote number storing section 142 stores the maximum vote number data indicating the maximum vote number increased by the maximum vote number calculating section 141, by using the magnetic disk drive 920.

In the neighbor repetition determining step S518, the maximum vote number calculating section 141 determines whether the maximum vote number calculating step S517 has been performed for every center neighbor pixel selected by the neighbor selecting section 138 in the neighbor selecting step S515 for the center pixel selected by the neighbor selecting section 138 in the maximum vote number repeating step S513, by using the CPU 911.

If it is determined that there is a center neighbor pixel remaining unprocessed, then the maximum vote number calculating section 141 returns to the neighbor repeating step S516 to select the next center neighbor pixel, by using the CPU 911.

If it is determined that every center neighbor pixel has been processed, then the process proceeds to a maximum vote number repetition determining step S519.

In the maximum vote number repetition determining step S519, the neighbor selecting section 138 determines whether the neighbor selecting step S515 through the neighbor repetition determining step S518 have been performed for every center pixel selected by the center selecting section 131 in the center pixel selecting step S512, by using the CPU 911.

If it is determined that there is a center pixel remaining unprocessed, then the maximum vote number calculating section 141 returns to the maximum vote number repeating step S514 to select the next center pixel, by using the CPU 911.

If it is determined that every center pixel has been processed, then the initializing process S510 is terminated.

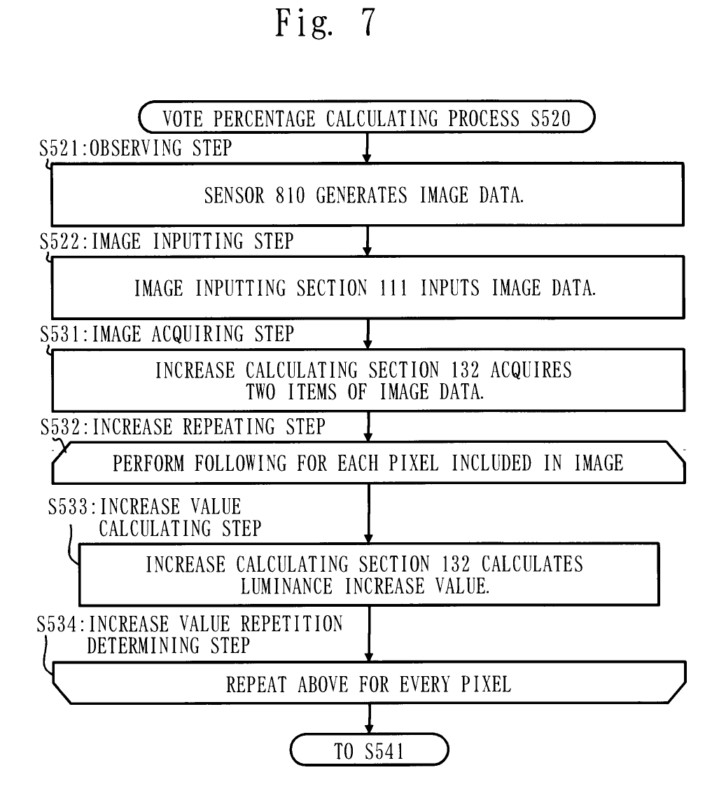

FIG. 7 shows a flow chart illustrating an example flow of the first half of the vote percentage calculating process S520 for calculating the vote percentage for each pixel by the moving target detecting apparatus 100 according to this embodiment.

In an observing step S521, the sensor 810 generates and outputs image data.

In an image inputting step S522, the image inputting section 111 inputs the image data outputted by the sensor 810 in the observing step S521, by using the communication device 915. The image storing section 112 stores the image data inputted by the image inputting section 111, by using the magnetic disk drive 920.

In an image acquiring step S531, the increase calculating section 132 acquires the latest image data and the second-latest image data among the image data stored by the image storing section 112 in the image inputting step S522, by using the CPU 911.

In an increase repeating step S532, the increase calculating section 132 selects one pixel at a time from among all the pixels included in the two-dimensional image, by using the CPU 911. The increase calculating section 132 performs an increase value calculating step S533 for the selected pixel. The increase calculating section 132 repeats this process for every pixel.

In the increase value calculating step S533, the increase calculating section 132 calculates the luminance increase value of the selected pixel, based on the two pieces of image data acquired in the image acquiring step S531, by using the CPU 911. The increase calculating section 132 also stores the luminance increase value data indicating the obtained luminance increase value, by using the magnetic disk drive 920.

In an increase value repetition determining step S534, the increase calculating section 132 determines whether the increase value calculating step S533 has been performed for every pixel included in the two-dimensional image, by using the CPU 911.

If it is determined that there is a pixel remaining unprocessed, then the increase calculating section 132 returns to the increase repeating step S532 to select the next pixel, by using the CPU 911.

If it is determined that every pixel has been processed, then the process proceeds to an increase vote number initializing step S541.

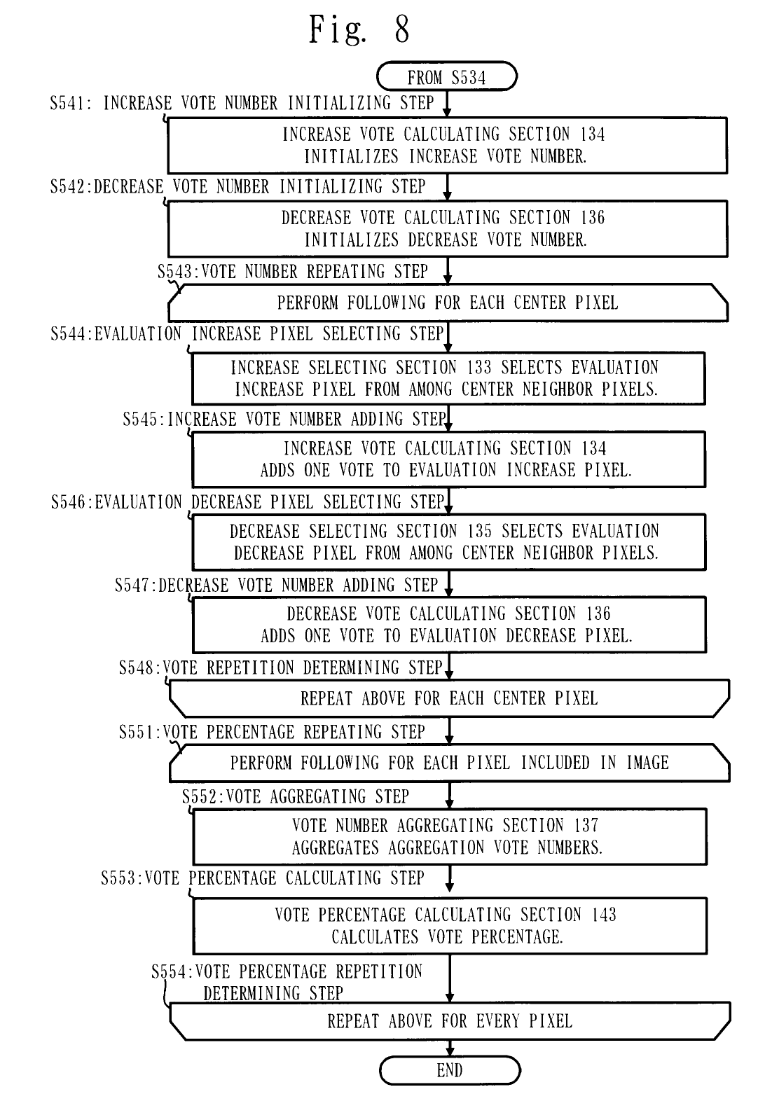

FIG. 8 shows a flow chart illustrating an example flow of the last half of the vote percentage calculating process S520 for calculating the vote percentage of each pixel by the moving target detecting apparatus 100 according to this embodiment.

In the increase vote number initializing step S541, the increase vote calculating section 134 initializes the increase vote number to 0 for each pixel included in the two-dimensional image, by using the CPU 911, and stores the increase vote number data indicating the initialized increase vote number, by using the magnetic disk drive 920.

In a decrease vote number initializing step S542, the decrease vote calculating section 136 initializes the decrease vote number to 0 for each pixel included in the two-dimensional image, by using the CPU 911, and stores the decrease vote number data indicating the initialized decrease vote number, by using the magnetic disk drive 920.

In a vote number repeating step S543, the increase selecting section 133 selects one center pixel at a time from among all the center pixels indicated by the center pixel data based on the center pixel data stored by the center selecting section 131 in the center pixel selecting step S512, by using the CPU 911. The increase selecting section 133 performs an evaluation increase pixel selecting step S544 through a decrease vote number adding step S547 for the selected pixel. The increase selecting section 133 repeats these processes for every center pixel.

In the evaluation increase pixel selecting step S544, the increase selecting section 133 selects one evaluation increase pixel from among the center neighbor pixels of the center pixel selected by the increase selecting section 133 in the vote number repeating step S543, based on the neighbor pixel data stored by the neighbor selecting section 138 and the luminance increase value data stored by the increase calculating section 132 in the increase value calculating step S533, by using the CPU 911.

In the increase vote number adding step S545, the increase vote calculating section 134 increases, by 1, the increase vote number indicated by the stored increase vote number data for the evaluation increase pixel selected by the increase selecting section 133 in the evaluation increase pixel selecting step S544, by using the CPU 911. The increase vote calculating section 134 stores the increase vote number data indicating the increased increase vote number, by using the magnetic disk drive 920.

In the evaluation decrease pixel selecting step S546, the decrease selecting section 135 selects one evaluation decrease pixel from among the center neighbor pixels of the center pixel selected by the increase selecting section 133 in the vote number repeating step S543, based on the neighbor pixel data stored by the neighbor selecting section 138 in the neighbor selecting step S515 and the luminance increase value data stored by the increase calculating section 132 in the increase value calculating step S533, by using the CPU 911.

In the decrease vote number adding step S547, the decrease vote calculating section 136 increases, by 1, the decrease vote number indicated by the stored decrease vote number data of the evaluation decrease pixel selected by the decrease selecting section 135 in the evaluation decrease pixel selecting step S546, by using the CPU 911. The decrease vote calculating section 136 stores the decrease vote number data indicating the increased decrease vote number, by using the magnetic disk drive 920.

In a vote repetition determining step S548, the increase selecting section 133 determines whether the processes have been performed for every center pixel or not, by using the CPU 911.

If it is determined that there is a center pixel remaining unprocessed, then the increase selecting section 133 returns to the vote number repeating step S543 to select the next center pixel, by using the CPU 911.

If it is determined that every center pixel has been processed, then the process proceeds to a vote percentage repeating step S551.

In the vote percentage repeating step S551, the vote number aggregating section 137 selects one pixel at a time from among all the pixels included in the two-dimensional image, by using the CPU 911. The vote number aggregating section 137 performs a vote aggregating step S552 through a vote percentage calculating step S553 for the selected pixel. The vote number aggregating section 137 repeats these processes for every pixel.

In the vote aggregating step S552, the vote number aggregating section 137 calculates the aggregation vote number of the pixel selected in the vote percentage repeating step S551, based on the increase vote number data stored by the increase vote calculating section 134 and the decrease vote number data stored by the decrease vote calculating section 136, by using the CPU 911. The vote number aggregating section 137 stores the aggregation vote number data indicating the obtained aggregation vote number, by using the magnetic disk drive 920.

In the vote percentage calculating step S553, the vote percentage calculating section 143 calculates the vote percentage of the pixel selected by the vote number aggregating section 137 in the vote percentage repeating step S551, based on the maximum vote number data stored by the maximum vote number storing section 142 in the maximum vote calculating step S517 and the aggregation vote number data stored by the vote number aggregating section 137 in the vote aggregating step S552, by using the CPU 911. The vote percentage calculating section 143 stores the vote percentage data indicating the obtained vote percentage, by using the magnetic disk drive 920.

In a vote percentage repetition determining step S554, the vote number aggregating section 137 determines whether the processes have been performed for every pixel included in the two-dimensional image or not, by using the CPU 911.

If it is determined that there is a pixel remaining unprocessed, then the vote number aggregating section 137 returns to the vote percentage repeating step S551 to select the next pixel, by using the CPU 911.

If it is determined that every pixel has been processed, then the vote percentage calculating process S520 is terminated.

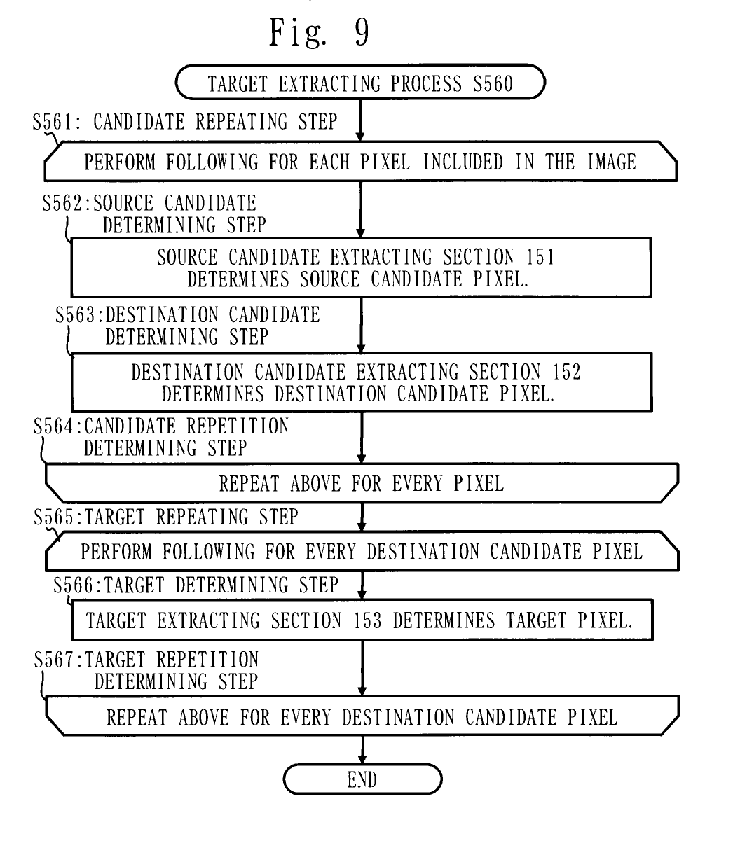

FIG. 9 shows a flow chart illustrating an example flow of a target extracting process S560 for extracting a target pixel by the moving target detecting apparatus 100 according to this embodiment.

In a candidate repeating step S561, the source candidate extracting section 151 selects one pixel at a time from among all the pixels included in the two-dimensional image, by using the CPU 911. The source candidate extracting section 151 performs a source candidate determining step S562 through a destination candidate determining step S563 for the selected pixel. The source candidate extracting section 151 repeats these processes for every pixel.

In the source candidate determining step S562, the source candidate extracting section 151 determines whether the pixel selected in the candidate repeating step S561 is the source candidate pixel or not, based on the source threshold data stored by the source threshold storing section 123 in the parameter inputting step S511 and the vote percentage data stored by the vote percentage calculating section 143 in the vote percentage calculating step S553, by using the CPU 911.

If it is determined that the selected pixel is the source candidate pixel, then the source candidate extracting section 151 stores the source candidate data indicating the selected pixel, by using the magnetic disk drive 920.

In the destination candidate determining step S563, the destination candidate extracting section 152 determines whether the pixel selected by the source candidate extracting section 151 in the candidate repeating step S561 is the destination candidate pixel or not, based on the destination threshold data stored by the destination threshold storing section 124 in the parameter inputting step S511 and the vote percentage data stored by the vote percentage calculating section 143 in the vote percentage calculating step S553, by using the CPU 911.

If it is determined that the selected pixel is the destination candidate pixel, then the destination candidate extracting section 152 stores the destination candidate data indicating the selected pixel, by using the magnetic disk drive 920.

In a candidate repetition determining step S564, the source candidate extracting section 151 determines whether the processes have been performed for every pixel or not, by using the CPU 911.

If it is determined that there is a pixel remaining unprocessed, then the source candidate extracting section 151 returns to the candidate repeating step S561 to select the next pixel, by using the CPU 911.

If it is determined that every pixel has been processed, then the process proceeds to a target repeating step S565.

In the target repeating step S565, the target extracting section 153 selects one pixel at a time from among all the pixels determined to be the destination candidate pixels by the destination candidate extracting section 152, based on the destination candidate data stored by the destination candidate extracting section 152 in the destination candidate determining step S563, by using the CPU 911. The target extracting section 153 performs a target determining step S566 for the selected destination candidate pixel. The target extracting section 153 repeats this process for every destination candidate pixel.

In the target determining step S566, the target extracting section 153 determines whether the destination candidate pixel selected in the target repeating step S565 is the target pixel or not, based on the determination distance data stored by the determination distance storing section 125 in the parameter inputting step S511 and the source candidate data stored by the source candidate extracting section 151 in the source candidate determining step S562, by using the CPU 911.

If it is determined that the selected destination candidate pixel is the target pixel, then the target extracting section 153 stores data indicating the selected destination candidate pixel as the target pixel data, by using the magnetic disk drive 920.

In a target repetition determining step S567, the target extracting section 153 determines whether the process has been performed for every destination candidate pixel or not, by using the CPU 911.

If it is determined that there is a destination candidate pixel remaining unprocessed, then the target extracting section 153 returns to the target repeating step S565 to select the next destination candidate pixel, by using the CPU 911.

If it is determined that every destination candidate pixel has been processed, then the target extracting process S560 is terminated.

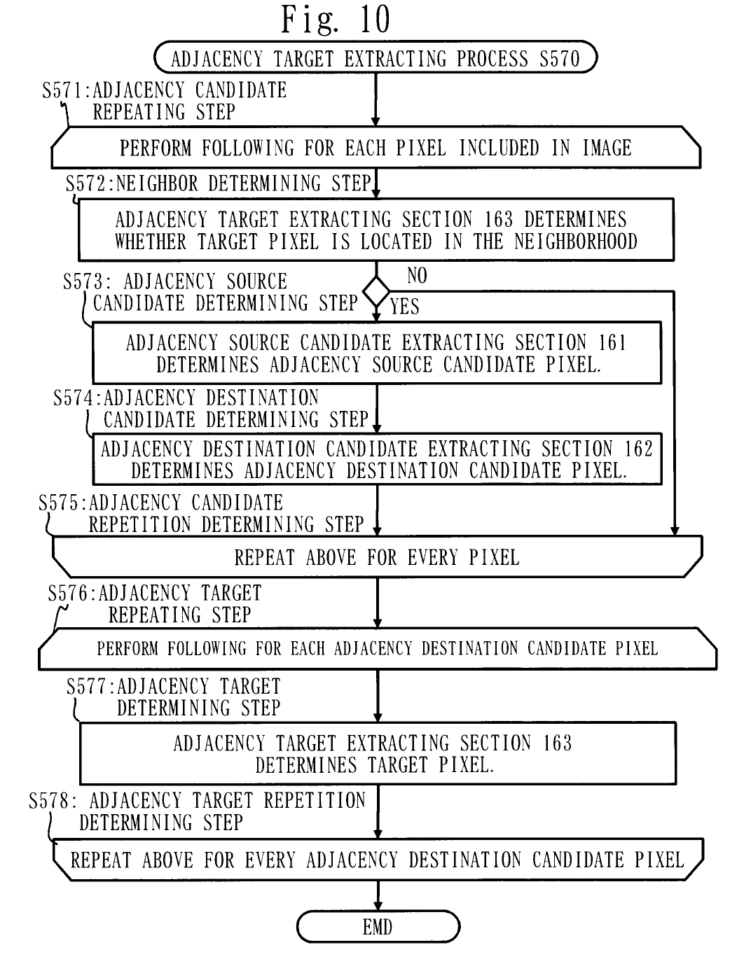

FIG. 10 shows a flow chart illustrating an example flow of an adjacency target extracting process S570 for extracting a target pixel adjacent to another target pixel by the moving target detecting apparatus 100 according to this embodiment.

In an adjacency candidate repeating step S571, the adjacency target extracting section 163 selects one pixel at a time from among all the pixels included in the two-dimensional image, by using the CPU 911. The adjacency target extracting section 163 performs a neighbor determining step S572 through an adjacency destination candidate determining step S574 for the selected pixel. The adjacency target extracting section 163 repeats these processes for every pixel.

In the neighbor determining step S572, the adjacency target extracting section 163 determines whether there is a target pixel in the neighborhood of the pixel selected in the adjacency candidate repeating step S571 or not, based on the target pixel data stored by the target extracting section 153 in the target determining step S566, by using the CPU 911.

If it is determined that there is a target pixel in the neighborhood of the selected pixel, then the process proceeds to an adjacency source candidate determining step S573.

If it is determined that no target pixel is in the neighborhood of the selected pixel, then the process proceeds to an adjacency candidate repetition determining step S575.

In the adjacency source candidate determining step S573, the adjacency source candidate extracting section 161 determines whether the pixel selected by the adjacency target extracting section 163 in the adjacency candidate repeating step S571 is the adjacency source candidate pixel or not, based on the adjacency source threshold data stored by the adjacency source threshold storing section 125 in the parameter inputting step S511 and the vote percentage stored by the vote percentage calculating section 143 in the vote percentage calculating step S553, by using the CPU 911.

If it is determined that the selected pixel is the adjacency source candidate pixel, then the adjacency source candidate extracting section 161 stores the adjacency source candidate data indicating the selected pixel, by using the magnetic disk derive 920.

In the adjacency destination candidate determining step S574, the adjacency destination candidate extracting section 162 determines whether the pixel selected by the adjacency target extracting section 163 in the adjacency candidate repeating step S571 is the adjacency destination candidate pixel or not, based on the adjacency destination threshold data stored by the adjacency destination threshold storing section 127 in the parameter inputting step S511 and the vote percentage data stored by the vote percentage calculating section 143 in the vote percentage calculating step S553, by using the CPU 911.

If it is determined that the selected pixel is the adjacency destination candidate pixel, then the adjacency destination candidate extracting section 162 stores the adjacency destination candidate data indicating the selected pixel, by using the magnetic disk derive 920.

In the adjacency candidate repetition determining step S575, the adjacency target extracting section 163 determines whether the processes have been performed for every pixel included in the two-dimensional image or not, by using the CPU 911.

If it is determined that there is a pixel remaining unprocessed, then the adjacency target extracting section 163 returns to the adjacency candidate repeating step S571 to select the next pixel, by using the CPU 911.

If it is determined that every pixel has been processed, then the process proceeds to an adjacency target repeating step S576.

In the adjacency target repeating step S576, the adjacency target extracting section 163 selects one pixel at a time from among all the pixels determined to be the adjacency destination candidate pixels by the adjacency destination candidate extracting section 162, based on the adjacency destination candidate data stored by the adjacency destination candidate extracting section 162 in the adjacency destination candidate determining step S574, by using the CPU 911. The adjacency target extracting section 163 performs an adjacency target determining step S577 for the selected adjacency destination candidate pixel. The adjacency target extracting section 163 repeats this process for every adjacency destination candidate pixel.

In the adjacency target determining step S577, the adjacency target extracting section 163 determines whether the adjacency destination candidate pixel selected in the adjacency target repeating step S576 is the target pixel or not, based on the adjacency determination distance data stored by the adjacency determination distance storing section 128 in the parameter inputting step S511 and the adjacency source candidate data stored by the adjacency source candidate extracting section 161 in the adjacency source candidate determining step S573, by using the CPU 911.

If it is determined that the selected adjacency destination candidate pixel is the target pixel, then the adjacency target extracting section 163 stores target pixel data indicating the selected adjacency destination candidate pixel, by using the magnetic disk drive 920.

In an adjacency target repetition determining step S578, the adjacency target extracting section 163 determines whether the process has been performed for every adjacency destination candidate pixel or not, by using the CPU 911.

If it is determined that there is an adjacency destination candidate pixel remaining unprocessed, then the adjacency target extracting section 163 returns to the adjacency target repeating step S576 to select the next adjacency destination candidate pixel, by using the CPU 911.

If it is determined that every adjacency destination candidate pixel has been processed, then the adjacency target extracting process S570 is terminated.

An operation of the moving target detecting apparatus 100 is now described with reference to a specific example.

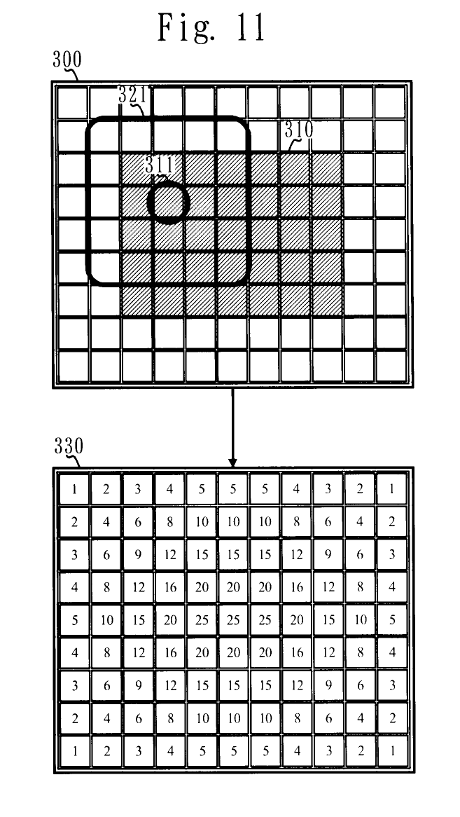

FIG. 11 shows an example of the center pixels selected by the center selecting section 131 and the maximum vote numbers obtained by the maximum vote number calculating section 141 according to this embodiment.

With this specific example, a two-dimensional image 300 consists of 99 pixels with vertical 9 pixels by horizontal 11 pixels.

The parameter inputting section 121 inputs the neighbor distance as a parameter, by using the keyboard 902. With this specific example, it is assumed that the parameter inputting section 121 inputs “5” as the neighbor distance.

The center selecting section 131 selects center pixels 310 whose center neighbor range falls within the image, from among the pixels of the two-dimensional image 300, based on the neighbor distance inputted by the parameter inputting section 121, by using the CPU 911. With this example, it is assumed that the center neighbor range is a rectangular area with the center pixel in the center and the neighbor distance on a side. For example, the center neighbor pixels 321 of the center pixel 311 highlighted by a bold circle in the center are the 25 pixels within the center neighbor range enclosed by a bold line.

In this case, the center selecting section 131 selects 35 pixels of 7×5 pixels marked by diagonal hatching, as the center pixels 310.

The maximum vote number calculating section 141 calculates a maximum vote number 330 for each of the 99 pixels of the two-dimensional image 300, based on the center pixels selected by the center selecting section 131, by using the CPU 911. More specifically, the maximum vote number calculating section 141 calculates 99 maximum vote numbers 330 respectively corresponding to the 99 pixels.

As shown in FIG. 11, a pixel located in the vicinity of the center of the image has a large maximum vote number (25, equal to the number of the center neighbor pixels, at maximum). The maximum vote number of a pixel becomes smaller as it comes closer to an edge of the image. It should be noted that there is no pixel having 0 for the maximum vote number. The minimum value of the maximum vote number is 1. That is to say, every pixel has the possibility to have an increase vote or a decrease vote.

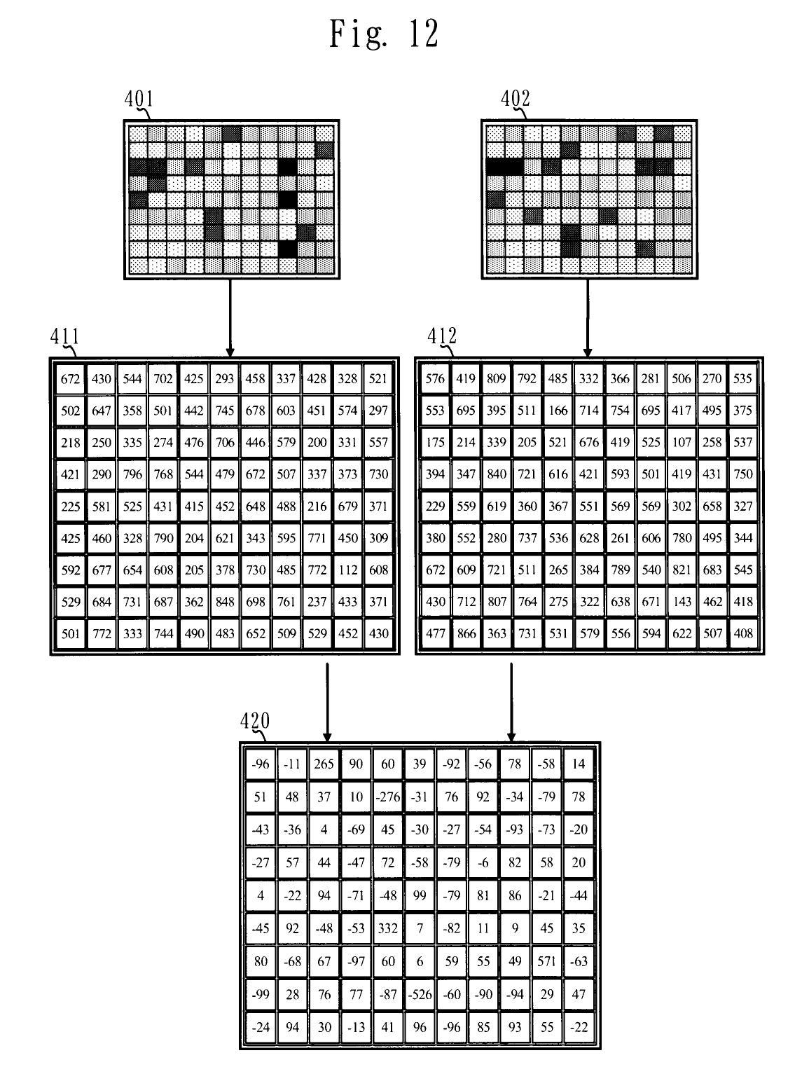

FIG. 12 shows examples of image data 411 and image data 412 which are inputted by the image inputting section 111 and luminance increase values 420 which is obtained by the increase calculating section 132, according to this embodiment.

The image inputting section 111 inputs the image data 411 indicating an image 401, by using the communication device 915. The image data 411 consists of 99 items of the luminance value data corresponding to the 99 pixels of the two-dimensional image 300. The image storing section 112 stores the image data 411 inputted by the image inputting section 111, by using the magnetic disk drive 920.

The image inputting section 111 inputs the image data 412 indicating an image 402, after a predetermine period of time, by using the communication device 915. Similarly, the image data 412 consists of 99 items of the luminance value data corresponding to the 99 pixels of the two-dimensional image 300. The image storing section 112 stores the image data 412 inputted by the image inputting section 111, by using the magnetic disk drive 920.

The increase calculating section 132 calculates a luminance increase value 420 for each of the 99 pixels of the two-dimensional image 300, based on the image data 411 and the image data 412 stored by the image storing section 112, by using the CPU 911. More specifically, the increase calculating section 132 calculates 99 luminance increase values 420 respectively corresponding to the 99 pixels. The luminance increase value 420 has a positive value if the luminance value of the pixel in the image 402 is higher than the luminance value of the pixel in the image 401. The luminance increase value 420 has a negative value if the luminance value of the pixel in the image 402 is lower than the luminance value of the pixel in the image 401.

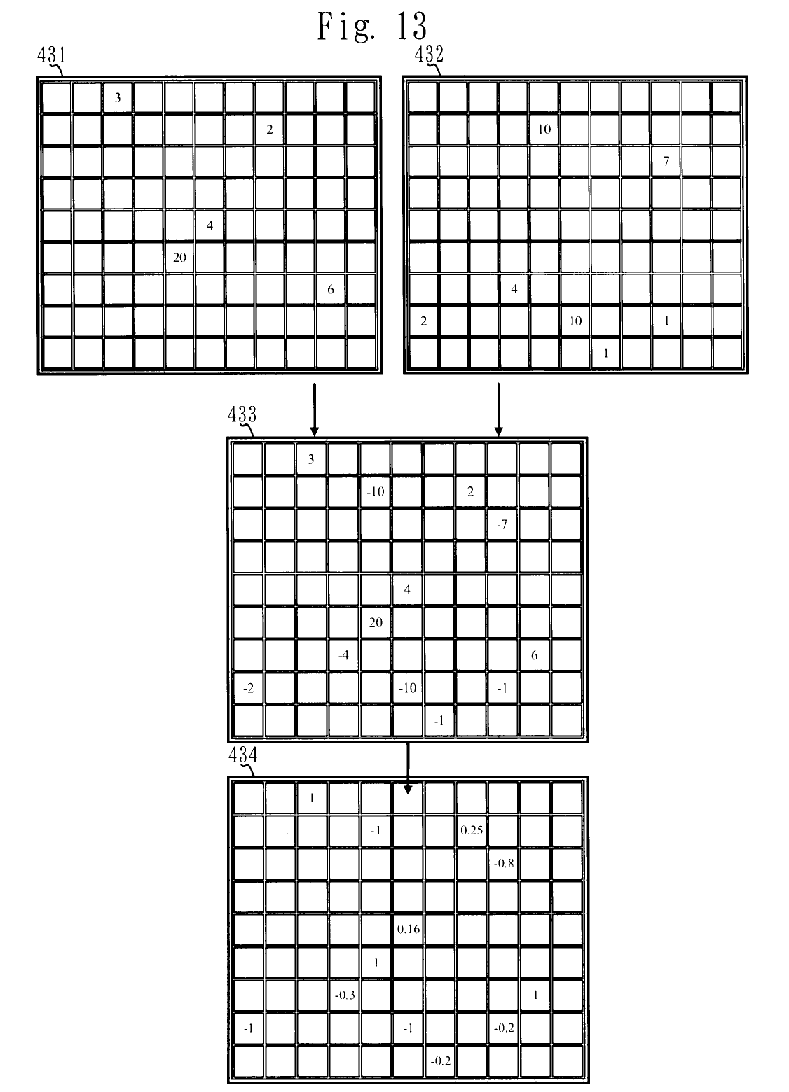

FIG. 13 shows examples of increase vote numbers 431, decrease vote numbers 432, aggregation vote numbers 433, and vote percentages 434 obtained respectively by the increase vote calculating section 134, the decrease vote calculating section 136, the vote number aggregating section 137, and the vote percentage calculating section 143, according to this embodiment.

The increase selecting section 133 selects an evaluation increase pixel for each of the 35 center pixels selected by the center selecting section 131, based on the 99 luminance increase values 420 obtained by the increase calculating section 132, by using the CPU 911. That is to say, the increase selecting section 133 selects 35 evaluation increase pixels respectively corresponding to the 35 center pixels. It should be noted that the same pixel may be selected as the evaluation increase pixel for different center pixels. Therefore, the number of pixels to be selected as the evaluation increase pixel at least once is 35 or less than 35. With this specific example, there are five pixels that are selected as the evaluation increase pixels at least once.

The increase vote calculating section 134 calculates an increase vote number 431 for the 99 pixels of the two-dimensional image 300, based on the 35 evaluation increase pixels selected by the increase selecting section 133, by using the CPU 911. That is to say, the increase vote calculating section 134 calculates 99 increase vote numbers 431 respectively corresponding to the 99 pixels. It should be noted that the increase vote numbers 431 having 0 are not shown in FIG. 13 for visual convenience sake. The decrease vote numbers 432, the aggregation vote numbers 433 and the vote percentages 434 are treated in the same manner.

The decrease selecting section 135 selects an evaluation decrease pixel for each of the 35 center pixels selected by the center selecting section 131, based on 99 of the luminance increase values 420 obtained by the increase calculating section 132, by using the CPU 911. That is to say, the decrease selecting section 135 selects 35 evaluation decrease pixels respectively corresponding to the 35 center pixels. It should be noted that the same pixel may be selected as the evaluation decrease pixel for different center pixels, like the evaluation increase pixel.

The decrease vote calculating section 136 calculates a decrease vote number 432 for each of the 99 pixels of the two-dimensional image 300 based on the 35 evaluation decrease pixels selected by the decrease selecting section 135, by using the CPU 911. That is to say, the decrease vote calculating section 136 calculates 99 decrease vote numbers 432 respectively corresponding to the 99 pixels.

The vote number aggregating section 137 calculates an aggregation vote numbers 433 for each of the 99 pixels of the two-dimensional image 300, based on the 99 increase vote numbers 431 obtained by the increase vote calculating section 134 and the 99 decrease vote numbers 432 obtained by the decrease vote calculating section 136, by using the CPU 911. That is to say, the vote number aggregating section 137 calculates 99 aggregation vote numbers 433 respectively corresponding to the 99 pixels.

The vote percentage calculating section 143 calculates an vote percentage 434 for each of the 99 pixels of the two-dimensional image 300, based on the 99 maximum vote numbers 330 stored by the maximum vote number storing section 142 and the 99 aggregation vote numbers 433 obtained by the vote number aggregating section 137, by using the CPU 911. That is to say, the vote percentage calculating section 143 calculates 99 vote percentages 433 respectively corresponding to the 99 pixels.

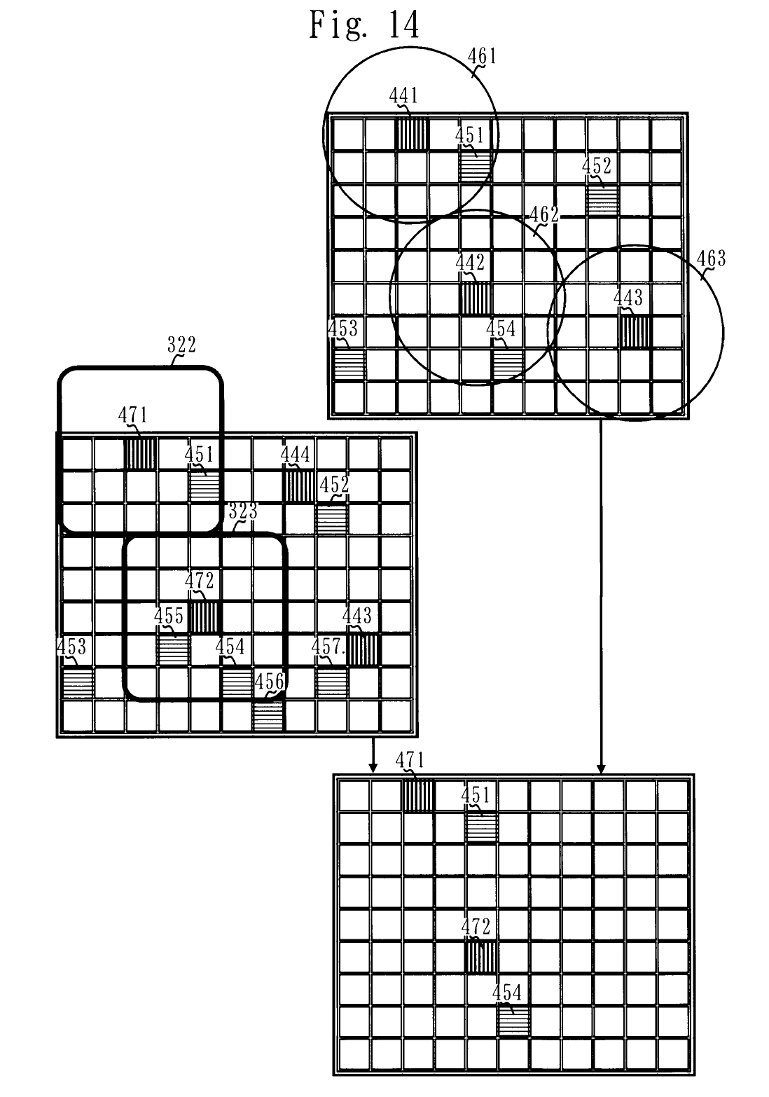

FIG. 14 shows examples of target pixels extracted by the target extracting section 153 and the adjacency target extracting section 163, according to this embodiment.

The source candidate extracting section 151 extracts a pixel whose vote percentage 434 is smaller than the source threshold, from the 99 pixels of the two-dimensional image 300, as the source candidate pixel, based on the source threshold stored by the source threshold storing section 123 and the 99 vote percentages 434 obtained by the vote percentage calculating section 143, by using the CPU 911. With this specific example, assuming that the source threshold storing section 123 stores “−0.5” for the source threshold, the source candidate extracting section 151 extracts four source candidate pixels 451 to 454.

The destination candidate extracting section 152 extracts a pixel whose vote percentage 434 is larger than the destination threshold, from the 99 pixels of the two-dimensional image 300, as the destination candidate pixel, based on the destination threshold stored by the destination threshold storing section 124 and the 99 vote percentages 434 obtained by the vote percentage calculating section 143, by using the CPU 911. With this specific example, assuming that the destination threshold storing section 124 stores “0.5” for the destination threshold, the destination candidate extracting section 152 extracts three destination candidate pixels 441 to 443.

The target extracting section 153 extract a target pixel, based on the determination distance stored by the determination distance storing section 125, the source candidate pixel extracted by the source candidate extracting section 151, and the destination candidate pixel extracted by the destination candidate extracting section 152, by using the CPU 911. With this specific example, the target extracting section 153 extracts the destination candidate pixel 441 as a target pixel 471 since the source candidate pixel 451 is located within a neighbor candidate range 461 of the destination candidate pixel 441. Also, the target extracting section 153 extracts the destination candidate pixel 442 as a target pixel 472 since the destination candidate pixel 454 is located within a neighbor candidate range 462 of the destination candidate pixel 442. In contrast, the target extracting section 153 does not extract the destination candidate pixel 443 as a target pixel because there is no destination candidate pixel located within a neighbor candidate range 463 of the destination candidate pixel 443.

The adjacency destination candidate extracting section 162 extracts a pixel whose vote percentage 434 is larger than the adjacency destination threshold as the adjacency destination candidate pixel from the 99 pixels of the two-dimensional image 300, based on the adjacency destination threshold stored by the adjacency destination threshold storing section 127 and the 99 vote percentages 434 obtained by the vote percentage calculating section 143, by using the CPU 911. The number of the adjacency destination candidate pixels extracted by the adjacency destination candidate extracting section 162 is the same or more than the number of the destination candidate pixels extracted by the destination candidate extracting section 152 because the adjacency destination threshold is smaller than the destination threshold. With this specific example, assuming that the adjacency destination threshold storing section 127 stores “0.2” for the adjacency destination threshold, the adjacency destination candidate extracting section 162 extracts an adjacency destination candidate pixel 444 in addition to three of the destination candidate pixels 441 to 443. The adjacency destination candidate extracting section 162 thus extracts four adjacency destination candidate pixels 441 to 444 in total.

It should be noted that the adjacency destination candidate extracting section 162 may not extract the adjacency destination candidate pixel not from all of the 99 pixels of the two-dimensional image 300. Alternatively, the adjacency destination candidate extracting section 162 may limit an extraction area to pixels within the neighborhood of the target pixel extracted by the target extracting section 153, and extract the adjacency destination candidate pixel from the limited extraction area. Still alternatively, the adjacency destination candidate extracting section 162 may extract the adjacency destination candidate pixel from all the pixels, except for those extracted by the target extracting section 153 as target pixels.

The adjacency source candidate extracting section 161 extracts a pixel whose vote percentage 434 is smaller than the adjacency source threshold as the adjacency source candidate pixel from the 99 pixels of the two-dimensional image 300, based on the adjacency source threshold stored by the adjacency source threshold storing section 125 and the 99 vote percentages 434 obtained by the vote percentage calculating section 143, by using the CPU 911. The number of the adjacency source candidate pixels extracted by the adjacency source candidate extracting section 161 is the same or more than the number of the source candidate pixels extracted by the source candidate extracting section 151 because the adjacency source threshold is larger than the source threshold. With this specific example, assuming that the adjacency source threshold storing section 125 stores “−0.2” for the adjacency source threshold, the adjacency source candidate extracting section 161 extracts three adjacency source candidate pixels 455 to 457 in addition to the four adjacency source candidate pixels 451 to 454. The adjacency source candidate extracting section 161 thus extracts seven adjacency source candidate pixels 451 to 457, in total.

It should be noted that the adjacency source candidate extracting section 161 may not extract the adjacency source candidate pixel from all of the 99 pixels of the two-dimensional image 300. Alternatively, the adjacency source candidate extracting section 161 may limit an extraction area to pixels within the neighborhood of the source candidate pixel paired with the target pixel extracted by the target extracting section 153, and extract the adjacency source candidate pixel from the limited extraction area. Still alternatively, the adjacency source candidate extracting section 161 may extract the adjacency source candidate pixel from pixels within the neighborhood of the source candidate pixel paired with the target pixel extracted by the target extracting section 153 with reference to the adjacency source threshold, but from the other pixels with reference to the source threshold stored by the source threshold storing section 123.

The adjacency target extracting section 163 extracts an adjacency destination candidate pixel which is paired with one of the adjacency source candidate pixel as the target pixel from the adjacency destination candidate pixels located in the neighborhood of the target pixel, based on the target pixel extracted by the target extracting section 153, the adjacency destination candidate pixel extracted by adjacency destination candidate extracting section 162, and the adjacency source candidate pixel extracted by the adjacency source candidate extracting section 161, by using the CPU 911. With this specific example, the adjacency target extracting section 163 extracts the adjacency destination candidate pixels 441 and 442 as neighbor destination candidate pixels included in the center neighbor pixel 322 of the target pixel 471 or the center neighbor pixel of the target pixel 472. The adjacency target extracting section 163 extracts the destination candidate pixel 441 as the target pixel 471 since the source candidate pixel 451 is located within the neighbor candidate range 461 of the destination candidate pixel 441. The adjacency target extracting section 163 extracts the destination candidate pixel 442 as the target pixel 472 since the source candidate pixel 454 and the adjacency source candidate pixel 455 are located within the neighbor candidate range 462 of the destination candidate pixel 442.

It should be noted that it is also possible that the adjacency target extracting section 163 extracts no pixel as the target pixel if the target extracting section 153 extracted the same pixel as the target pixel. In this case, the adjacency target extracting section 163 does not extract the adjacency destination candidate pixel.

A total of the target pixel thus extracted by the target extracting section 153 and the target pixel thus extracted by the adjacency target extracting section 163 is a target pixel extracted by the moving target detecting apparatus 100 this time. With this specific example, the target pixels 471 and 472 are extracted.

The target storing section 172 stores the target pixel data indicating the extracted two target pixels 471 and 472, by using the magnetic disk drive 920.

The target outputting section 173 outputs the target pixel data indicating the two target pixels 471 and 472 stored by the target storing section 172, by using the communication device 915.

Thus, according to the moving target detecting apparatus of this embodiment, the target extracting section 153 may extract a destination candidate pixel as the target pixel from the destination candidate pixels extracted by the destination candidate extracting section 152 when the destination candidate pixel is paired with a source candidate pixel. This may allow for an efficient detection of a target appearing in different pixels when it moves, without detecting a defective pixel such as a blinking defective pixel, because the defective pixel is not paired with any pixel.

The moving target detecting apparatus 100 according to this embodiment may comprise the memory (the magnetic disk drive 920) for storing data, the processor (the CPU 911) for processing the data, the image storing section 112, the destination candidate extracting section 152, the source candidate extracting section 151 and the target extracting section 153.

The image storing section 112 may store the first image data indicating the first image and the second image data indicating the second image, by using the memory (the magnetic disk drive 920).

The destination candidate extracting section 152 may extract a pixel increasing in the luminance value as the destination candidate pixel, from the plurality of pixels included in the first image and the second image, based on the first image and the second image indicated by the first image data and the second image data stored by the image storing section 112, by using the processor (the CPU 911).

The source candidate extracting section 151 may extract a pixel decreasing in the luminance value as the source candidate pixel, from the plurality of pixels included in the first image and the second image, based on the first image and the second image indicated by the first image data and the second image data stored by the image storing section 112, by using the processor (the CPU 911).

The target extracting section 153 may extract the destination candidate pixel as the target pixel when the destination candidate pixel is paired with the source candidate pixel, based on the destination candidate pixel extracted by the destination candidate extracting section 152 and the source candidate pixel extracted by the source candidate extracting section 151, by using the processor (the CPU 911).

According to the moving target detecting apparatus 100 of this embodiment, the target extracting section 153 may thus extract the destination candidate pixel as the target pixel from the plurality of the destination candidate pixels extracted by the destination candidate extracting section 152, if the destination candidate pixel is paired with the source candidate pixel. Hence, this may result in an effective detection of the target appearing in different pixels when it moves. It should be noted that no defective pixel, such as a blinking defective pixel, may be detected since it is paired with no other pixel.

The target extracting section 153 according to this embodiment may extract the destination candidate pixel extracted by the destination candidate extracting section 152 as the target pixel when the source candidate pixel extracted by the source candidate extracting section 151 is among the plurality of neighbor candidate pixels located in the neighborhood of the destination candidate pixel, by using the processor (the CPU 911).

According to the moving target detecting apparatus 100 of this embodiment, the target extracting section 153 may thus detect the target pixel by treating the source candidate pixel, which is located among the neighbor candidate pixels in the neighborhood of the destination candidate pixel, as the source candidate pixel paired with the destination candidate pixel. Hence, this may result in an effective detection of a target, if appearing in different pixels of the two images within the neighbor candidate pixel range.

The target extracting section 153 according to this embodiment may extract the target pixel by treating the plurality of pixels located within the rectangular range having the destination candidate pixel in the center as the plurality of neighbor candidate pixels, by using the processor (the CPU 911).

According to the moving target detecting apparatus 100 of this embodiment, the target extracting section 153 may thus determine whether the pixel is paired with the source candidate pixel, by treating the pixels within the rectangular range having the destination candidate pixel in the center, as the plurality of neighbor candidate pixels. Thus, the source candidate pixel to be paired with the target pixel may be determined based on the coordinates of the source candidate pixel. Hence, high speed processing may be achieved.

The target extracting section 153 may extract the target pixel by treating the plurality of pixels located within the distance of the predetermined number of pixels from the destination candidate pixel as the plurality of neighbor candidate pixels, by using the processor (the CPU 911).

According to the moving target detecting apparatus 100 of this embodiment, the target extracting section 153 may thus determine whether the pixel is paired with the source candidate pixel, by treating the pixels within the distance of the predetermined number of pixels from the destination candidate pixel as the plurality of neighbor candidate pixels. Therefore, a possible moving distance of the target may be estimated on the two-dimensional image in advance based on the maximum moving speed of the target, and then the distance may be set as the determination distance. This may result in an effective determination of the target pixel.

The moving target detecting apparatus 100 according to this embodiment may further comprise the increase calculating section 132, the center selecting section 131, the neighbor selecting section 138, the increase selecting section 133, and the decrease selecting section 135.

The increase calculating section 132 may calculate the difference as the luminance increase value, for each pixel of the plurality of pixels included in both the first image and the second image, the difference being obtained by subtracting the luminance value of the pixel of the first image from the luminance value of the pixel of the second image, based on the first image and the second image indicated by the first image data and the second image data stored by the image storing section 112, by using the processor (the CPU 911), to obtain the plurality of luminance increase values.

The center selecting section 131 may select at least two pixels as the plurality of center pixels, from the plurality of pixels, by using the processor (the CPU 911).

The neighbor selecting section 138 may select the plurality of pixels as the plurality of center neighbor pixels, for each center pixel of the plurality of center pixels selected by the center selecting section 131, the plurality of pixels being located in the neighborhood of the center pixel, by using the processor (the CPU 911), to obtain the plurality of center neighbor pixels.

The increase selecting section 133 may select the center neighbor pixel as the evaluation increase pixel, for each center pixel of the plurality of center pixels selected by the center selecting section 131, the center neighbor pixel having the largest luminance increase value of the plurality of luminance increase values calculated by the increase calculating section 132 in the plurality of center neighbor pixels selected by the neighbor selecting section 138, by using the processor (the CPU 911), to obtain the plurality of evaluation increase pixels.

The decrease selecting section 135 may select the center neighbor pixel as the evaluation decrease pixel, for each center pixel of the plurality of center pixels selected by the neighbor selecting section 138, the center neighbor pixel having the smallest luminance increase value of the plurality of luminance increase values calculated by the increase calculating section 132 in the plurality of center neighbor pixels selected by the center selecting section 131, by using the processor (the CPU 911), to obtain the plurality of evaluation decrease pixels.

The destination candidate extracting section 152 may extract the destination candidate pixel from the plurality of pixels based on the number of times the increase selecting section 133 selects each pixel of the plurality of pixels as the evaluation increase pixel, by using the processor (the CPU 911).

The source candidate extracting section 151 may extract the source candidate pixel from the plurality of pixels based on the number of times the decrease selecting section 135 selects each pixel of the plurality of pixels as the evaluation decrease pixel, by using the processor (the CPU 911).

According to the moving target detecting apparatus 100 of this embodiment, the increase selecting section 133 may thus select a pixel having the largest luminance increase value of the center neighbor pixels for each center pixel as the evaluation increase pixel; the destination candidate extracting section 152 may extract the destination candidate pixel based on the number of times each pixel is selected as the evaluation increase pixel; the decrease selecting section 135 may select a pixel having the smallest luminance increase value of the center neighbor pixels for each center pixel as the evaluation decrease pixel; and the source candidate extracting section 151 may extract the source candidate pixel based on the number of times each pixel is selected as the evaluation decrease pixel. This may result in an effective detection of a pixel showing the target if the background of the image contains non-uniform luminance including a complicated pattern.

The moving target detecting apparatus 100 according to this embodiment may further comprise the increase vote calculating section 134 and the decrease vote calculating section 136.

The increase vote calculating section 134 may calculate the number of times the increase selecting section 133 selects each pixel of the plurality of pixels as the evaluation increase pixel, as an increase vote number, for each pixel of the plurality of pixels, by using processor (the CPU 911), to obtain the plurality of increase vote numbers.

The decrease vote calculating section 136 may calculate the number of times the decrease selecting section 135 selects each pixel of the plurality of pixels as the evaluation decrease pixel, as the decrease vote number, for each pixel of the plurality of pixels, by using the processor (the CPU 911), to obtain the plurality of decrease vote numbers.

The destination candidate extracting section 152 may extract the destination candidate pixel from the plurality of pixels based on the plurality of increase vote numbers calculated by the increase vote calculating section 134, by using the processor (the CPU 911).

The source candidate extracting section 151 may extract the source candidate pixel from the plurality of pixels based on the plurality of decrease vote numbers calculated by the decrease vote calculating section 136, by using the processor (the CPU 911).

According to the moving target detecting apparatus 100 of this embodiment, the increase vote calculating section 134 may thus calculate the increase vote number based on the number of times each pixel is selected as the evaluation increase pixel; and the decrease vote calculating section 136 may calculate the decrease vote number based on the number of times each pixel is selected as the evaluation decrease pixel. This may allow the destination candidate pixel and the source candidate pixel to be extracted based on the increase vote number and the decrease vote number. This may result in an effective detection of a pixel showing the target when the background of the image contains non-uniform luminance including a complicated pattern.

The moving target detecting apparatus 100 according to this embodiment may further comprise the vote number aggregating section 137.

The vote number aggregating section 137 may calculate the difference as the aggregation vote number, for each pixel, the difference being obtained by subtracting the number of times (the decrease vote number) the decrease selecting section 135 selects the pixel as the evaluation decrease pixel from the number of times (the increase vote number) the increase selecting section 133 selects the pixel as the evaluation increase pixel, by using the processor (the CPU 911), to obtain the plurality of aggregation vote numbers.

The destination candidate extracting section 152 may extract the destination candidate pixel from the plurality of pixels based on the plurality of aggregation vote numbers calculated by the vote number aggregating section 137, by using the processor (the CPU 911).

The source candidate extracting section 151 may extract the source candidate pixel from the plurality of pixels based on the plurality of aggregation vote numbers calculated by the vote number aggregating section 137, by using the processor (the CPU 911).

According to the moving target detecting apparatus 100 of this embodiment, the vote number aggregating section 137 may thus calculate the aggregation vote number based on the increase vote number and the decrease vote number, and the source candidate extracting section 151 and the destination candidate extracting section 152 may extract the source candidate pixel and the destination candidate pixel. This may unload a memory area storing the increase vote numbers and the decrease vote numbers at an early stage. There are few cases in which the same pixel is selected as the evaluation increase pixel for a specific center pixel and also as the evaluation decrease pixel for a different center pixel. Hence, there is little fear of losing information in the aggregation vote number obtained by aggregating the increase vote number and the decrease vote number.

Alternatively, it is also possible that the vote number aggregating section 137 calculates the aggregation vote numbers directly based on selection results from the increase selecting section 133 and the increase vote calculating section 134, rather than calculating the increase vote number and the decrease vote number separately and then calculating the aggregation vote number. In this case, however, the operating procedures may be changed as follows:

With reference to the flow chart of FIG. 8:

The increase vote number initializing step S541 and the decrease vote number initializing step S542 may be replaced by the aggregation vote number initializing process. In the aggregation vote number initializing process, the vote number aggregating section 137 may initialize the aggregation vote number to 0 for each pixel included in the two-dimensional image, by using the CPU 911, and store aggregation vote number data indicating the initialized aggregation vote number, by using the magnetic disk drive 920.

In the increase vote number adding step S545, the increase vote calculating section 134 may increase the aggregation vote number by 1 for the selected evaluation increase pixel selected by the increase selecting section 133 in the evaluation increase pixel selecting step S544, by using the CPU 911.

In the decrease vote number adding step S547, the decrease vote calculating section 136 may decrease the aggregation vote number by 1 for the evaluation decrease pixel selected by the decrease selecting section 135 in the evaluation decrease pixel selecting step S546, by using the CPU 911.

The vote aggregating step S552 is omitted.

This may allow for an effective reduction in the size substantially to a half of a memory area to be used for calculating the aggregation vote numbers.

The moving target detecting apparatus 100 according to this embodiment may further comprise the maximum vote number storing section 142 and the vote percentage calculating section 143.

The maximum vote number storing section 142 may store the number of a center pixel as the maximum vote number, for each pixel of the plurality of pixels, the center pixel having the pixel among the plurality of center neighbor pixels in the neighborhood of the center pixel, by using the memory (the magnetic disk drive 920), to store the plurality of maximum vote numbers.

The vote percentage calculating section 143 may calculate the quotient as the vote percentage, for each pixel of the plurality of pixels, the quotient being obtained by dividing the aggregation vote number calculated by the vote number aggregating section 137 by the maximum vote number stored by the maximum vote number storing section 142, by using the processor (the CPU 911), to obtain the plurality of vote percentages.

The destination candidate extracting section 152 may extract the destination candidate pixel from the plurality of pixels based on the plurality of vote percentages obtained by the vote percentage calculating section 143, by using the processor (the CPU 911).

The source candidate extracting section 151 may extract the source candidate pixel from the plurality of pixels based on the plurality of vote percentages obtained by the vote percentage calculating section 143, by using the processor (the CPU 911).

According to the moving target detecting apparatus 100 of this embodiment, the source candidate extracting section 151 and the destination candidate extracting section 152 may thus extract the source candidate pixel and the destination candidate pixel based on the vote percentage obtained by dividing the aggregation vote number by the maximum vote number. This may result in an accurate comparison between the votes of pixels having different maximum vote numbers due to their locations within an image. Hence, the reliability of extraction of the target pixel may be enhanced.

The destination candidate extracting section 152 according to this embodiment may extract a pixel as the destination candidate pixel, from the plurality of pixels, the pixel having the vote percentage calculated by the vote percentage calculating section 143 larger than the predetermined destination threshold, by using the processor (the CPU 911).

The source candidate extracting section 151 according to this embodiment may extract a pixel as the source candidate pixel, from the plurality of pixels, the pixel having the vote percentage calculated by the vote percentage calculating section 143 smaller than the predetermined source threshold, by using the processor (the CPU 911).

According to the moving target detecting apparatus 100 of this embodiment, the destination candidate extracting section 152 may thus extract a pixel having the vote percentage larger than the predetermined destination threshold, as the destination candidate pixel, and the source candidate extracting section 151 may thus extract a pixel having the vote percentage smaller than the predetermined source threshold, as the source candidate pixel. This may reduce the influence of the background on the target pixel in the image. Hence, the reliability of detection of the target pixel may be enhanced.

The moving target detecting apparatus 100 according to this embodiment may further comprise the adjacency destination candidate extracting section 162, the adjacency source candidate extracting section 161, and the adjacency target extracting section 163.

The adjacency destination candidate extracting section 162 may extract a pixel as the adjacency destination candidate pixel, from the plurality of target neighbor pixels located in the neighborhood of the target pixel extracted by the target extracting section 153, the pixel having the vote percentage calculated by the vote percentage calculating section 143 larger than the adjacency destination threshold that is smaller than the predetermined destination threshold, by using the processor (the CPU 911).

The adjacency source candidate extracting section 161 may extract a pixel as the adjacency source candidate pixel, from the plurality of target neighbor pixels, the pixel having the vote percentage calculated by the vote percentage calculating section 143 smaller than the adjacency source threshold that is larger than the predetermined source threshold, by using the processor (the CPU 911).

The adjacency target extracting section 163 may extract the adjacency destination candidate pixel extracted by the adjacency destination candidate extracting section 162 when the adjacency source candidate pixel extracted by the adjacency source candidate extracting section 161 is among the plurality of adjacency neighbor pixels located in the neighborhood of the adjacency destination candidate extracting section 162, by using the processor (the CPU 911).

According to the moving target detecting apparatus 100 of this embodiment, the adjacency destination candidate extracting section 162 may thus extract a pixel having the vote percentage larger than the adjacency destination threshold as the adjacency destination candidate pixel in the neighborhood of the target pixel extracted by the target extracting section 153, and the adjacency source candidate extracting section 161 may thus extract a pixel having the vote percentage calculated by the vote percentage calculating section 143 smaller than the adjacency source threshold as the adjacency source candidate pixel in the neighborhood of the target pixel extracted by the target extracting section 153. This may allow for an effective detection of two or more target pixels adjacent to each other.

The neighbor selecting section 138 according to this embodiment may select the plurality of pixels as the plurality of center neighbor pixels, for each center pixel of the plurality of center pixels selected by the center selecting section 131, the plurality of pixels being located within the rectangular range having the center pixel in the center, by using the processor (the CPU 911).

According to the moving target detecting apparatus 100 of this embodiment, the increase selecting section 133 may thus select the evaluation increase pixel by treating pixels located within the rectangular range having the center pixel in the center as the center neighbor pixels. This may allow the evaluation increase pixel to be selected based on the coordinates of the pixel. Hence, high speed processing may be achieved.

The neighbor selecting section 138 according to this embodiment may select the plurality of pixels as the plurality of center neighbor pixels, for each center pixel of the plurality of center pixels selected by the center selecting section 131, the plurality of pixels being located within the distance of the predetermined number of pixels from the center pixel, by using the processor (the CPU 911).

According to the moving target detecting apparatus 100 of this embodiment, the increase selecting section 133 may thus select the evaluation increase pixel by treating pixels located within the distance of the predetermined number of pixels from the center pixel. This may allow for an accurate selection of the evaluation increase pixels.

The center selecting section 131 according to this embodiment may select each pixel as the center pixel from the plurality of pixels when the plurality of center neighbor pixels in the neighborhood of the pixel fall within the image, by using the processor (the CPU 911), to obtain the plurality of center pixels.

According to the moving target detecting apparatus 100 of this embodiment, a pixel may thus be selected as the center pixel when the center neighbor pixels in the neighborhood of the pixel fall within the image. Therefore, this may equalize the number of the center neighbor pixels for every center pixel, and also equalize the weight in the selection of a pixel as the evaluation increase pixel by the increase selecting section 133. Hence, the reliability of detection of the target pixel may be enhanced.

The moving target detecting apparatus 100 according to this embodiment may further comprise the input device (the communication device 915) for inputting data and the image inputting section 111.

The image inputting section 111 may input image data indicating an image at the rate of one frame per the predetermined period, by using the input device (the communication device 915).

The image storing section 112 may store the image data inputted by the image inputting section 111, and treat one of the image data stored as the first image data and the image data stored that is inputted next to the first image data by the image inputting section 111 as the second image data, by using the memory (the magnetic disk drive 920).

According to the moving target detecting apparatus 100 of this embodiment, the target pixel may thus be detected based on two items of image data consecutive in time-series. Therefore, this may allow for an effective detection of the target pixel showing a moving target.

The moving target detecting apparatus 100 according to this embodiment may be implemented by a computer's execution of a computer program that causes the computer to function as the moving target detecting apparatus 100.

The computer program causing a computer to function as the moving target detecting apparatus 100 of this embodiment may allow for an effective detection of a target appearing in different pixels when it moves, without detecting a defective pixel.

The method of detecting a moving target by the moving target detecting apparatus 100 according to this embodiment based on the first image data indicating the first image and the second image data indicating the second image, which are stored on the memory (the magnetic disk drive 920) may comprise the following processes.

The processor (the CPU 911) may extract a pixel increasing in the luminance value as the destination candidate pixel from the plurality of pixels included in the first image and the second image based on the first image and the second image indicated by the first image data and the second image data stored on the memory (the magnetic disk drive 920).

The processor (the CPU 911) may extract a pixel decreasing in the luminance value as the source candidate pixel from the plurality of pixels included in the first image and the second image based on the first image and the second image indicated by the first image data and the second image data stored on the memory (the magnetic disk drive 920).

The processor (the CPU 911) may extract the destination candidate pixel as the target pixel, when the destination candidate pixel is paired with the source candidate pixel, based on the destination candidate pixel extracted and the source candidate pixel extracted.

The method of detecting a moving target of this embodiment may allow for an effective detection of a target appearing in different pixels when it moves, without detecting a defective pixel.

It should be noted that parameters such as the neighbor distance may be stored by the neighbor distance storing section 122, etc. in advance, while parameters such as the neighbor distance are inputted by the parameter inputting section 121 in the foregoing description.

The operation of the moving target detecting apparatus 100 discussed hereinbefore may be summarized as follows.

First, a vote range setting section (the parameter inputting section 121) may set a pixel value varying pixel search range (the center neighbor range, a vote range). The vote range (the center neighbor range) may be defined as an arbitrary search range having the same number of pixels vertically and horizontally (i.e., the number of pixels in the x axis direction and the number of pixels in the y axis direction are the same). This vote range (the center neighbor range) may be changed based on the size of an input image or the image type.

Next, a vote range securable pixel extracting section (the center selecting section 131) may extract a pixel that can secure the vote range (i.e., a potential center pixel) in the first image (the first frame) for a series of input images. This is done to avoid allocating a center pixel to a pixel that cannot be a center pixel because the vote range is fixed, and space is not available for the vote range at an edge of an input image.

Next, an inter-frame evaluation value difference calculating section (the increase calculating section 132) may compare a first frame evaluation value (the luminance value of a pixel of the first image) and a second frame evaluation value (the luminance value of a pixel of the second image) to obtain a difference (the luminance increase value) between the vote ranges having the same pixel as the center pixels.

Next, an inter-frame evaluation value difference maximum value pixel searching section (the increase selecting section 133) and an inter-frame evaluation value difference minimum value pixel searching section (the decrease selecting section 135) may search for a maximum value pixel (the evaluation increase pixel) and a minimum value pixel (the evaluation decrease pixel) of an inter-frame evaluation value difference value (the luminance increase value) in the vote range (the center neighbor range).

Next, an inter-frame evaluation value difference maximum value pixel positive vote casting section (the increase vote calculating section 134) and an inter-frame evaluation value difference minimum value pixel negative vote casting section (the decrease vote calculating section 136) cast a plus vote to an inter-frame evaluation value difference maximum value pixel (the evaluation increase pixel) and a minus vote to an inter-frame evaluation value difference minimum value pixel (the evaluation decrease pixel). The inter-frame evaluation value difference maximum value pixel positive vote casting section and the inter-frame evaluation value difference minimum value pixel negative vote casting section do not cast any vote to other pixels (i.e., they are treated as ±0).

This operation may be performed on every center pixel in the second frame.

Next, when an inter-frame voting for all the pixels is over, an inter-frame evaluation difference positive/negative vote pixel vote percentage converting section (the vote percentage calculating section 143) may convert the vote number (the aggregation vote number) of each pixel to a vote percentage to the maximum vote number the pixel can have. This is done to have constant evaluation standards. The maximum vote number differs between a pixel located at an end portion and a pixel located at a center portion in the same frame, because of the vote range arrangement.

The size of the vote range may determine the maximum vote number of each pixel in the frame. Thus, an inter-frame evaluation value difference positive/negative vote pixel maximum vote number calculating section (the maximum vote number calculating section 141) may calculate the maximum vote number prior to the operation of the inter-frame evaluation difference positive/negative vote pixel vote percentage converting section (the vote percentage calculating section 143).

Next, an inter-frame evaluation value difference positive/negative vote pixel vote percentage threshold processing section (the source candidate extracting section 151, the destination candidate extracting section 152) may perform a threshold processing using an arbitrary plus vote parentage and an arbitrary minus vote percentage (the source threshold and the destination threshold), on an inter-frame evaluation value difference positive/negative vote pixel vote percentage (the vote percentage) to eliminate a pixel having a small vote percentage in absolute value.

Next, a pixel extraction distance internal positive/negative pair pixel searching section (the target extracting section 153) may search for a pair of a plus value pixel (the destination candidate pixel) and a minus value pixel (the source candidate pixel) extracted by the inter-frame evaluation value difference positive/negative vote pixel vote percentage threshold processing section (the source candidate extracting section 151, the destination candidate extracting section 152). The pixel extraction distance internal positive/negative pair pixel searching section (the target extracting section 153) may determine that the plus value pixel (the destination candidate pixel) and the minus value pixel (the source candidate pixel) are paired when they are located within a distance range (the neighbor candidate range). The distance range (the neighbor candidate range) may be determined based on a maximum acceptable distance (the determination distance, an extraction pixel distance). The extraction pixel distance (the determination distance) may be set by an extraction pixel distance setting section (the parameter inputting section 121, the determination distance storing section 125). The extraction pixel distance (the determination distance) may be changed arbitrarily based on the speed of a target or the frame interval of an input image. Alternatively, however, the extraction pixel distance may be set in the vicinity (in a direction of top, bottom, right or left, or the whole range) of a pixel of interest. This may allow for an effective response to any actions of the target.

Next, a moving target pixel extracting section (the target extracting section 153) may extract the plus value pixel (the destination candidate pixel) out of the pixel pair searched and retrieved by the pixel extraction distance internal positive/negative pair pixel searching section (the target extracting section 153) as a pixel currently showing the target at the present time, and binarize the extracted pixel to obtain the moving target pixel (the target pixel).

As described above, the moving target detecting apparatus 100 may allow for an effective detection of a target, which is as tiny as around one pixel, appearing in a series of input images each containing a complicated background with varying temperatures of a land, the sky, clouds and the like. The target moving by at least one pixel between frames can be detected, even if the target appears with low S/N signal intensity such that the luminance level of the target is not large enough compared to the luminance level of the background, and the frequency distribution of the luminance value of the background and the frequency distribution of the luminance value of the target partially overlap.

The moving target detecting apparatus 100 discussed hereinbefore may compare a pixel of the first frame inputted at one previous time and a pixel of the second frame currently inputted, and detect a pair of a pixel whose pixel value is increased and a pixel whose pixel value is decreased, in the detecting process of a target appearing in the image.

This may allow for an effective detection of such a tiny moving target appearing in an image at low S/N signal intensity.

The moving target detecting apparatus 100 described hereinbefore may allow for an accurate detection of a plurality of moving target objects such as an airplane, a vessel, and a vehicle, when the target objects each are as tiny as around one pixel appearing in an input image at low signal intensity. Those tiny target objects may be detected by using observation equipment with a sensor such as a radar that receives a series of images containing complicated patterns of a blue sky, clouds, a land, and the like in the background.

The moving target detecting apparatus 100 described hereinbefore may include the vote range setting section (the parameter inputting section 121, the neighbor distance storing section 122) for setting the arbitrary search range consisting of the same number of pixels horizontally and vertically with a pixel A (the center pixel) in the center, as the pixel value varying pixel search range (the center neighbor range, the vote range) in an input image.

The moving target detecting apparatus 100 described hereinbefore may allow the size of the pixel value varying pixel search range (the center neighbor range, the vote range) to be varied according to the size of an input image or an image type.

The moving target detecting apparatus 100 described hereinbefore may include the vote range securable pixel extracting section (the center selecting section 131) for extracting exclusively a pixel (i.e., a potential center pixel) that can secure the vote range (the center neighbor range) in an input image. This may thus avoid allocating a center pixel to a pixel that cannot be a center pixel.

The moving target detecting apparatus 100 described hereinbefore may include the inter-frame evaluation value difference calculating section (the increase calculating section 132) for comparing the luminance value of a pixel inputted at one previous time and the luminance value of a pixel inputted at the present time to obtain a difference (the luminance increase value) between the vote ranges (the center neighbor ranges) having the same pixie as the center pixel.

The moving target detecting apparatus 100 described hereinbefore may include the inter-frame evaluation value difference maximum value pixel searching section (the increase selecting section 133) and the inter-frame evaluation value difference minimum value pixel searching section (the decrease selecting section 135) for searching for a maximum value pixel (the evaluation increase pixel) and a minimum value pixel (the evaluation decrease pixel) of the inter-frame evaluation value difference value (the luminance increase value) in the calculated vote range (the center neighbor range).

The moving target detecting apparatus 100 described hereinbefore may include the inter-frame evaluation value difference maximum value pixel positive vote casting section (the increase vote calculating section 134) and the inter-frame evaluation value difference minimum value pixel negative vote casting section (the decrease vote calculating section 136) for casting a plus vote to the inter-frame evaluation value difference maximum value pixel (the evaluation increase pixel) and a minus vote to the inter-frame evaluation value difference minimum value pixel (the evaluation decrease pixel).

The moving target detecting apparatus 100 described hereinbefore may include the inter-frame evaluation difference positive/negative vote pixel vote percentage converting section (the vote percentage calculating section 143) for converting the vote number of the calculated inter-frame evaluation value difference maximum value pixel positive vote number (the increase vote number) and the vote number of the inter-frame evaluation value difference minimum value pixel negative vote number (the decrease vote number) to the vote percentage to the maximum vote number that pixel can obtain.

The moving target detecting apparatus 100 described hereinbefore may include the inter-frame evaluation value difference positive/negative vote pixel maximum vote number calculating section (the maximum vote number calculating section 141) for calculating the maximum vote number of each pixel in a frame, that is used for calculating the inter-frame evaluation value difference positive/negative vote pixel vote percentage (the vote percentage).

The moving target detecting apparatus 100 described hereinbefore may include the inter-frame evaluation value difference positive/negative vote pixel vote percentage threshold processing section (the source candidate extracting section 151, the destination candidate extracting section 152) for performing a threshold processing on the calculated inter-frame evaluation value difference positive/negative vote pixel vote percentage (the vote percentage) based on an arbitrary vote percentage to extract a pixel having a high vote percentage (the source candidate pixel, the destination candidate pixel).

The moving target detecting apparatus 100 described hereinbefore may include the extraction pixel distance setting section (the parameter inputting section 121, the determination distance storing section 125) for setting the maximum acceptable distance (the determination distance, the extraction pixel distance) that is used to determine that a plus value pixel and a minus value pixel, extracted after the inter-frame evaluation value difference positive/negative vote pixel vote percentage threshold process, are paired, in the search of the pair.

The moving target detecting apparatus 100 described hereinbefore may allow for an arbitrary change in the extraction pixel distance (the determination distance) according to the speed of a target or the frame interval of an input image.

The moving target detecting apparatus 100 described hereinbefore may allow for an effective setting of the extraction pixel distance (the candidate neighbor range) in the vicinity (in a direction of top, bottom, right or left, or the whole range) of a pixel of interest.

This may thus allow for an effective response to any action of the target.

The moving target detecting apparatus 100 described hereinbefore may include the pixel extraction distance internal positive/negative pair pixel searching section (the target extracting section 153) for searching for the plus value pixels (the destination candidate pixels) and the minus value pixels (the source candidate pixels) extracted after the inter-frame evaluation value difference positive/negative vote pixel vote percentage threshold process, in pairs, based on the set extraction pixel distance (the determination distance).

The moving target detecting apparatus 100 described hereinbefore may include the moving target pixel extracting section (the target extracting section 153) may extract the plus value pixel (the destination candidate pixel), as the moving target pixel (the target pixel), of the pair of the plus value pixel (the destination candidate pixel) and the minus value pixel (the source candidate pixel) searched for by the pixel extraction distance internal positive/negative pair pixel searching section (the target extracting section 153).

The moving target detecting apparatus 100 described hereinbefore may allow for an effective detection of a target in such a situation where the background, containing clouds and the like, does not have a certain uniformity.

The moving target detecting apparatus 100 described hereinbefore may not fail to detect a target nor detect the background by false detection in such a situation where the luminance level of the target is not large enough compared to the luminance level of the background when the frequency distribution of the luminance value of the background partially overlaps the frequency distribution of the luminance value of the target, for example.

The moving target detecting apparatus 100 described hereinbefore may also require no determination of reference values to evaluate the uniformity of the background, and no perspective knowledge on the state of the background, a difference in luminance between the target and the background, and the like for determining the reference value for detecting a target.

The moving target detecting apparatus 100 described hereinbefore may allow for an effective elimination of noise in a situation where a defective pixel such as a blinking defective pixel or a fixed defective pixel causes high luminance noise.

The moving target detecting apparatus 100 described hereinbefore may further allow for an effective detection of a target even in a situation where the luminance level is as low enough compared to the luminance level of the background as the pixel is not a peak pixel of the image.

The moving target detecting apparatus 100 described hereinbefore may further allow for an effective detection of a target in such a situation where the pixel showing the target in an input image is as tiny as around one pixel, and the frequency distribution of the luminance value of the target is overlapped by the frequency distribution of the luminance value of the background.

Defective pixels include the fixed defective pixel that outputs the same abnormal luminance value constantly, and the blinking defective pixel that outputs an abnormal luminance value nonconstantly. The blinking defective pixel acts normally with a normal luminance one time, and abnormally by outputting an abnormal luminance at another time. The luminance variation of this blinking defective pixel has little periodicity and regularity.

The moving target detecting apparatus 100 described hereinbefore never fails to detect the blinking defective pixel as the target pixel. This may eliminate such a manual operation that an operator visually checks an output image, thereby specifying the position of a blinking defective pixel, and removes the defective pixel.

The moving target detecting apparatus 100 discussed hereinbefore may allow for an effective indication of a still target, by indicating a target detected at the previous time when a detection result shows that there is no moving target object.

The moving target detecting apparatus 100 described hereinbefore may thus allow for detecting a target in an input image with any type of background. Further, the moving target detecting apparatus 100 described hereinbefore may thus allow for detecting a target as tiny as around one pixel. Still further, the moving target detecting apparatus 100 described hereinbefore may thus allow for detecting exclusively a moving target without detecting a defective pixel as the target, in such a situation where an input image includes both a target and a defective pixel.

### Embodiment 2

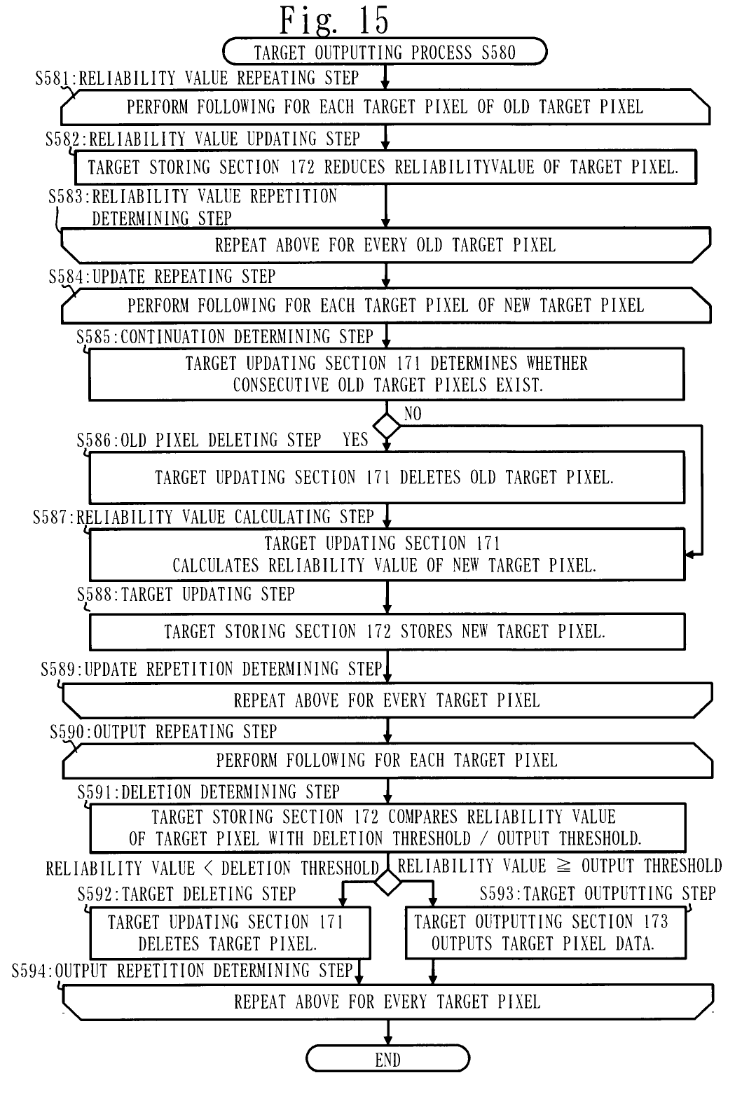

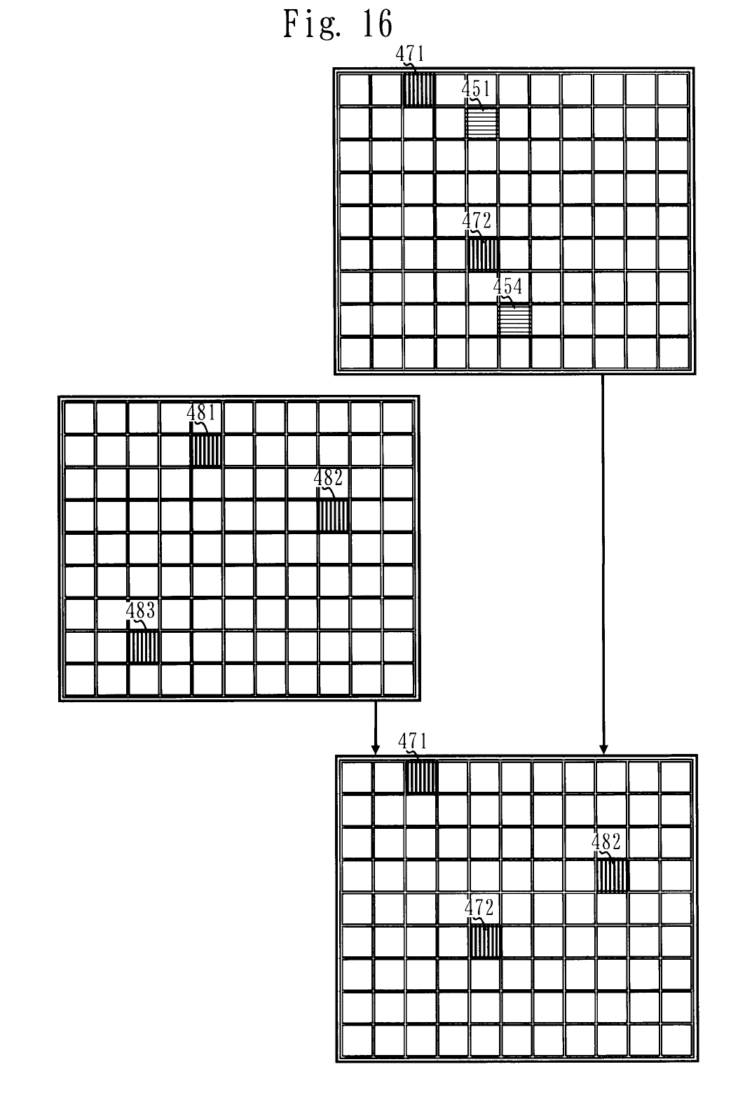

A second embodiment is now described with reference to FIG. 15 and FIG. 16.

It should be noted that the same elements as those of the moving target detecting apparatus 100 of the first embodiment are assigned the same reference numerals, and will not be discussed here in detail.

With this embodiment, the moving target detecting apparatus 100 is not configured to simply output the target pixel extracted by the target extracting section 153 or the adjacency target extracting section 163, but configured to compare a previously extracted target pixel and a currently extracted target pixel to evaluate the reliability of the target pixel, and then output the target pixel extracted based on an evaluation result.

The target storing section 172 may also store data (hereinafter, referred to as “reliability value data”) indicating the reliability value of a target pixel indicated by the target pixel data, for each item of the target pixel data stored therein, by using the magnetic disk drive 920. The reliability value may be defined as a value that indicates the degree of certainty of a target pixel showing the target. For example, the target extracting section 153 and the adjacency target extracting section 163 calculates the reliability value of a target pixel based on the luminance increase value or the vote percentage of that target pixel.

The target storing section 172 may reduce the reliability value of each target pixel indicated by old target pixel data currently stored therein, by using the CPU 911, before storing the target pixel data newly extracted by the target extracting section 153 or the adjacency target extracting section 163. More specifically, the target storing section 172 may subtract a predetermined value from the reliability value indicated by the reliability value data stored therein, or multiply the reliability value by a predetermined value (more than 0 and less than 1), by using the CPU 911, thereby thus reducing the reliability value, for example. The target storing section 172 may generate the reliability value data indicating the reduced reliability value, by using the CPU 911, and store generated reliability value data, by using the magnetic disk drive 920.

The target updating section 171 may input the old target pixel data stored by the target storing section 172 and the new target pixel data outputted by the target extracting section 153 or the adjacency target extracting section 163, by using the CPU 911. The target updating section 171 may determine whether the source candidate pixel paired with the new target pixel indicated by the new target pixel data matches the old target pixel indicated by the old target pixel data or not, based on the inputted old target pixel data and the new target pixel data, by using the CPU 911.

If it is determined that the source candidate pixel matches the old target pixel, then the target updating section 171 may input the reliability value data of the old target pixel stored by the target storing section 172, and increase the reliability value of the old target pixel indicated by the inputted reliability value data, by using the CPU 911. More specifically, the target updating section 171 may add a predetermined value to the reliability value, or multiply the reliability value by a predetermined value (more than 1), by using the CPU 911, thereby thus increasing the reliability value, for example. The target updating section 171 may treat the increased reliability value as the reliability value of the new target pixel paired with the source candidate pixel matching the old target pixel, and generate the reliability value data indicating the increased reliability value, by using the CPU 911.

The target updating section 171 may delete the target pixel data indicating the old target pixel and the reliability value data indicating the reliability value of the old target pixel from the target storing section 172, by using the CPU 911.

If it is determined that the source candidate pixel does not match the old target pixel, then the target updating section 171 may calculate the reliability value of the new target pixel, by using the CPU 911. More specifically, the target updating section 171 may treat a predetermined initial value as the reliability value of the new target pixel, for example. The target updating section 171 may then generate the reliability value data indicating the obtained reliability value, by using the CPU 911.

The target updating section 171 may output the inputted new target pixel data and the generated reliability value data, by using the CPU 911, regardless of whether or not it is determined that the source candidate pixel matches the old target pixel.

The target storing section 172 may input the target pixel data and the reliability value data outputted by the target updating section 171, by using the CPU 911. The target storing section 172 may store the inputted new target pixel data and the inputted reliability value data in addition to the old target pixel data and the reliability value data previously stored therein, by using the magnetic disk drive 920.

The target storing section 172 may compare the reliability value indicated by the stored reliability value data with a predetermined threshold (hereinafter, referred to as a “deletion threshold”), by using the CPU 911. The target storing section 172 may then delete the target pixel data indicating a target pixel and reliability value data indicating the reliability value of that target pixel, by using the CPU 911, when the reliability value of that specific target pixel is reduced below the deletion threshold.

The target extracting section 153 and the adjacency target extracting section 163 do not detect a target if the pixel showing the target does not change by move of the target. Given this fact, the target storing section 172 may keep holding the old target pixel data, regarding that the target pixel showing the target has not changed, if there is no pixel corresponding to the old target pixel stored by the target storing section 172 among the target pixels extracted by the target extracting section 153 or the adjacency target extracting section 163. The target storing section 172 may reduce the reliability value of the old target pixel gradually and finally delete the target pixel data, regarding that the target is lost, if the reliability value is reduced below the deletion threshold.

With newly detected targets, they may possibly be falsely detected. Given this fact, the target updating section 171 may be configured to assign a target pixel with the reliability value which is a value equal to or a little more than the deletion threshold, if it is determined that the source candidate pixel of the target pixel does not match the old target pixel, by using the CPU 911. In the case where the reliability value of the target pixel is set to a higher value than the deletion threshold, the target updating section 171 may determine how high the reliability value of the target pixel may be above the deletion threshold, based on the reliability value obtained by the target extracting section 153 or the adjacency target extracting section 163, by using the CPU 911.

As a result, the target storing section 172 reduces the reliability value of the target pixel unless it is followed by another target pixel detected next, thereby reducing the reliability value of that target pixel below the deletion threshold. This may allow the target updating section 171 to delete the target pixel data indicating that target pixel. This may thus allow a falsely detected target to be deleted immediately without keeping it for a while.

Noise interference on images or the like may prevent the target extracting section 153 and the adjacency target extracting section 163 from extracting a target pixel when the target appears in different pixels. To cope with this situation, the target updating section 171 may estimate a pixel showing the target in the present image, based on the action of the target pixel shown in the previous images, by using the CPU 911, rather than simply keeping the old target pixel data. Then, the target storing section 172 may store target pixel data indicating the pixel estimated by the target updating section 171 as the target pixel, by using the magnetic disk drive 920.

The target outputting section 173 may input the target pixel data stored by the target storing section 172, by using the CPU 911. The target outputting section 173 may output the inputted target pixel data, by using the communication device 915.

The target outputting section 173 may be configured to input the reliability value data stored by the target storing section 172; compare the reliability value of the target pixel indicated by the inputted target pixel data with a predetermined threshold (hereinafter, referred to as an “output threshold”), based on the inputted reliability value data, by using the CPU 911; and output the target pixel data only if the reliability value of the target pixel is the same or higher than the output threshold. If the reliability value of the target pixel is lower than the output threshold, the target outputting section 173 may not therefore output the target pixel data. The output threshold should be set to a value that is the same or higher than the deletion threshold, as a matter of course.

This may allow the target outputting section 173 to output the target pixel data only for a target having high reliability as a result of such as several consecutive detections, but not for a target having low reliability so that it is likely to have been falsely detected and be being deleted before long. This may effectively eliminate falsely detected targets.

FIG. 15 shows a flow chart illustrating an example flow of a target outputting process S580 for outputting a detected target pixel by the moving target detecting apparatus 100 according to this embodiment.

In a reliability value repeating step S581, the target storing section 172 selects one target pixel at a time from among all the old target pixels, based on the stored target pixel data, by using the CPU 911. The target storing section 172 performs a reliability value updating step S582 through a reliability value repeating step S583 for the selected target pixel. The target storing section 172 repeats these processes for every old target pixel.

In the reliability value updating step S582, the target storing section 172 reduces the reliability value of the target pixel selected by the reliability value repeating step S581 at a fixed rate, based on the stored target pixel data, by using the CPU 911. The target storing section 172 stores the target pixel data including the reliability value data indicating the reduced reliability value, by using the magnetic disk drive 920.

In the reliability value repetition determining step S583, the target storing section 172 determines whether the processes have been performed for every old target pixel or not, by using the CPU 911.

If it is determined that there is an old target pixel remaining unprocessed, then the target storing section 172 returns to the reliability value repeating step S581 to select the next old target pixel, by using the CPU 911.

If it is determined that every old target pixel has been processed, then the target storing section 172 proceeds to an update repeating step S584, by using the CPU 911.

In the update repeating step S584, the target updating section 171 selects one target pixel at a time from among all the target pixels extracted by the target extracting section 153 or the adjacency target extracting section 163, based on the target pixel data stored by the target extracting section 153 in the target determining step S566 and the target pixel data stored by the adjacency target extracting section 163 in the adjacency target determining step S577, by using the CPU 911. The target updating section 171 performs a continuation determining step S585 through a target updating step S588 for the selected target pixel. The target updating section 171 repeats these processes for every target pixel.

In the continuation determining step S585, the target updating section 171 determines whether there is a pixel, among the old target pixels, that matches the source candidate pixel paired with the target pixel selected in the update repeating step S584 or not, based on the old target pixels stored by the target storing section 172, by using the CPU 911.

If it is determined that there is a pixel that matches the source candidate pixel paired with the selected target pixel among the old target pixels, then the target updating section 171 proceeds to an old pixel deleting step S586, by using the CPU 911.

If it is determined that there is no pixel that matches the source candidate pixel paired with the selected target pixel among the old target pixels, then the target updating section 171 proceeds to a reliability value calculating step S587, by using the CPU 911.

In the old pixel deleting step S586, the target updating section 171 deletes from the target storing section 172 the target pixel data indicating the old target pixel that is determined in the continuation determining step S585 to match the source candidate pixel paired with the target pixel selected in the update repeating step S584, by using the CPU 911.

In the reliability value calculating step S587, the target updating section 171 calculates the reliability value of the selected target pixel, by using the CPU 911.

In the target updating step S588, the target storing section 172 stores the target pixel data indicating the target pixel selected by the target updating section 171 in the update repeating step S584 and the reliability value data indicating the reliability value obtained by the target updating section 171 in the reliability value calculating step S587, by using the magnetic disk drive 920.

In an update repetition determining step S589, the target updating section 171 determines whether the processes have been performed for every target pixel or not, by using the CPU 911.

If it is determined that there is a target pixel remaining unprocessed, then the target updating section 171 returns to the update repeating step S584 to select the next target pixel, by using the CPU 911.

If it is determined that every target pixel has been processed, then the process proceeds to an output repeating step S590.

In the output repeating step S590, the target storing section 172 selects one target pixel at a time from among all the target pixels, based on the stored target pixel data, by using the CPU 911. The target storing section 172 performs a deletion determining step S591 through a target outputting step S593 for the selected target pixel. The target storing section 172 repeats these processes for every target pixel.

In the deletion determining step S591, the target storing section 172 compares the reliability value of the target pixel selected in the output repeating step S590 and the deletion threshold and the output threshold (more than or equal to the deletion threshold), by using the CPU 911.

If it is determined that the reliability value of the selected target pixel is less than the deletion threshold, then the target storing section 172 proceeds to a target deleting step S592, by using the CPU 911.

If it is determined that the reliability value of the selected target pixel is the same or more than the output threshold, then the target storing section 172 proceeds to the target outputting step S593, by using the CPU 911.

In the target deleting step S592, the target storing section 172 deletes the target pixel data indicating the target pixel selected in the output repeating step S590 from the target pixel data stored therein, by using the CPU 911.

The operation then proceeds to an output repetition determining step S594.

In the target outputting step S593, the target outputting section 173 outputs the target pixel data indicating the target pixel selected by the target storing section 172 in the output repeating step S590, by using the communication device 915.

In the output repetition determining step S594, the target storing section 172 determines whether the processed have been performed for every target pixel or not, by using the CPU 911.

If it is determined that there is a target pixel remaining unprocessed, then the target storing section 172 returns to the output repeating step S590 to select the next target pixel, by using the CPU 911.

If it is determined that every target pixel has been processed, then the target outputting process is terminated.

An operation of the moving target detecting apparatus 100 is now discussed with reference to a specific example.

FIG. 16 shows examples of target pixels to be extracted by the moving target detecting apparatus 100 according to this embodiment.

The target storing section 172 stores target pixel data indicating three target pixels 481, 482, and 483 as results from the previous extraction, by using the magnetic disk drive 920.

The target storing section 172 stores the reliability value data indicating the reliability value “32” for the target pixel 481, the reliability value “67” for the target pixel 482, and the reliability value “34” for the target pixel 483, by using the magnetic disk drive 920. It is assumed here that the deletion threshold and the output threshold are “30” each.

First, the target storing section 172 reduces the reliability value of the target pixel indicated by the stored target pixel data, by using the CPU 911. More specifically, the target storing section 172 may reduce the reliability value by “5” at a time, for example.

With this specific example, the target storing section 172 reduces the reliability value of the target pixel 481 to “27”, the reliability value of the target pixel 482 to “62”, and the reliability value of the target pixel 483 to “29”, for example.

The target updating section 171 deletes a target pixel among the previous target pixels if the target pixel matches a source candidate pixel or an adjacency source candidate pixel that is paired with the present target pixel, based on the previous target pixel stored by the target storing section 172 and the present target pixel extracted by the target extracting section 153 or the adjacency target extracting section 163, by using the CPU 911. The target pixels that are not matched are left undeleted. With this specific example, the previous target pixel 481 matches the source candidate pixel 451 that is paired with the present target pixel 471. Therefore, the target updating section 171 deletes target pixel data indicating the previous target pixel 481 from the target storing section 172. The previous target pixels 482 and 483 match neither the source candidate pixel 451 paired with the present target pixel 471 nor the source candidate pixel 454 paired with the present target pixel 472. Therefore, the target updating section 171 keeps target pixel data indicating the previous target pixels 482 and 483 undeleted.

The target updating section 171 calculates the reliability value of each of the present target pixels extracted by the target extracting section 153 and the adjacency target extracting section 163, by using the CPU 911.

The target updating section 171 obtains the reliability value of a present target pixel by adding a value to the reliability value of an old target pixel, by using the CPU 911, if the old target pixel matches the source candidate pixel or the adjacency source candidate pixel paired with the present target pixel. More specifically, the target updating section 171 may add “7” to the reliability value of the old target pixel to obtain a new reliability value.

The target updating section 171 may then obtain the reliability value of a present target pixel by assigning a predetermined initial value, “32”, that is the same or more than the deletion threshold, for example, by using the CPU 911, if the old target pixel matches the source candidate pixel or the adjacency source candidate pixel paired with the present target pixel.

With this specific example, the target updating section 171 assigns “39” to the target pixel 471 as the reliability value, based on the inherited reliability value “32” of the old target pixel 481. The target updating section 171 then assigns the initial value “32” as the reliability value of the target pixel 472.

The target storing section 172 stores target pixel data indicating the target pixel which is a result from the current extraction, by using the magnetic disk drive 920, in addition to the target pixel data stored therein indicating the target pixels kept undeleted by the target updating section 171.

With this specific example, the target storing section 172 stores target pixel data indicating four target pixels in total, including the target pixels 482 and 483 kept undeleted by the target updating section 171 and the present target pixels 471 and 472.

Finally, the target storing section 172 deletes stored target pixel data indicating a target pixel having a reliability value lower than the deletion threshold, by using the CPU 911.

With this specific example, among the four remaining target pixels 471, 472, 482, and 483, the reliability value “39” for the target pixel 472, the reliability value “32” for the target pixel 472, and the reliability value “62” for the target pixel 482 are higher than “30” of the deletion threshold. Therefore, the target storing section 172 keeps target pixel data indicating those three target pixels 471, 472 and 482 undeleted.

In contrast, the reliability value for the target pixel 483 is “29”. Therefore, the target storing section 172 deletes target pixel data indicating the target pixel 483.

With this specific example, the deletion threshold and the output threshold have the same value. Therefore, the target outputting section 173 outputs all the target pixel data indicating the target pixels thus extracted.

In the case that the output threshold is higher than the deletion threshold, the target outputting section 173 may output target pixel data stored by the target storing section 172 indicating a target pixel only when the reliability value of the target pixel is the same or more than the output threshold.

With this specific example, if the output threshold is “35”, then the target outputting section 173 outputs target pixel data indicating the target pixels 471 and 482 whose reliability values are higher than the output threshold among the three extracted pixels 471, 472 and 482.

The moving target detecting apparatus 100 according to this embodiment may further comprise the target updating section 171.

The increase calculating section 132 may calculate the plurality of luminance increase values, by treating the latest image data as the second image data, and the second-latest image data as the first image data, of the image data inputted by the image inputting section 111 and stored by the image storing section 112, when the image inputting section 111 inputs an image data.

The target updating section 171 may extract the target pixel previously extracted by the target extracting section 153, when the target pixel matches no pixel among the source candidate pixels paired with the target pixel currently extracted by the target extracting section 153, by using the processor (the CPU 911).

According to the moving target detecting apparatus 100 of this embodiment, a previously extracted target pixel is extracted as a target pixel if the target pixel matches no source candidate pixel paired with a currently extracted target pixel. This may allow for an effective detection of a target pixel if a target moves at low speed and a pixel showing the target does not change.

According to the moving target detecting apparatus 100 described hereinbefore, the target detected at the previous time may be displayed as a substitute if the frame interval of an inputted image is relatively short, or a low speed target has little change in position in consecutive frames. This may allow for a display indicating a stopped state of the target.

### Embodiment 3

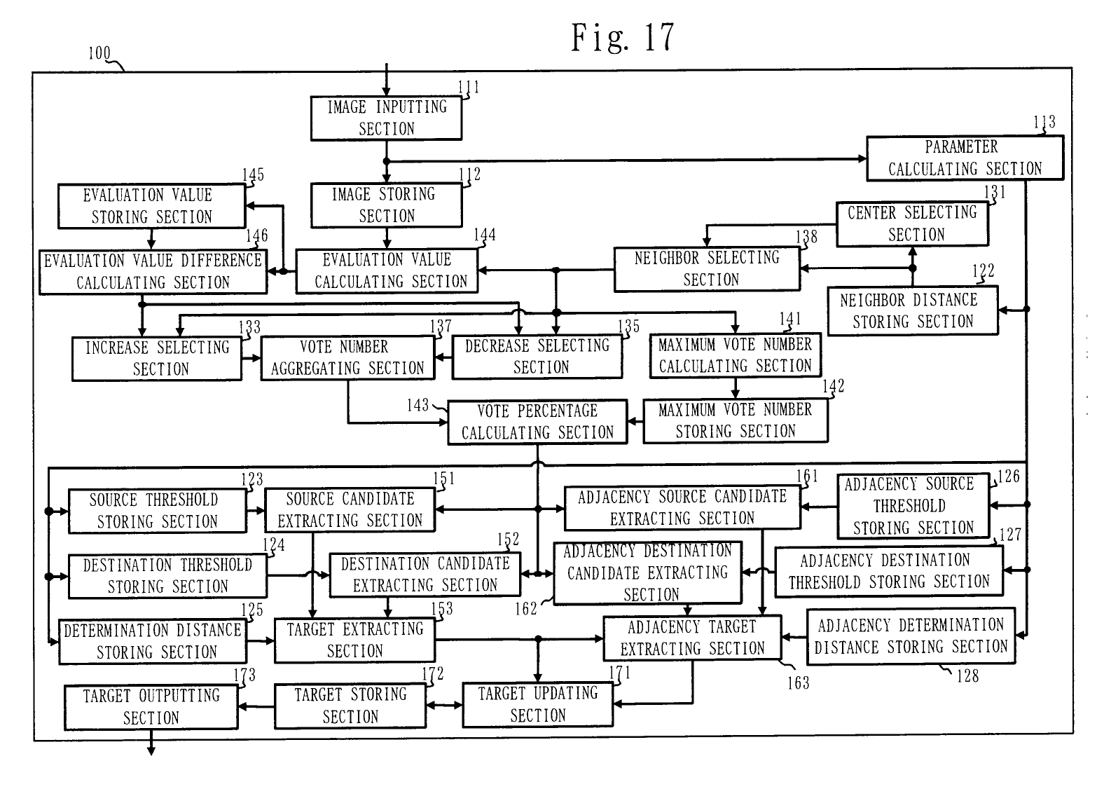

A third embodiment is now discussed with reference to FIG. 17 to FIG. 21.

FIG. 17 shows a functional block diagram illustrating an example configuration of the moving target detecting apparatus 100 according to this embodiment.

It should be noted that the same elements of the moving target detecting apparatus 100 as those described in the first embodiment or the second embodiment are assigned the same reference numerals and will not be discussed here in detail.

The moving target detecting apparatus 100 includes a parameter calculating section 113 instead of the parameter inputting section 121. The moving target detecting apparatus 100 also includes an evaluation value calculating section 144, an evaluation value storing section 145, and an evaluation value difference calculating section 146 instead of the increase calculating section 132. The moving target detecting apparatus 100 does not include the increase vote calculating section 134 and the decrease vote calculating section 136.

The parameter calculating section 113 may calculate parameters such as the neighbor distance, based on the size of an image indicated by image data inputted by the image inputting section 111 or the like, by using the CPU 911, instead of the parameter inputting section 121 inputting parameters such as the neighbor distance. The parameter calculating section 113 may output data indicating an obtained parameter, by using the CPU 911.

The neighbor distance storing section 122, the source threshold storing section 123, the destination threshold storing section 124, the determination distance storing section 125, the adjacency source threshold storing section 125, the adjacency destination threshold storing section 127, and the adjacency determination distance storing section 128 may input data indicating parameters obtained by the parameter calculating section 113, by using the CPU 911, and store the inputted data by using the magnetic disk drive 920.

Alternatively, however, those parameters may be inputted by the parameter inputting section 121, like the case of the first embodiment.

The evaluation value calculating section (a first evaluation value calculating section or a second evaluation value calculating section) 144 may input the latest image data of the image data stored by the image storing section 112, by using the CPU 911. The evaluation value calculating section 144 may input the neighbor pixel data outputted by the neighbor selecting section 138, by using the CPU 911. The evaluation value calculating section 144 may calculate a difference (hereinafter, referred to as a “luminance evaluation value”) for each of the plurality of center neighbor pixels selected by the neighbor selecting section 138 of each center pixel selected by the center selecting section 131, based on the inputted image data and the inputted neighbor pixel data, by using the CPU 911. Specifically, the luminance evaluation value may be obtained by subtracting the luminance value of the center pixel from the luminance value of the center neighbor pixel. More specifically, the evaluation value calculating section 144 may calculate the luminance evaluation value for each pair of the center pixel and a pixel within the center neighbor range having the center pixel in the center. If the neighbor selecting section 138 selects p center neighbor pixels for each center pixel, then the evaluation value calculating section 144 may calculate p luminance evaluation values corresponding to the p center neighbor pixels, for each center pixel. If the center selecting section 131 selects q center pixels in total, then the evaluation value calculating section 144 calculates p luminance evaluation values for each of the q center pixels. Therefore, the evaluation value calculating section 144 calculates p×q luminance evaluation values in total. The evaluation value calculating section 144 may output data (hereinafter, referred to as “luminance evaluation value data”) indicating an obtained plurality of luminance evaluation values, by using the CPU 911.

The evaluation value storing section 145 may input the luminance evaluation value data outputted by the evaluation value calculating section 144, by using the CPU 911. The evaluation value storing section 145 may store the inputted luminance evaluation value data, by using the magnetic disk drive 920. It is to be noted that the evaluation value storing section 145 may hold the luminance evaluation value data of at least the previous image data, by using the magnetic disk drive 920. More specifically, the evaluation value storing section 145 may store the luminance evaluation value data of the previous image data and the luminance evaluation value data of the latest image data, for example. Then, when the evaluation value calculating section 144 outputs the luminance evaluation value data of the next image data, the evaluation value storing section 145 may write the luminance evaluation value data of the next image data over the luminance evaluation value data of the previous image data, and store the luminance evaluation value data of the next image data. Alternatively, the evaluation value storing section 145 may store the luminance evaluation value data of the previous image data alone. When the evaluation value calculating section 144 outputs the luminance evaluation value data of the latest image data, the evaluation value storing section 145 may wait until the evaluation value difference calculating section 146 completes a process described below, and then write the luminance evaluation value data of the next image data over the luminance evaluation value data of the previous image data, thereby thus storing the luminance evaluation value data of the latest image data.

The evaluation value difference calculating section 146 may calculates a difference as the evaluation value difference, for each of the plurality of center neighbor pixels selected by the neighbor selecting section 138 of each of the plurality of center pixels selected by the center selecting section 131, based on the luminance evaluation value data of the previous image data stored by the evaluation value storing section 145 and the luminance evaluation value data of the latest image data obtained by the evaluation value calculating section 144, by using the CPU 911. More specifically, the evaluation value difference may be obtained by subtracting the luminance evaluation value (a first luminance evaluation value) of the previous image (a first image) from the luminance evaluation value (a second luminance evaluation value) of the latest image (a second image). More specifically, the evaluation value difference calculating section 146 calculates the total of p×q evaluation value differences, which is the same as the total number of the luminance evaluation values calculated by the evaluation value calculating section 144.

The evaluation value difference calculating section 146 may output data (hereinafter, referred to as “evaluation value difference data”) indicating the obtained plurality of evaluation value differences, by using the CPU 911.

The increase selecting section 133 may input the neighbor pixel data outputted by the neighbor selecting section 138 and the evaluation value difference data outputted by the evaluation value difference calculating section 146, by using the CPU 911. The increase selecting section 133 may calculate the evaluation increase pixel for each of the plurality of center pixels selected by the center selecting section 131, based on the inputted neighbor pixel data and the inputted evaluation value difference data, by using the CPU 911. More specifically, the evaluation increase pixel is a center neighbor pixel having the largest evaluation value difference of the center neighbor pixels of each center pixel of the center pixels. The increase selecting section 133 obtains the evaluation increase pixel by comparing the plurality of evaluation value differences obtained by the evaluation value difference calculating section 146 for the plurality of the center neighbor pixels selected by the neighbor selecting section 138 for each center pixel of the center pixels selected by the center selecting section 131. The increase selecting section 133 may compare p evaluation value differences obtained by the evaluation value difference calculating section 146 to obtain one evaluation increase pixel for each center pixel. The increase selecting section 133 may obtain q evaluation increase pixels corresponding to the q center pixels. The increase selecting section 133 may then output the evaluation increase pixel data indicating the plurality of evaluation increase pixels obtained for each of the plurality of center pixels selected by the center selecting section 131, by using the CPU 911.

Similarly, the decrease selecting section 135 may input the neighbor pixel data outputted by the neighbor selecting section 138 and the evaluation value difference data outputted by the evaluation value difference calculating section 146, and calculate q evaluation decrease pixels corresponding to the q center pixels selected by the center selecting section 131, based on the inputted neighbor pixel data and the inputted evaluation value difference data, by using the CPU 911. The decrease selecting section 135 may then output the evaluation decrease pixel data indicating the plurality of evaluation decrease pixels obtained for each of the plurality of center pixels selected by the center selecting section 131, by using the CPU 911.

The vote number aggregating section 137 may input the evaluation increase pixel data outputted by the increase selecting section 133 and the evaluation decrease pixel data outputted by the decrease selecting section 135, by using the CPU 911. The vote number aggregating section 137 may then calculate a difference, as the aggregation vote number, for each of the pixels of the image, based on the inputted evaluation increase pixel data and the inputted evaluation decrease pixel data, by using the CPU 911. More specifically, the aggregation vote number for a pixel may be obtained by subtracting the number of times the pixel is selected as the evaluation decrease pixel from the number of times the pixel is selected as the evaluation increase pixel.

Alternatively, however, the increase vote calculating section 134 may calculate the increase vote number, the decrease vote calculating section 136 may calculate the decrease vote number, and the vote number aggregating section 137 may calculate the aggregation vote number based on the obtained increase vote number and the obtained decrease vote number, like the case of the first embodiment.

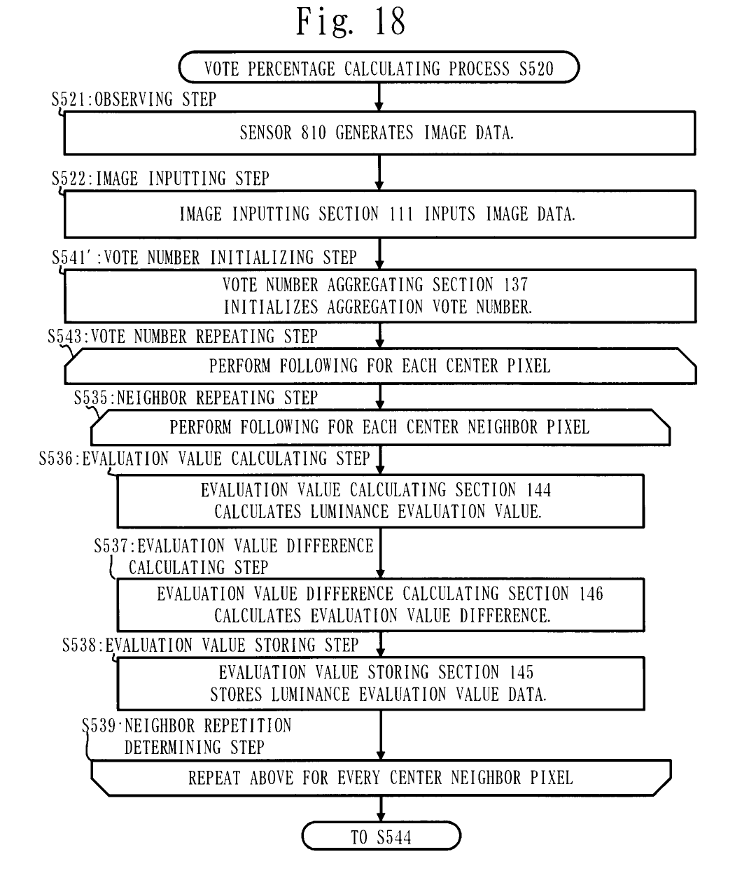

FIG. 18 shows a flow chart illustrating an example flow of the first half of the vote percentage calculating process S520 for calculating the vote percentage of each pixel by the moving target detecting apparatus 100 according to this embodiment.

It should be noted that the same processes as those of the vote percentage calculating process S520 described in the first embodiment are assigned the same reference numerals, and will not be discussed here in detail.

After the image inputting step S522, the process proceeds to a vote number initializing step S541′.

In the vote number initializing step S541′, the vote number aggregating section 137 initializes the aggregation vote number to 0 for each pixel of the two-dimensional image by using the CPU 911, and stores the aggregation vote number data indicating the initialized aggregation vote number, by using the magnetic disk drive 920.

In the vote number repeating step S543, the evaluation value calculating section 144 selects one center pixel at a time from among all the center pixels indicated by the center pixel data, based on the center pixel data stored by the center selecting section 131 in the center pixel selecting step S512, by using the CPU 911. The evaluation value calculating section 144 then performs a neighbor repeating step S535 through a vote number subtracting step S547′ for the selected center. The evaluation value calculating section 144 repeats these processes for every center pixel.

In the neighbor repeating step S535, the evaluation value calculating section 144 selects one center neighbor pixel at a time from among all the center neighbor pixels selected by the neighbor selecting section 138 in the neighbor selecting step S515 for the center pixel selected in the vote number repeating step S543, by using the CPU 911. The evaluation value calculating section 144 then performs the increase value calculating step S533 for the selected pixel. The evaluation value calculating section 144 repeats this process for every center neighbor pixel.

In an evaluation value calculating step S536, the evaluation value calculating section 144 calculates the luminance evaluation value of the center neighbor pixel selected by the neighbor repeating step S535, based on the image data inputted by the image inputting section 111 in the image inputting step S522, by using the CPU 911. The evaluation value calculating section 144 then stores the luminance evaluation value data indicating the obtained luminance evaluation value, by using the magnetic disk drive 920.

In an evaluation value difference calculating step S537, the evaluation value difference calculating section 146 inputs the luminance evaluation value data stored by the evaluation value calculating section 144 in the evaluation value calculating step S536 and the luminance evaluation value data stored by the evaluation value storing section 145 in an evaluation value storing step S538 for the same center neighbor pixel for the same center pixel of the previous image, by using the CPU 911. The evaluation value difference calculating section 146 then calculates the evaluation value difference based on the inputted two items of luminance evaluation value data. The evaluation value difference calculating section 146 then stores the evaluation value difference data indicating the obtained evaluation value difference, by using the magnetic disk drive 920.

In the evaluation value storing step S538, the evaluation value storing section 145 inputs the evaluation value difference stored by the evaluation value calculating section 144 in the evaluation value calculating step S536, by using the CPU 911. The evaluation value storing section 145 then stores the inputted luminance evaluation value data, by using the magnetic disk drive 920. The luminance evaluation value data stored by the evaluation value storing section 145 is used by the evaluation value difference calculating section 146 for calculating the evaluation value difference in the vote percentage calculating process S520 for the next image.

In a neighbor repetition determining step S539, the evaluation value calculating section 144 determines whether the evaluation value calculating step S536 through the evaluation value storing step S538 have been performed for every center neighbor pixel of the center pixel selected in the vote number repeating step S543 or not, by using the CPU 911.

If it is determined that there is a center neighbor pixel remaining unprocessed, then the evaluation value calculating section 144 returns to the neighbor repeating step S535 to select the next center neighbor pixel, by using the CPU 911.

If it is determined that every center neighbor pixel has been processed, then the process proceeds to the evaluation increase pixel selecting step S544.

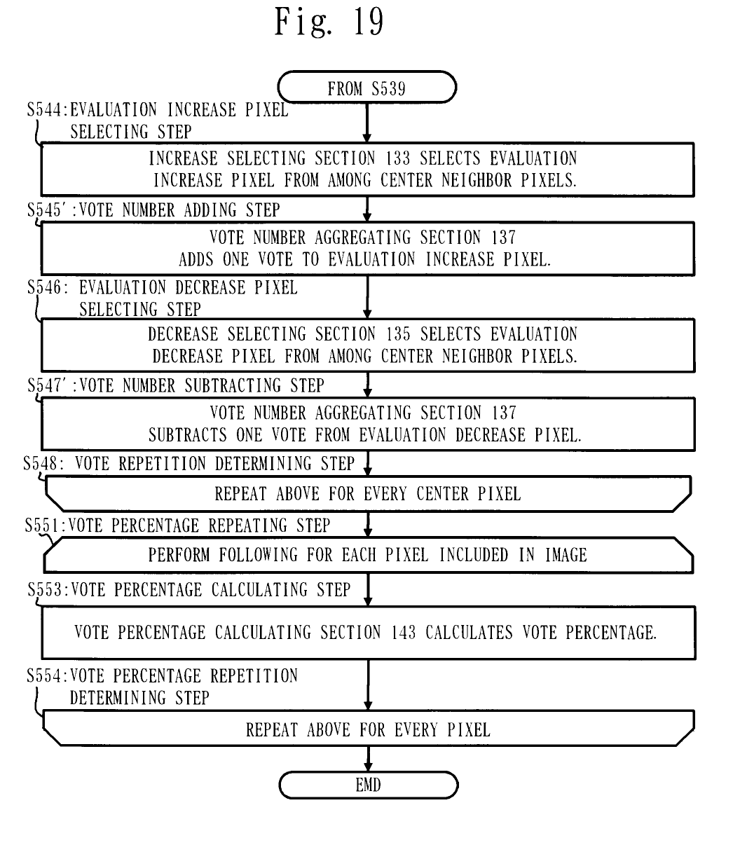

FIG. 19 shows a flow chart illustrating an example flow of the last half of the vote percentage calculating process S520 for calculating the vote percentage of each pixel by the moving target detecting apparatus 100 according to this embodiment.

In the evaluation increase pixel selecting step S544, the increase selecting section 133 inputs all the evaluation value difference data stored by the evaluation value difference calculating section 146 in the evaluation value difference calculating step S537 for the center pixel selected by the evaluation value calculating section 144 in the vote number repeating step S543, by using the CPU 911. The increase selecting section 133 then selects the evaluation increase pixel based on the inputted evaluation value difference data, by using the CPU 911. The increase selecting section 133 then stores the evaluation increase pixel data indicating the selected evaluation increase pixel, by using the magnetic disk drive 920.

In a vote number adding step S545′, the vote number aggregating section 137 inputs the evaluation increase pixel data stored by the increase selecting section 133 in the evaluation increase pixel selecting step S544, by using the CPU 911. The vote number aggregating section 137 then acquires the aggregation vote number data for the evaluation increase pixel selected by the increase selecting section 133 in the evaluation increase pixel selecting step S544, from the stored aggregation vote number data, based on the inputted evaluation increase pixel data, by using the CPU 911. The vote number aggregating section 137 then adds 1 to the aggregation vote number of the evaluation increase pixel selected by the increase selecting section 133 in the evaluation increase pixel selecting step S544, based on the acquired aggregation vote number data, by using the CPU 911. The vote number aggregating section 137 then stores the aggregation vote number data indicating the added aggregation vote number, as the aggregation vote number data for the evaluation increase pixel selected by the increase selecting section 133 in the evaluation increase pixel selecting step S544, by using the magnetic disk drive 920.

In an evaluation decrease pixel selecting step S546, the decrease selecting section 135 inputs all the evaluation value difference data stored by the evaluation value difference calculating section 146 in the evaluation value difference calculating step S537, for the center pixel selected by the evaluation value calculating section 144 in the vote number repeating step S543, by using the CPU 911. The decrease selecting section 135 then selects the evaluation decrease pixel based on the inputted evaluation value difference data, by using the CPU 911. The decrease selecting section 135 then stores the evaluation decrease pixel data indicating the selected evaluation decrease pixel by using the magnetic disk drive 920.

In the vote number subtracting step S547′, the vote number aggregating section 137 inputs the evaluation decrease pixel data stored by the decrease selecting section 135 in the evaluation decrease pixel selecting step S546, by using the CPU 911. The vote number aggregating section 137 then acquires the aggregation vote number data for the evaluation decrease pixel selected by the decrease selecting section 135 in the evaluation decrease pixel selecting step S546, from the stored aggregation vote number data, based on the inputted evaluation decrease pixel data, by using the CPU 911. The vote number aggregating section 137 then subtracts 1 from the aggregation vote number of the evaluation decrease pixel selected by the decrease selecting section 135 in the evaluation decrease pixel selecting step S546, based on the acquired aggregation vote number data, by using the CPU 911. The vote number aggregating section 137 then stores the aggregation vote number data indicating the subtracted aggregation vote number as the aggregation vote number data for the evaluation decrease pixel selected by the decrease selecting section 135 in the evaluation decrease pixel selecting step S546, by using the magnetic disk drive 920.

In the vote repetition determining step S548, the evaluation value calculating section 144 determines whether the processes have been performed for every center pixel or not, by using the CPU 911.

If it is determined that there is a center pixel remaining unprocessed, then the evaluation value calculating section 144 returns to the vote number repeating step S543 to select the next center pixel, by using the CPU 911.

If it is determined that every center pixel has been processed, then the process proceeds to the vote percentage repeating step S551.

The vote percentage repeating step S551 and the following processes are performed in the same manner as those described in the first embodiment, and therefore will not be described here in detail.

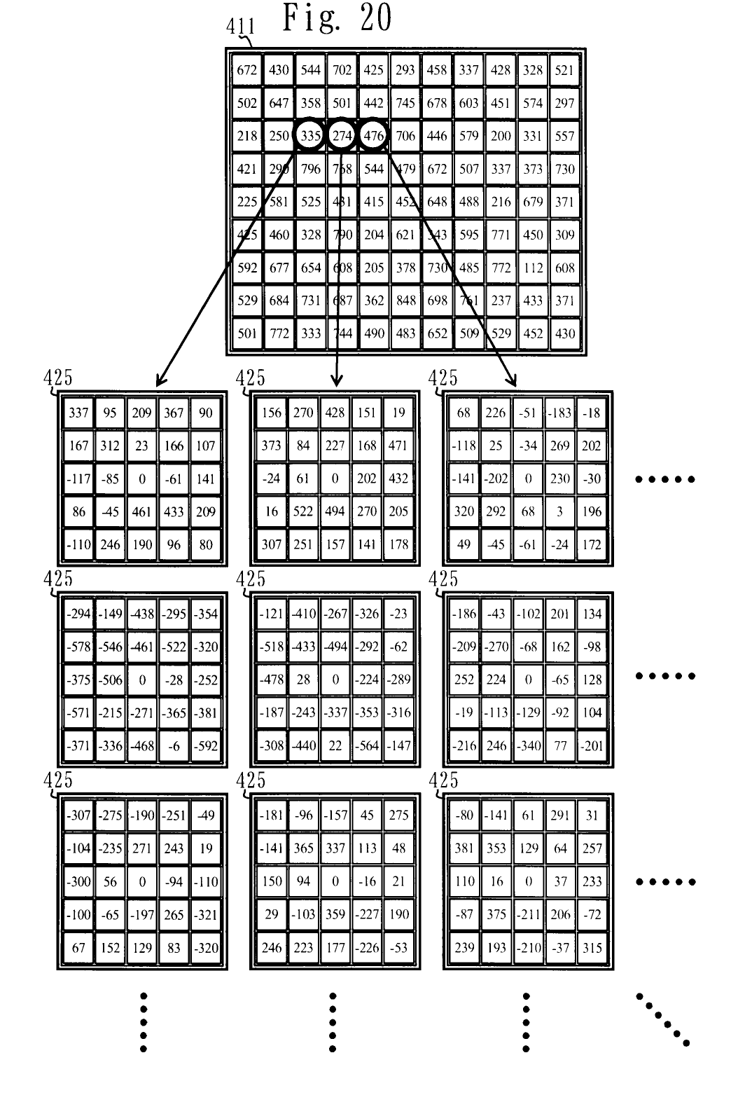

FIG. 20 shows examples of luminance evaluation values 425 obtained by the evaluation value calculating section 144 according to this embodiment.

The image inputting section 111 inputs the image data 411 by using the communication device 915. With these examples, the image data 411 consists of 99 items of the luminance value data corresponding to 99 pixels with vertical 9 pixels by horizontal 11 pixels of the two-dimensional image 300. The image storing section 112 stores the image data 411 inputted by the image inputting section 111, by using the magnetic disk drive 920.

The center selecting section 131 selects 35 pixels as the center pixels, out of the 99 pixels of the two-dimensional image 300. The neighbor selecting section 138 selects 25 center neighbor pixels for each of the center pixels selected by the center selecting section 131.

The evaluation value calculating section 144 calculates luminance evaluation values 425 corresponding to the 25 center neighbor pixels selected by the neighbor selecting section 138 for each of the 35 center pixels selected by the center selecting section 131, based on the latest image data 411 stored by image storing section 112, by using the CPU 911. The number of the luminance evaluation values 425 is 25×35=875.

The evaluation value storing section 145 stores the luminance evaluation value data indicating the luminance evaluation values 425 obtained by the evaluation value calculating section 144, by using the magnetic disk drive 920.

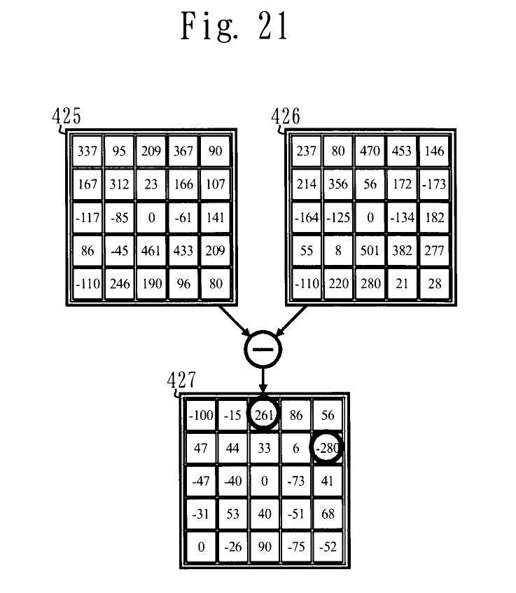

FIG. 21 shows an example of an evaluation value difference 427 obtained by the evaluation value difference calculating section 146 according to this embodiment.

The image inputting section 111 inputs the next image data, and the image storing section 112 stores the inputted image data. The evaluation value calculating section 144 calculates 875 luminance evaluation values 426 based on the latest image data stored by the image storing section 112, by using the CPU 911.

The evaluation value difference calculating section 146 calculates a difference as the luminance evaluation value difference 427, based on the luminance evaluation value 425 of the previous image indicated by the luminance evaluation value data stored by the evaluation value storing section 145 and the luminance evaluation value 426 of the latest image obtained by the evaluation value calculating section 144, by using the CPU 911. More specifically, the luminance evaluation value difference 427 may be obtained by subtracting the luminance evaluation value 425 of the previous image from the luminance evaluation value 426 of the latest image. The evaluation value difference calculating section 146 then calculates 875 luminance evaluation value differences 427 by using the CPU 911.

The increase selecting section 133 selects a center neighbor pixel having the largest luminance evaluation value difference of the 25 center neighbor pixels, for each of the 35 center pixels selected by the center selecting section 131, as the evaluation increase pixel, based on the luminance evaluation value difference 427 obtained by the evaluation value difference calculating section 146, by using the CPU 911. The increase selecting section 133 thus selects 35 evaluation increase pixels by using the CPU 911.

The decrease selecting section 135 selects a center neighbor pixel having the smallest luminance evaluation value difference of the 25 center neighbor pixels, for each of the 35 center pixels selected by the center selecting section 131, as the evaluation decrease pixel, based on the luminance evaluation value difference 427 obtained by the evaluation value difference calculating section 146, by using the CPU 911. The increase selecting section 133 thus selects 35 evaluation decrease pixels by using the CPU 911.

The target pixel may thus be extracted, not by simply comparing the luminance values of pixels themselves, but by calculating the difference (the luminance evaluation value) between the luminance value of the center neighbor pixel and the luminance value of the center pixel and then selecting the evaluation increase pixel and the evaluation decrease pixel, based on the inter-image or inter-frame difference (the evaluation value difference) in the difference between the luminance value of the center neighbor pixel and the luminance value of the center pixel. This may result in an effective extraction of the target pixel even when the luminance of an image varies locally or globally.

The moving target detecting apparatus 100 according to this embodiment may further comprise the center selecting section 131, neighbor selecting section 138, the first evaluation value calculating section (the evaluation value calculating section 144), the second evaluation value calculating section (the evaluation value calculating section 144), the evaluation value difference calculating section 146, the increase selecting section 133, and the decrease selecting section 135.

The center selecting section 131 may select at least two pixels as the plurality of center pixels, from the plurality of pixels included in both the first image and the second image, by using the processor (the CPU 911).

The neighbor selecting section 138 may select the plurality of pixels as the plurality of center neighbor pixels, for each center pixel of the plurality of center pixels selected by the center selecting section 131, the plurality of pixels being located in the neighborhood of the center pixel, by using the processor (the CPU 911), to obtain the plurality of center neighbor pixels.

The first evaluation value calculating section (the evaluation value calculating section 144) may calculate the difference as the first luminance evaluation value, for each center neighbor pixel of the plurality of center neighbor pixels selected by the neighbor selecting section 138 for each center pixel of the plurality of center pixels selected by the center selecting section 131, the difference being obtained by subtracting the luminance value of the center pixel of the first image from the luminance value of the center neighbor pixel of the first image, by using the processor (the CPU 911), to obtain the plurality of first luminance evaluation values.

The second evaluation value calculating section (the evaluation value calculating section 144) may calculate the difference as the second luminance evaluation value, for each center neighbor pixel of the plurality of center neighbor pixels selected by the neighbor selecting section 138 for each center pixel of the plurality of center pixels selected by the center selecting section 131, the difference being obtained by subtracting the luminance value of the center pixel of the second image from the luminance value of the center neighbor pixel of the second image, by using the processor (the CPU 911), to obtain the plurality of second luminance evaluation values.

The evaluation value difference calculating section 146 may calculate the difference as the evaluation value difference, for each center neighbor pixel of the plurality of center neighbor pixels selected by the neighbor selecting section 138 for each center pixel of the plurality of center pixels selected by the center selecting section 131, the difference being obtained by subtracting the first luminance evaluation value (the luminance evaluation value of the second-latest image) calculated by the first evaluation value calculating section (the evaluation value calculating section 144) and the second luminance evaluation value (the luminance evaluation value of the latest image) calculated by the second evaluation value calculating section (the evaluation value calculating section 144), by using the processor (the CPU 911), to obtain the plurality of evaluation value differences.

The increase selecting section 133 may select the center neighbor pixel as the evaluation increase pixel, for each center pixel of the plurality of center pixels selected by the center selecting section 131, the center neighbor pixel having the largest evaluation value difference of the plurality of evaluation value differences calculated by the evaluation value difference calculating section 146 in the plurality of center neighbor pixels selected by the neighbor selecting section 138, by using the processor (the CPU 911), to obtain the plurality of evaluation increase pixels.

The decrease selecting section 135 may select the center neighbor pixel as the evaluation decrease pixel, for each center pixel of the plurality of center pixels selected by the center selecting section 131, the center neighbor pixel having the smallest evaluation value difference of the plurality of the evaluation value differences calculated by the evaluation value difference calculating section 146 in the plurality of center neighbor pixels selected by the neighbor selecting section 138, by using the processor (the CPU 911), to obtain the plurality of evaluation decrease pixels.

The destination candidate extracting section 152 may extract the destination candidate pixel from the plurality of pixels based on the number of times the increase selecting section 133 selects each pixel of the plurality of pixels as the evaluation increase pixel, by using the processor (the CPU 911).

The source candidate extracting section 151 may extract the source candidate pixel from the plurality of pixels based on the number of times of the decrease selecting section 135 selects each pixel of the plurality of pixels as the evaluation decrease pixel, by using the processor (the CPU 911).

According to the moving target detecting apparatus 100 of this embodiment, the evaluation increase pixel and the evaluation decrease pixel may be selected based on the amount of change, between images, of the difference in the luminance value between the center neighbor pixel and the center pixel. This may result in an effective extraction of the target pixel even when the luminance of an image varies locally or globally.

The moving target detecting apparatus 100 discussed hereinbefore may also perform the following operation in addition to the operation described in the first embodiment.

For each pixel existing in the image of the first frame and having potential to be an center pixel, extracted by a vote range securable pixel extracting section (the center selecting section 131), an inner-frame evaluation value calculating section (the evaluation value calculating section 144) may calculate differences (the luminance evaluation values, or the first frame evaluation values) between a pixel value of the pixel itself and pixel values of other pixels within a vote range (the center neighbor range) having the pixel as the center pixel. The inner-frame evaluation value calculating section (the evaluation value calculating section 144) performs this difference calculation within a center pixel object range (the center neighbor range) by scanning the range gradually from the top left to the bottom right in the frame.

Next, the inner-frame evaluation value calculating section (the evaluation value calculating section 144) may also calculate the inner-frame evaluation value (the luminance value evaluation value, or the second frame evaluation value), for an image to be inputted next time (the second image, or the second frame), like the case of the first frame (the first image).

Next, an inter-frame evaluation value difference calculating section (the evaluation value difference calculating section 146) may compare a first frame evaluation value (the luminance evaluation value of the first image) and a second frame evaluation value (the luminance evaluation value of the second image) to obtain the difference (the luminance increase value) between vote ranges having the same pixel as the center pixels.

The moving target detecting apparatus 100 described hereinbefore may be configured to include an inner-frame evaluation value calculating section (the evaluation value storing section 145) that calculates a difference (the luminance evaluation value) between the pixel value of the center pixel within the vote range (the center neighbor range) of all the vote range securable pixels and the pixel value of every pixel within the vote range (the center neighbor range) except for the center pixel, and holds the value of this difference as the evaluation value, for the inputted image.

According to the moving target detecting apparatus 100 described hereinbefore, the inner-frame evaluation value calculating section (the evaluation value calculating section 144) may calculate the luminance evaluation value of an image inputted at one previous time (the first image) and the luminance evaluation value of an image inputted at the present time (the second image).

The moving target detecting apparatus 100 described hereinbefore may include the inter-frame evaluation value difference calculating section (the evaluation value difference calculating section). The inter-frame evaluation value difference calculating section (the evaluation value difference calculating section 146) may compare the calculated inner-frame evaluation value (the luminance evaluation value, or the first frame evaluation value) of the image inputted at one previous time (the first image) and the inner-frame evaluation value (the luminance evaluation value, or the second frame evaluation value) of the image inputted at the present time (the second image) to obtain a difference (the luminance increase value) between the vote ranges (the center neighbor ranges) having the same pixel as the center pixel.

### Embodiment 4

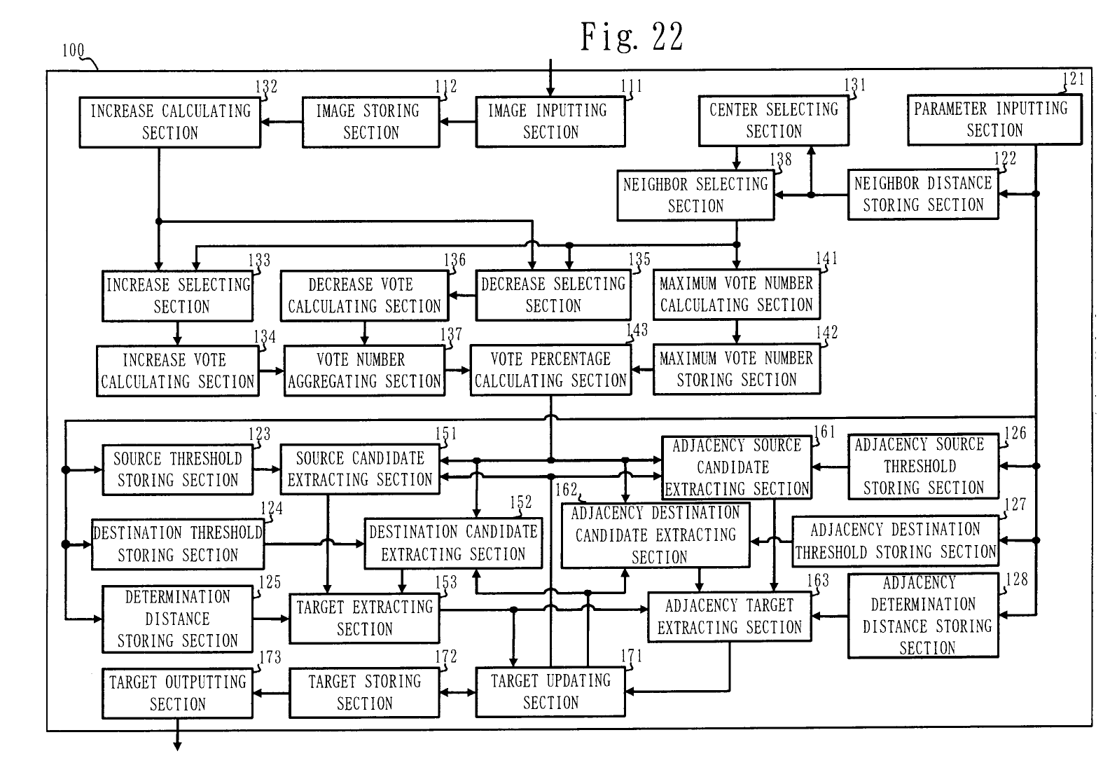

A fourth embodiment is now discussed with reference to FIG. 22.

FIG. 22 shows a functional block diagram illustrating an example configuration of the moving target detecting apparatus 100 according to this embodiment.

It should be noted that the same elements as those of the moving target apparatus 100 described in the first embodiment, the second embodiment, or the third embodiment are assigned the same reference numerals and will not be discussed here in detail.

The target updating section 171 may input the target pixel data outputted by the target extracting section 153 or the adjacency target extracting section 163 and the target pixel data stored by the target storing section 172, by using the CPU 911. The target updating section 171 may cause the target storing section 172 to store the inputted target pixel data in addition to the old target pixel data previous stored therein, by using the CPU 911.

The target updating section 171 may then search the old target pixel data stored by the target storing section 172 for target pixel data indicating a target pixel that matches the source candidate pixel paired with the target pixel indicated by the inputted target pixel data, by using the CPU 911. When the target pixel data indicating the target pixel that matches the source candidate pixel is found, then the target updating section 171 may increase the reliability value of the target pixel by adding the reliability value indicated by the reliability value data included in the old target pixel data to the reliability value indicated by the reliability value data included in the new target pixel data, by using the CPU 911. The target storing section 172 may store the target pixel data including the reliability value data indicating the increased reliability value, by using the magnetic disk drive 920. The target storing section 172 may then delete an old target pixel that matches the source candidate pixel, by using the magnetic disk drive 920.

It is less likely that the determination is a false detection when a pixel determined to have shown a target in the previous image (that is, the source candidate pixel paired with the target pixel) has determined in the determination at the previous time, to show a target in the latest image at the time. This means that the determination is highly reliable. Hence, the target updating section 171 may increase the reliability value of the target pixel.

The target updating section 171 may then compare the increased reliability value with a predetermined threshold, by using the CPU 911, when the reliability value of the target pixel is increased. Then, if the reliability value is higher than the predetermined threshold, for the target currently appearing in the target pixel, the target updating section 171 may estimate the position of a target pixel which will show the target at next time, by using the CPU 911. More specifically, the target updating section 171 may calculate a difference between the position of the new target pixel and the position of the old target pixel (the source candidate pixel), and then add an obtained difference to the position of the new target pixel, thereby estimating the position of the next target pixel, by using the CPU 911, for example.

The target updating section 171 may then output data (hereinafter, referred to as “present target data”) indicating the position (hereinafter, referred to as a “present target position”) of the new target pixel and data (hereinafter, referred to as “estimation target data”) indicating an estimated position (hereinafter, referred to as an “estimation target position”) of the target pixel, by using the CPU 911.

The source candidate extracting section 151 and the adjacency source candidate extracting section 161 may input the present target data outputted by the target updating section 171, by using the CPU 911.

The destination candidate extracting section 152 and the adjacency destination candidate extracting section 162 may input the estimation target data outputted by the target updating section 171, by using the CPU 911.

The source candidate extracting section 151, the destination candidate extracting section 152, the adjacency source candidate extracting section 161, and the adjacency destination candidate extracting section 162 may use the inputted present target data or the inputted estimation target data in the next process. The next process means the process where the latest image data at the present stage is treated as the first image data, and a new incoming image data to be inputted next by the image inputting section 111 is treated as the second image data.

The source candidate extracting section 151 may determine whether a pixel located at the present target position indicated by the present target data is the source candidate pixel or not, with reference to a predetermined threshold that is larger (i.e., the absolute value is smaller) than the destination threshold stored by source threshold storing section 123, based on the inputted present target data, by using the CPU 911.

Similarly, the adjacency source candidate extracting section 161 may determine whether a pixel located at the present target position indicated by the present target data is the adjacency source candidate pixel or not, with reference to a predetermined threshold that is larger (i.e., the absolute value is smaller) than the source threshold stored by adjacency source threshold storing section 126, based on the inputted present target data, by using the CPU 911.

The destination candidate extracting section 152 may determine whether a pixel located within a predetermined range having the estimation target position indicated by the estimation target data in the center is the destination candidate pixel or not, with reference to a predetermined threshold that is smaller (i.e., the absolute value is smaller) than the destination threshold stored by the destination threshold storing section 124, based on the inputted estimation target data, by using the CPU 911.

Similarly, the adjacency destination candidate extracting section 162 may determine whether a pixel located within a predetermined range having the estimation target position indicated by the estimation target data in the center is the adjacency destination candidate pixel or not, with reference to a predetermined threshold that is smaller (i.e., the absolute value is smaller) than the adjacency destination threshold stored by the adjacency destination threshold storing section 127, based on the inputted estimation target data, by using the CPU 911.

Thus, the thresholds may be adjusted. This may facilitate the detection of continuous target pixel following the target pixel that is determined to have a high reliability value from the past determination results. This may allow for an efficient tracking of a target without losing it.

The moving target detecting apparatus 100 discussed hereinbefore may compare, between frames, the arrangement of the pair of a plus value pixel (the destination candidate pixel) and a minus value pixel (the source candidate pixel) searched and retrieved by a pixel extraction distance internal positive/negative pair pixel searching section (the target extracting section 153), and thereby determine the moving direction of the target as a minimum value pixel direction, and a pixel (the target pixel) showing the target at the present time point as a minimum value pixel (the source candidate pixel).

This may allow for an effective recognition of the moving direction of the target.

The moving target detecting apparatus 100 discussed hereinbefore may recognize the moving direction of the target by the arrangement of the minus value pixels (the source candidate pixels) and the plus value pixels (destination candidate pixels) based on the pair of the plus value pixel (the destination candidate pixel) and the minus value pixel (the source candidate pixel) searched and retrieved by the pixel extraction distance internal positive/negative pair pixel searching section (the target extracting section 153).

It is to be noted that in addition to the tracking method discussed hereinbefore, the target pixel may alternatively be tracked by using an existing tracking method. The target updating section 171 may detect the moving direction and the moving speed of the target to be utilized in the tracking method, based on the target pixel extracted by the target extracting section 153 or the adjacency target extracting section 163 and the source candidate pixel paired with that target pixel.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A moving target detecting apparatus comprising:
a memory for storing data;
a processor for processing the data;
an image storing section that stores first image data indicating a first image and second image data indicating a second image, by using the memory;
a destination candidate extracting section that extracts a pixel increasing in a luminance value as a destination candidate pixel, from a plurality of pixels included in the first image and the second image, based on the first image and the second image indicated by the first image data and the second image data stored by the image storing section, by using the processor;
a source candidate extracting section that extracts a pixel decreasing in a luminance value as a source candidate pixel, from the plurality of pixels included in the first image and the second image, based on the first image and the second image indicated by the first image data and the second image data stored by the image storing section, by using the processor; and
a target extracting section that extracts the destination candidate pixel as a target pixel when the destination candidate pixel is paired with the source candidate pixel, based on the destination candidate pixel extracted by the destination candidate extracting section and the source candidate pixel extracted by the source candidate extracting section, by using the processor.

2. The moving target detecting apparatus according to claim 1, wherein the target extracting section extracts the destination candidate pixel extracted by the destination candidate extracting section as the target pixel when the source candidate pixel extracted by the source candidate extracting section is among a plurality of neighbor candidate pixels located in the neighborhood of the destination candidate pixel, by using the processor.

3. The moving target detecting apparatus according to claim 2, wherein the target extracting section extracts the target pixel by treating a plurality of pixels located within a rectangular range having the destination candidate pixel in the center as the plurality of neighbor candidate pixels, by using the processor.

4. The moving target detecting apparatus according to claim 2, wherein the target extracting section extracts the target pixel by treating a plurality of pixels located within a distance of a predetermined number of pixels from the destination candidate pixel as the plurality of neighbor candidate pixels, by using the processor.

5. The moving target detecting apparatus according to claim 1, further comprising:
an increase calculating section that calculates a difference as a luminance increase value, for each pixel of the plurality of pixels included in both the first image and the second image, the difference being obtained by subtracting a luminance value of a pixel of the first image from a luminance value of a pixel of the second image, based on the first image and the second image indicated by the first image data and the second image data stored by the image storing section, by using the processor, to obtain a plurality of luminance increase values;
a center selecting section 131 that selects at least two pixels as a plurality of center pixels, from the plurality of pixels, by using the processor;
a neighbor selecting section that selects a plurality of pixels as a plurality of center neighbor pixels, for each center pixel of the plurality of center pixels selected by the center selecting section 131, the plurality of pixels being located in the neighborhood of the center pixel, by using the processor, to obtain the plurality of center neighbor pixels;
an increase selecting section that selects a center neighbor pixel as an evaluation increase pixel, for each center pixel of the plurality of center pixels selected by the center selecting section 131, the center neighbor pixel having a largest luminance increase value of the plurality of luminance increase values calculated by the increase calculating section in the plurality of center neighbor pixels selected by the neighbor selecting section, by using the processor, to obtain a plurality of evaluation increase pixels; and
a decrease selecting section that selects a center neighbor pixel as an evaluation decrease pixel, for each center pixel of the plurality of center pixels selected by the center selecting section 131, the center neighbor pixel having a smallest luminance increase value of the plurality of luminance increase values calculated by the increase calculating section in the plurality of center neighbor pixels selected by the neighbor selecting section, by using the processor, to obtain a plurality of evaluation decrease pixels,
wherein the destination candidate extracting section extracts the destination candidate pixel from the plurality of pixels based on the number of times the increase selecting section selects each pixel of the plurality of pixels as the evaluation increase pixel, by using the processor, and
wherein the source candidate extracting section extracts the source candidate pixel from the plurality of pixels based on the number of times the decrease selecting section selects each pixel of the plurality of pixels as the evaluation decrease pixel, by using the processor.

6. The moving target detecting apparatus according to claim 1, further comprising:
a center selecting section 131 that selects at least two pixels as a plurality of center pixels, from the plurality of pixels included in both the first image and the second image, by using the processor;
a neighbor selecting section that selects a plurality of pixels as a plurality of center neighbor pixels, for each center pixel of the plurality of center pixels selected by the center selecting section 131, the plurality of pixels being located in the neighborhood of the center pixel, by using the processor, to obtain the plurality of center neighbor pixels;
a first evaluation value calculating section that calculates a difference as a first luminance evaluation value, for each center neighbor pixel of the plurality of center neighbor pixels selected by the neighbor selecting section for each center pixel of the plurality of center pixels selected by the center selecting section 131, the difference being obtained by subtracting a luminance value of the center pixel of the first image from a luminance value of the center neighbor pixel of the first image, by using the processor, to obtain a plurality of first luminance evaluation values;
a second evaluation value calculating section that calculates a difference as a second luminance evaluation value, for each center neighbor pixel of the plurality of center neighbor pixels selected by the neighbor selecting section for each center pixel of the plurality of center pixels selected by the center selecting section 131, the difference being obtained by subtracting a luminance value of the center pixel of the second image from a luminance value of the center neighbor pixel of the second image, by using the processor, to obtain a plurality of second luminance evaluation values;
an evaluation value difference calculating section that calculates a difference as an evaluation value difference, for each center neighbor pixel of the plurality of center neighbor pixels selected by the neighbor selecting section for each center pixel of the plurality of center pixels selected by the center selecting pixels, the difference being obtained by subtracting the first luminance evaluation value calculated by the first evaluation value calculating section and the second luminance evaluation value calculated by the second evaluation value calculating section, by using the processor, to obtain a plurality of evaluation value differences;
an increase selecting section that selects a center neighbor pixel as an evaluation increase pixel, for each center pixel of the plurality of center pixels selected by the center selecting section 131, the center neighbor pixel having a largest evaluation value difference of the plurality of evaluation value differences calculated by the evaluation value difference calculating section in the plurality of center neighbor pixels selected by the neighbor selecting section, by using the processor, to obtain a plurality of evaluation increase pixels; and
a decrease selecting section that selects a center neighbor pixel as an evaluation decrease pixel, for each center pixel of the plurality of center pixels selected by the center selecting section 131, the center neighbor pixel having a smallest evaluation value difference of the plurality of the evaluation value differences calculated by the evaluation value difference calculating section in the plurality of center neighbor pixels selected by the neighbor selecting section, by using the processor, to obtain a plurality of evaluation decrease pixels,
wherein the destination candidate extracting section extracts the destination candidate pixel from the plurality of pixels based on the number of times the increase selecting section selects each pixel of the plurality of pixels as the evaluation increase pixel, by using the processor, and
wherein the source candidate extracting section extracts the source candidate pixel from the plurality of pixels based on the number of times of the decrease selecting section selects each pixel of the plurality of pixels as the evaluation decrease pixel, by using the processor.

7. The moving target detecting apparatus according to claim 5, further comprising:
an increase vote calculating section that calculates the number of times the increase selecting section selects each pixel of the plurality of pixels as the evaluation increase pixel, as an increase vote number, for each pixel of the plurality of pixels, by using processor, to obtain a plurality of increase vote numbers; and
a decrease vote calculating section that calculates the number of times the decrease selecting section selects each pixel of the plurality of pixels as the evaluation decrease pixel, as a decrease vote number for each pixel of the plurality of pixels, by using the processor, to obtain a plurality of decrease vote numbers;
wherein the destination candidate extracting section extracts the destination candidate pixel from the plurality of pixels based on the plurality of increase vote numbers calculated by the increase vote calculating section, by using the processor, and
wherein the source candidate extracting section extracts the source candidate pixel from the plurality of pixels based on the plurality of decrease vote numbers calculated by the decrease vote calculating section, by using the processor.

8. The moving target detecting apparatus according to claim 5, further comprising:
a vote number aggregating section that calculates a difference as an aggregation vote number, for each pixel of the plurality of the pixels, the difference being obtained by subtracting the number of times the decrease selecting section selects the pixel as the evaluation decrease pixel from the number of times the increase selecting section selects the pixel as the evaluation increase pixel, by using the processor, to obtain a plurality of aggregation vote numbers,
wherein the destination candidate extracting section extracts the destination candidate pixel from the plurality of pixels based on the plurality of aggregation vote numbers calculated by the vote number aggregating section, by using the processor, and
wherein the source candidate extracting section extracts the source candidate pixel from the plurality of pixels based on the plurality of aggregation vote numbers calculated by the vote number aggregating section, by using the processor.

9. The moving target detecting apparatus according to claim 8, further comprising:
a maximum vote number storing section that stores the number of a center pixel as a maximum vote number, for each pixel of the plurality of pixels, the center pixel having the pixel among the plurality of center neighbor pixels in the neighborhood of the center pixel, by using the memory, to store a plurality of maximum vote numbers; and
a vote percentage calculating section that calculates a quotient as a vote percentage, for each pixel of the plurality of the pixels, the quotient being obtained by dividing the aggregation vote number calculated by the vote number aggregating section by the maximum vote number stored by the maximum vote number storing section, by using the processor, to obtain a plurality of vote percentages;
wherein the destination candidate extracting section extracts the destination candidate pixel from the plurality of pixels based on the plurality of vote percentages obtained by the vote percentage calculating section, by using the processor, and
wherein the source candidate extracting section extracts the source candidate pixel from the plurality of pixels based on the plurality of vote percentages obtained by the vote percentage calculating section, by using the processor.

10. The moving target detecting apparatus according to claim 9,
wherein the destination candidate extracting section extracts a pixel as the destination candidate pixel, from the plurality of pixels, the pixel having a vote percentage calculated by the vote percentage calculating section larger than a predetermined destination threshold, by using the processor, and
wherein the source candidate extracting section extracts a pixel as the source candidate pixel, from the plurality of pixels, the pixel having a vote percentage calculated by the vote percentage calculating section smaller than a predetermined source threshold, by using the processor.

11. The moving target detecting apparatus according to claim 10, further comprising:
an adjacency destination candidate extracting section that extracts a pixel as a adjacency destination candidate pixel, from the plurality of target neighbor pixels located in the neighborhood of the target pixel extracted by the target extracting section, the pixel having a vote percentage calculated by the vote percentage calculating section larger than an adjacency destination threshold that is smaller than the predetermined destination threshold, by using the processor;
an adjacency source candidate extracting section that extracts a pixel as an adjacency source candidate pixel, from the plurality of target neighbor pixels, the pixel having a vote percentage calculated by the vote percentage calculating section smaller than an adjacency source threshold that is larger than the predetermined source threshold, by using the processor; and
an adjacency target extracting section that extracts the adjacency destination candidate pixel extracted by the adjacency destination candidate extracting section when the adjacency source candidate pixel extracted by the adjacency source candidate extracting section is among a plurality of adjacency neighbor pixels located in the neighborhood of the adjacency destination candidate pixel, by using the processor.

12. The moving target detecting apparatus according to claim 5, wherein the neighbor selecting section selects a plurality of pixels as the plurality of center neighbor pixels, for each center pixel of the plurality of center pixels selected by the center selecting section 131, the plurality of pixels being located within a rectangular range having the center pixel in the center, by using the processor.

13. The moving target detecting apparatus according to claim 5, wherein the neighbor selecting section selects a plurality of pixels as the plurality of center neighbor pixels, for each center pixel of the plurality of center pixels selected by the center selecting section 131, the plurality of pixels being located within a distance of a predetermined number of pixels from the center pixel, by using the processor.

14. The moving target detecting apparatus according to claim 5, wherein the neighbor selecting section selects each pixel as the center pixel from the plurality of pixels when the plurality of center neighbor pixels in the neighborhood of the pixel fall within the image, by using the processor, to obtain the plurality of center pixels.

15. The moving target detecting apparatus according to claim 1, further comprising:
an input device for inputting data; and
an image inputting section that inputs image data indicating an image at the rate of one frame per a predetermined period, by using the input device,
wherein the image storing section stores the image data inputted by the image inputting section, and treats one of the image data stored as the first image data and the image data stored that is inputted next to the first image data by the image inputting section as the second image data.

16. The moving target detecting apparatus according to claim 15, further comprising:
an increase calculating section that calculates a difference as a luminance increase value, for each pixel of a plurality of pixels included in both the first image and the second image, the difference being obtained by subtracting the luminance value of a pixel of the first image from the luminance value of a pixel of the second image, by using the processor, to obtain the plurality of luminance increase values, by treating latest image data as the second image data, and second-latest image data as the first image data, of the image data inputted by the image inputting section and stored by the image storing section, when the image inputting section inputs image data; and
a target updating section that extracts the target pixel previously extracted by the target extracting section, when the target pixel matches no pixel among the source candidate pixels paired with the target pixel currently extracted by the target extracting section, by using the processor.

17. A computer readable storage medium having stored therein a computer program for causing a computer to function as the moving target detecting apparatus of claim 1.

18. A moving target detecting method for detecting a moving target by a moving target detecting apparatus including a memory for storing data and a processor for processing the data based on first image data indicating a first image and second image data indicating a second image, which are stored on the memory, the moving target detecting method comprising:
extracting a pixel increasing in a luminance value as a destination candidate pixel, by the processor, from a plurality of pixels included in the first image and the second image, based on the first image and the second image indicated by the first image data and the second image data stored on the memory;
extracting a pixel decreasing in a luminance value as a source candidate pixel, by the processor, from the plurality of pixels included in the first image and the second image, based on the first image and the second image indicated by the first image data and the second image data stored on the memory; and
extracting the destination candidate pixel as a target pixel, by the processor, when the destination candidate pixel is paired with the source candidate pixel, based on the destination candidate pixel extracted and the source candidate pixel extracted.
